(19) United States
(12) Patent Application Publication
(10) Pub. No.: US 2026/0256129 A1
(43) Pub. Date: Sep. 3, 2026

(54) PREDICTIVE MAPPING AND SPRAYER CONTROL

(71) Applicant: Deere & Company, Moline, IL (US)

(72) Inventors: Travis J. Auderer, Ankeny, IA (US); Nathan R. Vandike, Geneseo, IL (US); Kevin A. Thelen, Ankeny, IA (US)

(21) Appl. No.: 19/655,210

(22) Filed: Apr. 22, 2026

Related U.S. Application Data
(63) Continuation of application No. 18/194,194, filed on Mar. 31, 2023, now Pat. No. 12,635,678.
(60) Provisional application No. 63/327,246, filed on Apr. 4, 2022.
(60) Provisional application No. 63/327,247, filed on Apr. 4, 2022.
(60) Provisional application No. 63/327,248, filed on Apr. 4, 2022.

(51) Int. Cl. A01M 7/00; A01B 69/04; G05D 105/15; G06Q 50/02; G16Y 10/05

(52) U.S. Cl. CPC A01M 7/0089; A01B 69/008; A01M 7/0057; G05D 2105/15; G06Q 50/02; G16Y 10/05

(57) ABSTRACT

An information map is obtained by an agricultural system. The information map maps characteristic values at different geographic locations in a worksite. An in-situ sensor detects values of a characteristic as a mobile machine operates at the worksite. A predictive map generator generates a predictive map that maps predictive values of the characteristic detected by the in-situ sensor at different geographic locations in the worksite based on a relationship between the values of the characteristic in the information map and the values of the characteristic detected by the in-situ sensor. The predictive map can be output and used in automated machine control.

### CROSS-REFERENCE TO RELATED APPLICATIONS

The present application is a continuation of and claims the benefit of U.S. nonprovisional patent application Serial No. 18/194,194, filed March 31, 2023, which is based on and claims the benefit of U.S. provisional patent applications Serial No. 63/327,248, filed April 4, 2022, Serial No. 63/327,247, filed April 4, 2022, and Serial No. 63/327,246, filed April 4, 2022, the content of which are hereby incorporated by reference in their entirety.

### FIELD OF THE DESCRIPTION

The present description relates to mobile machines, particularly mobile machines configured to apply product to a field such as mobile agricultural sprayers.

### BACKGROUND

There are a wide variety of different mobile machines. Some mobile machines apply product, such as fertilizer, pesticide, herbicide, as well as a variety of other products to a field. One such machine is an agricultural sprayer. An agricultural sprayer often includes one or more tanks or reservoirs that hold a fluid product (substance) to be sprayed on an agricultural field. Such systems typically include a fluid line or conduit mounted on a foldable, hinged, or retractable and extendible boom. The fluid line is coupled to one or more spray nozzles mounted along the boom. The spray nozzles are configured to receive the fluid and direct atomized fluid, in a dispersal area, to a crop or field during application. As the sprayer travels through the field, the boom is moved to a deployed position and the product is pumped from the one or more tanks or reservoirs, through the nozzles, so that it is sprayed or applied to the crop or field over which the sprayer is traveling.

The discussion above is merely provided for general background information and is not intended to be used as an aid in determining the scope of the claimed subject matter.

### SUMMARY

An information map is obtained by an agricultural system. The information map maps characteristic values at different geographic locations in a worksite. An in-situ sensor detects values of a characteristic as a mobile machine operates at the worksite. A predictive map generator generates a predictive map that maps predictive values of the characteristic detected by the in-situ sensor at different geographic locations in the worksite based on a relationship between the values of the characteristic in the information map and the values of the characteristic detected by the in-situ sensor. The predictive map can be output and used in automated machine control.

Example 1 is an agricultural spraying system comprising:

a communication system configured to receive an information map that includes values of a characteristic corresponding to different geographic locations in a worksite;

an in-situ soil moisture sensor configured to detect a value of soil moisture corresponding to a geographic location in the worksite;

a predictive model generator configured to generate a predictive model indicative of a relationship between values of the characteristic and values of soil moisture based on a value of the characteristic in the information map at the geographic location and the value of soil moisture detected by the in-situ soil moisture sensor corresponding to the geographic location; and

a predictive map generator configured to generate a functional predictive map of the worksite that maps predictive values of soil moisture to the different geographic locations in the worksite, based on the values of the characteristic in the information map and based on the predictive model.

Example 2 is the agricultural spraying system of any or all previous examples, wherein the predictive map generator is configured to prepare the functional predictive map for consumption by a control system that generates control signals to control a controllable subsystem on a mobile agricultural sprayer based on the functional predictive map.

Example 3 is the agricultural spraying system of any or all previous examples, wherein the information map comprises a topographic map that maps, as the values of the characteristic, topographic characteristic values to the different geographic locations in the worksite, and wherein the predictive model generator is configured to generate as the predictive model, a predictive soil moisture model indicative of a relationship between topographic characteristic values and values of soil moisture based on the value of soil moisture detected by the in-situ soil moisture sensor corresponding to the geographic location and the topographic characteristic value, in the topographic map, at the geographic location, the predictive soil moisture model being configured to receive a topographic characteristic value as a model input and generate a value of soil moisture as a model output based on the relationship.

Example 4 is the agricultural spraying system of any or all previous examples, wherein the information map comprises a soil type map that maps, as the values of the characteristic, soil type values to the different geographic locations in the worksite, and wherein the predictive model generator is configured to generate as the predictive model, a predictive soil moisture model indicative of a relationship between soil type values and values of soil moisture based on the value of soil moisture detected by the in-situ soil moisture sensor corresponding to the geographic location and the soil type value, in the soil type map, at the geographic location, the predictive soil moisture model being configured to receive a soil type value as a model input and generate a value of soil moisture as a model output based on the relationship.

Example 5 is the agricultural spraying system of any or all previous examples, wherein the information map comprises a soil moisture map that maps, as the values of the characteristic, soil moisture values to the different geographic locations in the worksite, and wherein the predictive model generator is configured to generate as the predictive model, a predictive soil moisture model indicative of a relationship between soil moisture values and values of soil moisture based on the value of soil moisture detected by the in-situ soil moisture sensor corresponding to the geographic location and the soil moisture value, in the soil moisture map, at the geographic location, the predictive soil moisture model being configured to receive a soil moisture value, from the soil moisture map, as a model input and generate a value of soil moisture as a model output based on the relationship.

Example 6 is the agricultural spraying system of any or all previous examples, wherein the information map comprises an optical characteristic map that maps, as the values of the characteristic, optical characteristic values to the different geographic locations in the worksite, and wherein the predictive model generator is configured to generate as the predictive model, a predictive soil moisture model indicative of a relationship between optical characteristic values and values of soil moisture based on the value of soil moisture detected by the in-situ soil moisture sensor corresponding to the geographic location and the optical characteristic value, in the optical characteristic map, at the geographic location, the predictive soil moisture model being configured to receive an optical characteristic value as a model input and generate a value of soil moisture as a model output based on the relationship.

Example 7 is the agricultural spraying system of any or all previous examples, wherein the information map comprises a tiling map that maps, as the values of the characteristic, tiling characteristic values to the different geographic locations in the worksite, and wherein the predictive model generator is configured to generate as the predictive model, a predictive soil moisture model indicative of a relationship between tiling characteristic values and values of soil moisture based on the value of soil moisture detected by the in-situ soil moisture sensor corresponding to the geographic location and the tiling characteristic value, in the tiling map, at the geographic location, the predictive soil moisture model being configured to receive a tiling characteristic value as a model input and generate a value of soil moisture as a model output based on the relationship.

Example 8 is the agricultural spraying system of any or all previous examples, wherein the information map comprises an irrigation map that maps, as the values of the characteristic, irrigation characteristic values to the different geographic locations in the worksite, and wherein the predictive model generator is configured to generate as the predictive model, a predictive soil moisture model indicative of a relationship between irrigation characteristic values and values of soil moisture based on the value of soil moisture detected by the in-situ soil moisture sensor corresponding to the geographic location and the irrigation characteristic value, in the irrigation map, at the geographic location, the predictive soil moisture model being configured to receive an irrigation characteristic value as a model input and generate a value of soil moisture as a model output based on the relationship.

Example 9 is the agricultural spraying system of any or all previous examples, wherein the information map comprises a prior operation characteristic map that maps, as the values of the characteristic, prior operation characteristic values to the different geographic locations in the worksite, and wherein the predictive model generator is configured to generate as the predictive model, a predictive soil moisture model indicative of a relationship between prior operation characteristic values and values of soil moisture based on the value of soil moisture detected by the in-situ soil moisture sensor corresponding to the geographic location and the prior operation characteristic value, in the prior operation characteristic map, at the geographic location, the predictive soil moisture model being configured to receive a prior operation characteristic value as a model input and generate a value of soil moisture as a model output based on the relationship.

Example 10 is the agricultural spraying system of any or all previous examples and further comprising:

an in-situ boom height sensor configured to detect a value of boom height corresponding to a geographic location in the worksite.

Example 11 is the agricultural spraying system of any or all previous examples, wherein the predictive model generator is further configured to generate a predictive boom height model indicative of a relationship between predictive values of soil moisture and values of boom height based on a predictive value of soil moisture in the functional predictive map at the geographic location to which the value of boom height detected by the in-situ boom height sensor corresponds and the value of boom height detected by the in-situ boom height sensor corresponding to the geographic location.

Example 12 is the agricultural spraying system of any or all previous examples, wherein the predictive map generator is further configured to generate a functional predictive boom height map of the worksite that maps predictive values of boom height to the different geographic locations in the worksite, based on the predictive values of soil moisture in the functional predictive map and based on the predictive boom height model.

Example 13 is the agricultural spraying system of any or all previous examples and further comprising:

an in-situ machine height sensor configured to detect a value of machine height corresponding to a geographic location in the worksite.

Example 14 is the agricultural spraying system of any or all previous examples, wherein the predictive model generator is further configured to generate a predictive machine height model indicative of a relationship between predictive values of soil moisture and values of machine height based on a predictive value of soil moisture in the functional predictive map at the geographic location to which the value of machine height detected by the in-situ boom height sensor corresponds and the value of machine height detected by the in-situ machine height sensor corresponding to the geographic location.

Example 15 is the agricultural spraying system of any or all previous examples, wherein the predictive map generator is further configured to generate a functional predictive machine height map of the worksite that maps predictive values of machine height to the different geographic locations in the worksite, based on the predictive values of soil moisture in the functional predictive map and based on the predictive machine height model.

Example 16 is the agricultural spraying system of any or all previous examples and further comprising a control system that comprises one or more of:

a path planning controller configured to control a steering subsystem of a mobile agricultural sprayer based on the functional predictive map;

a machine height controller configured to control a machine height subsystem of the mobile agricultural sprayer based on the functional predictive map;

a boom height controller configured to control a boom height subsystem of the mobile agricultural sprayer based on the functional predictive map;

a tire pressure controller configured to control a tire pressure subsystem of the mobile agricultural sprayer based on the functional predictive map; and

an interface controller configured to control an interface mechanism based on the functional predictive map.

Example 17 is a computer implemented method of generating a functional predictive map comprising:

receiving an information map that maps values of a characteristic to different geographic locations in a worksite;

detecting, with an in-situ sensor, a value of soil moisture corresponding to a geographic location at the worksite while a mobile agricultural sprayer is operating at the worksite;

generating a predictive model indicative of a relationship between values of the characteristic and values of soil moisture based on the value of soil moisture detected by the in-situ sensor corresponding to the geographic location and the value of the characteristic in the information map at the geographic location; and

controlling a predictive map generator to generate the functional predictive map of the worksite that maps predictive values of soil moisture to the different geographic locations in the worksite based on the values of the characteristic in the information map and the predictive model.

Example 18 is the computer implemented method of any or all previous examples, wherein receiving the information map comprises receiving a topographic map that maps, as the values of the characteristic, topographic characteristic values to the different geographic locations in the worksite, and wherein generating the predictive model comprises:

generating, as the predictive model, a predictive soil moisture model indicative of a relationship between topographic characteristic values and values of soil moisture based on the value of soil moisture detected by the in-situ soil moisture sensor corresponding to the geographic location and the topographic characteristic value, in the topographic map, at the geographic location, the predictive soil moisture model being configured to receive a topographic characteristic value as a model input and generate a value of soil moisture as a model output based on the relationship.

Example 19 is the computer implemented method of any or all previous examples, wherein receiving the information map comprises receiving a soil type map that maps, as the values of the characteristic, soil type values to the different geographic locations in the worksite, and wherein generating the predictive model comprises:

generating, as the predictive model, a predictive soil moisture model indicative of a relationship between soil type values and values of soil moisture based on the value of soil moisture detected by the in-situ soil moisture sensor corresponding to the geographic location and the soil type value, in the soil type map, at the geographic location, the predictive soil moisture model being configured to receive a soil type value as a model input and generate a value of soil moisture as a model output based on the relationship.

Example 20 is the computer implemented method of any or all previous examples, wherein receiving the information map comprises receiving a soil moisture map that maps, as the values of the characteristic, soil moisture values to the different geographic locations in the worksite, and wherein generating the predictive model comprises:

generating, as the predictive model, a predictive soil moisture model indicative of a relationship between soil moisture values and values of soil moisture based on the value of soil moisture detected by the in-situ soil moisture sensor corresponding to the geographic location and the soil moisture value, in the soil moisture map, at the geographic location, the predictive soil moisture model being configured to receive a soil moisture value, from the soil moisture map, as a model input and generate a value of soil moisture as a model output based on the relationship.

Example 21 is the computer implemented method of any or all previous examples, wherein receiving the information map comprises receiving an optical characteristic map that maps, as the values of the characteristic, optical characteristic values to the different geographic locations in the worksite, and wherein generating the predictive model comprises:

generating, as the predictive model, a predictive soil moisture model indicative of a relationship between optical characteristic values and values of soil moisture based on the value of soil moisture detected by the in-situ soil moisture sensor corresponding to the geographic location and the optical characteristic value, in the optical characteristic map, at the geographic location, the predictive soil moisture model being configured to receive an optical characteristic value as a model input and generate a value of soil moisture as a model output based on the relationship.

Example 22 is the computer implemented method of any or all previous examples, wherein receiving the information map comprises receiving a tiling map that maps, as the values of the characteristic, tiling characteristic values to the different geographic locations in the worksite, and wherein generating the predictive model comprises:

generating, as the predictive model, a predictive soil moisture model indicative of a relationship between tiling characteristic values and values of soil moisture based on the value of soil moisture detected by the in-situ soil moisture sensor corresponding to the geographic location and the tiling characteristic value, in the tiling map, at the geographic location, the predictive soil moisture model being configured to receive a tiling characteristic value as a model input and generate a value of soil moisture as a model output based on the relationship.

Example 23 is the computer implemented method of any or all previous examples, wherein receiving the information map comprises receiving an irrigation map that maps, as the values of the characteristic, irrigation characteristic values to the different geographic locations in the worksite, and wherein generating the predictive model comprises:

generating, as the predictive model, a predictive soil moisture model indicative of a relationship between irrigation characteristic values and values of soil moisture based on the value of soil moisture detected by the in-situ soil moisture sensor corresponding to the geographic location and the irrigation characteristic value, in the irrigation map, at the geographic location, the predictive soil moisture model being configured to receive an irrigation characteristic value as a model input and generate a value of soil moisture as a model output based on the relationship.

Example 24 is the computer implemented method of any or all previous examples, wherein receiving the information map comprises receiving a prior operation characteristic map that maps, as the values of the characteristic, prior operation characteristic values to the different geographic locations in the worksite, and wherein generating the predictive model comprises:

generating, as the predictive model, a predictive soil moisture model indicative of a relationship between prior operation characteristic values and values of soil moisture based on the value of soil moisture detected by the in-situ soil moisture sensor corresponding to the geographic location and the prior operation characteristic value, in the prior operation characteristic map, at the geographic location, the predictive soil moisture model being configured to receive a prior operation characteristic value as a model input and generate a value of soil moisture as a model output based on the relationship.

Example 25 is the computer implemented method of any or all previous examples and further comprising:

detecting, with an in-situ boom height sensor, a value of boom height corresponding to a geographic location at the worksite while the mobile agricultural sprayer is operating at the worksite;

generating a predictive boom height model indicative of a relationship between predictive values of soil moisture and values of boom height based on the value of boom height detected by the in-situ boom height sensor corresponding to the geographic location and the predictive value of soil moisture in the functional predictive map at the geographic location to which the value of boom height detected by the in-situ boom height sensor corresponds; and

controlling the predictive map generator to generate a functional predictive boom height map of the worksite that maps predictive values of boom height to the different geographic locations in the worksite based on the predictive values of soil moisture in the functional predictive map and the predictive boom height model.

Example 26 is the computer implemented method of any or all previous examples and further comprising:

detecting, with an in-situ machine height sensor, a value of machine height corresponding to a geographic location at the worksite while the mobile agricultural sprayer is operating at the worksite;

generating a predictive machine height model indicative of a relationship between predictive values of soil moisture and values of machine height based on the value of machine height detected by the in-situ machine height sensor corresponding to the geographic location and the predictive value of soil moisture in the functional predictive map at the geographic location to which the value of machine height detected by the in-situ machine height sensor corresponds; and

controlling the predictive map generator to generate a functional predictive machine height map of the worksite that maps predictive values of machine height to the different geographic locations in the worksite based on the predictive values of soil moisture in the functional predictive map and the predictive machine height model.

Example 27 is the computer implemented method of any or all previous examples and further comprising:

controlling a controllable subsystem of the mobile agricultural sprayer based on the functional predictive map.

Example 28 is the computer implemented method of any or all previous examples, wherein controlling the controllable subsystem of the mobile agricultural sprayer based on the functional predictive map comprises:

controlling a tire pressure subsystem to adjust a pressure of a tire of the mobile agricultural sprayer based on the functional predictive map.

Example 29 is the computer implemented method of any or all previous examples, wherein controlling the controllable subsystem of the mobile agricultural sprayer based on the functional predictive map comprises:

controlling a boom height subsystem to actuate a boom height actuator of the mobile agricultural sprayer based on the functional predictive map.

Example 30 is the computer implemented method of any or all previous examples, wherein controlling the controllable subsystem of the mobile agricultural sprayer based on the functional predictive map comprises:

controlling a machine height subsystem to actuate a machine height actuator of the mobile agricultural sprayer based on the functional predictive map.

Example 31 is the computer implemented method of any or all previous examples, wherein controlling the controllable subsystem of the mobile agricultural sprayer based on the functional predictive map comprises:

controlling a steering subsystem to adjust a heading of the mobile agricultural sprayer based on the functional predictive map.

Example 32 is the computer implemented method of any or all previous examples, wherein controlling the controllable subsystem of the mobile agricultural sprayer based on the functional predictive map comprises:

controlling an interface mechanism to provide an indication based on the functional predictive map.

Example 33 is a mobile agricultural sprayer comprising:

a communication system that receives an information map that maps values of a characteristic to different geographic locations in a worksite;

an in-situ soil moisture sensor that detects a value of soil moisture corresponding to a geographic location;

a predictive model generator that generates a predictive soil moisture model indicative of a relationship between values of the characteristic and values of soil moisture based on the value of the characteristic in the information map at the geographic location and the value of soil moisture detected by the in-situ soil moisture sensor corresponding to the geographic location;

a predictive map generator that generates a functional predictive soil moisture map of the worksite that maps predictive values of soil moisture to the different geographic locations in the worksite, based on the values of the characteristic in the information map at those different geographic locations and based on the predictive soil moisture model; and

a control system that generates a control signal to control a controllable subsystem of the mobile agricultural sprayer based on the functional predictive soil moisture map.

Example 34 is an agricultural spraying system comprising:

a communication system configured to receive an information map that includes values of a characteristic corresponding to different geographic locations in a worksite;

an in-situ height characteristic sensor configured to detect a value of a height characteristic corresponding to a geographic location in the worksite;

a predictive model generator configured to generate a predictive model indicative of a relationship between values of the characteristic and values of the height characteristic based on a value of the characteristic in the information map at the geographic location and the value of the height characteristic detected by the in-situ height characteristic sensor corresponding to the geographic location; and

a predictive map generator configured to generate a functional predictive map of the worksite that maps predictive values of the height characteristic to the different geographic locations in the worksite, based on the values of the characteristic in the information map and based on the predictive model.

Example 35 is the agricultural spraying system of any or all previous examples, wherein the predictive map generator is configured to prepare the functional predictive map for consumption by a control system that generates control signals to control a controllable subsystem on a mobile agricultural sprayer based on the functional predictive map.

Example 36 is the agricultural spraying system of any or all previous examples, wherein the in-situ height characteristic sensor comprises:

an in-situ boom height sensor configured to detect, as the value of the height characteristic, a value of boom height corresponding to the geographic location in the worksite.

Example 37 is the agricultural spraying system of any or all previous examples, wherein the information map comprises a soil moisture map that maps, as the values of the characteristic, soil moisture values to the different geographic locations in the worksite, and wherein the predictive model generator is configured to generate as the predictive model, a predictive boom height model indicative of a relationship between soil moisture values and values of boom height based on the value of boom height detected by the in-situ boom height sensor corresponding to the geographic location and the soil moisture value, in the soil moisture map, at the geographic location, the predictive boom height model being configured to receive a soil moisture value as a model input and generate a value of boom height as a model output based on the relationship.

Example 38 is the agricultural spraying system of any or all previous examples, wherein the information map comprises a predictive soil moisture map that maps, as the values of the characteristic, predictive soil moisture values to the different geographic locations in the worksite, and wherein the predictive model generator is configured to generate as the predictive model, a predictive boom height model indicative of a relationship between predictive soil moisture values and values of boom height based on the value of boom height detected by the in-situ boom height sensor corresponding to the geographic location and the predictive soil moisture value, in the predictive soil moisture map, at the geographic location, the predictive boom height model being configured to receive a predictive soil moisture value as a model input and generate a value of boom height as a model output based on the relationship.

Example 39 is the agricultural spraying system of any or all previous examples, wherein the in-situ height characteristic sensor comprises:

an in-situ machine height sensor configured to detect, as the value of the height characteristic, a value of machine height corresponding to the geographic location in the worksite.

Example 40 is the agricultural spraying system of any or all previous examples, wherein the information map comprises a soil moisture map that maps, as the values of the characteristic, soil moisture values to the different geographic locations in the worksite, and wherein the predictive model generator is configured to generate as the predictive model, a predictive machine height model indicative of a relationship between soil moisture values and values of machine height based on the value of machine height detected by the in-situ machine height sensor corresponding to the geographic location and the soil moisture value, in the soil moisture map, at the geographic location, the predictive machine height model being configured to receive a soil moisture value as a model input and generate a value of machine height as a model output based on the relationship.

Example 41 is the agricultural spraying system of any or all previous examples, wherein the information map comprises a predictive soil moisture map that maps, as the values of the characteristic, predictive soil moisture values to the different geographic locations in the worksite, and wherein the predictive model generator is configured to generate as the predictive model, a predictive machine height model indicative of a relationship between predictive soil moisture values and values of machine height based on the value of machine height detected by the in-situ machine height sensor corresponding to the geographic location and the predictive soil moisture value, in the predictive soil moisture map, at the geographic location, the predictive machine height model being configured to receive a predictive soil moisture value as a model input and generate a value of machine height as a model output based on the relationship.

Example 42 is the agricultural spraying system of any or all previous examples, wherein the communication system is further configured to receive an additional information map that includes values of an additional characteristic corresponding to the different geographic locations in the worksite.

Example 43 is the agricultural spraying system of any or all previous examples and further comprising:

an in-situ soil moisture sensor configured to detect a value of soil moisture corresponding to a geographic location in the worksite.

Example 44 is the agricultural spraying system of any or all previous examples, wherein the predictive model generator is further configured to generate a predictive soil moisture model indicative of a relationship between values of the additional characteristic and values of soil moisture based on a value of the additional characteristic in the additional information map at the geographic location to which the value of soil moisture detected by the in-situ soil moisture sensor corresponds and the value of soil moisture detected by the in-situ soil moisture sensor corresponding to the geographic location.

Example 45 is the agricultural spraying system of any or all previous examples, wherein the predictive map generator is further configured to generate a functional predictive soil moisture map of the worksite that maps predictive values of soil moisture to the different geographic locations in the worksite, based on the values of the additional characteristic in the additional information map and based on the predictive soil moisture model.

Example 46 is the agricultural spraying system of any or all previous examples, wherein the information map comprises the functional predictive soil moisture map that maps, as the values of the characteristic, predictive values of soil moisture to the different geographic locations in the worksite, and wherein the predictive model generator is configured to generate as the predictive model, a predictive height characteristic model indicative of a relationship between predictive value of soil moisture and values of machine height based on the value of machine height detected by the in-situ height characteristic sensor corresponding to the geographic location and the predictive value of soil moisture, in the functional predictive soil moisture map, at the geographic location, the predictive height characteristic model being configured to receive a predictive value of soil moisture as a model input and generate a value of the height characteristic as a model output based on the relationship.

Example 47 is the agricultural spraying system of any or all previous examples and further comprising a control system that comprises one or more of:

a path planning controller configured to control a steering subsystem of a mobile agricultural sprayer based on the functional predictive map;

a machine height controller configured to control a machine height subsystem of the mobile agricultural sprayer based on the functional predictive map;

a boom height controller configured to control a boom height subsystem of the mobile agricultural sprayer based on the functional predictive map;

a tire pressure controller configured to control a tire pressure subsystem of the mobile agricultural sprayer based on the functional predictive map; and

an interface controller configured to control an interface mechanism based on the functional predictive map.

Example 48 is a computer implemented method of generating a functional predictive map comprising:

receiving an information map that maps values of a characteristic to different geographic locations in a worksite;

detecting, with an in-situ sensor, a value of a height characteristic corresponding to a geographic location at the worksite while a mobile agricultural sprayer is operating at the worksite;

generating a predictive model indicative of a relationship between values of the characteristic and values of the height characteristic based on the value of the height characteristic detected by the in-situ sensor corresponding to the geographic location and the value of the characteristic in the information map at the geographic location; and

controlling a predictive map generator to generate the functional predictive map of the worksite that maps predictive values of the height characteristic to the different locations in the worksite based on the values of the characteristic in the information map and the predictive model.

Example 49 is the computer implemented method of any or all previous examples, wherein detecting, with an in-situ sensor, the value of the height characteristic corresponding to the geographic location comprises detecting, with an in-situ boom height sensor, a value of boom height corresponding to the geographic location.

Example 50 is the computer implemented method of any or all previous examples, wherein receiving the information map comprises receiving a soil moisture map that maps, as the values of the characteristic, soil moisture values to different geographic locations in the worksite, and wherein generating the predictive model comprises:

generating, as the predictive model, a predictive boom height model indicative of a relationship between soil moisture values and values of boom height based on the value of boom height detected by the in-situ boom height sensor corresponding to the geographic location and the soil moisture value, in the soil moisture map, at the geographic location, the predictive boom height model being configured to receive a soil moisture value as a model input and generate a value of boom height as a model output based on the relationship.

Example 51 is the computer implemented method of any or all previous examples, wherein receiving the information map comprises receiving a predictive soil moisture map that maps, as the values of the characteristic, predictive soil moisture values to different geographic locations in the worksite, and wherein generating the predictive model comprises:

generating, as the predictive model, a predictive boom height model indicative of a relationship between predictive soil moisture values and values of boom height based on the value of boom height detected by the in-situ boom height sensor corresponding to the geographic location and the predictive soil moisture value, in the predictive soil moisture map, at the geographic location, the predictive boom height model being configured to receive a predictive soil moisture value as a model input and generate a value of boom height as a model output based on the relationship.

Example 52 is the computer implemented method of any or all previous examples, wherein detecting, with an in-situ sensor, the value of the height characteristic corresponding to the geographic location comprises detecting, with an in-situ machine height sensor, a value of machine height corresponding to the geographic location.

Example 53 is the computer implemented method of any or all previous examples, wherein receiving the information map comprises receiving a soil moisture map that maps, as the values of the characteristic, soil moisture values to different geographic locations in the worksite, and wherein generating the predictive model comprises:

generating, as the predictive model, a predictive machine height model indicative of a relationship between soil moisture values and values of machine height based on the value of machine height detected by the in-situ machine height sensor corresponding to the geographic location and the soil moisture value, in the soil moisture map, at the geographic location, the predictive machine height model being configured to receive a soil moisture value as a model input and generate a value of machine height as a model output based on the relationship.

Example 54 is the computer implemented method of any or all previous examples, wherein receiving the information map comprises receiving a predictive soil moisture map that maps, as the values of the characteristic, predictive soil moisture values to different geographic locations in the worksite, and wherein generating the predictive model comprises:

generating, as the predictive model, a predictive machine height model indicative of a relationship between predictive soil moisture values and values of machine height based on the value of machine height detected by the in-situ machine height sensor corresponding to the geographic location and the predictive soil moisture value, in the predictive soil moisture map, at the geographic location, the predictive boom height model being configured to receive a predictive soil moisture value as a model input and generate a value of boom height as a model output based on the relationship.

Example 55 is the computer implemented method of any or all previous examples and further comprising:

receiving an additional information map that maps values of an additional characteristic to different geographic locations in the worksite.

Example 56 is the computer implemented method of any or all previous examples and further comprising:

detecting, with an in-situ soil moisture sensor, a value of soil moisture corresponding to a geographic location at the worksite while the mobile agricultural sprayer is operating at the worksite;

generating a predictive soil moisture model indicative of a relationship between values of the additional characteristic and values of soil moisture based on the value of soil moisture detected by the in-situ soil moisture sensor corresponding to the geographic location and the value of the additional characteristic in the additional information map at the geographic location to which the value of soil moisture detected by the in-situ soil moisture sensor corresponds; and

controlling the predictive map generator to generate a functional predictive soil moisture map of the worksite that maps predictive values of soil moisture to the different geographic locations in the worksite based on values of the additional characteristic in the additional information map and the predictive soil moisture model.

Example 57 is the computer implemented method of any or all previous examples, wherein receiving the information map comprises receiving the functional predictive soil moisture map that maps, as the values of the characteristic, predictive soil moisture values to different geographic locations in the worksite, and wherein generating the predictive model comprises:

generating, as the predictive model, a predictive height characteristic model indicative of a relationship between predictive soil moisture values and values of the height characteristic based on the value of the height characteristic detected by the in-situ sensor corresponding to the geographic location and the predictive soil moisture value, in the functional predictive soil moisture map, at the geographic location, the predictive height characteristic model being configured to receive a predictive soil moisture value as a model input and generate a value of the height characteristic as a model output based on the relationship.

Example 58 is the computer implemented method of any or all previous examples and further comprising:

controlling a controllable subsystem of the mobile agricultural sprayer based on the functional predictive map.

Example 59 is the computer implemented method of any or all previous examples, wherein controlling the controllable subsystem of the mobile agricultural sprayer based on the functional predictive map comprises:

controlling a tire pressure subsystem to adjust a pressure of a tire of the mobile agricultural sprayer based on the functional predictive map.

Example 60 is the computer implemented method of any or all previous examples, wherein controlling the controllable subsystem of the mobile agricultural sprayer based on the functional predictive map comprises:

controlling a boom height subsystem to actuate a boom height actuator of the mobile agricultural sprayer based on the functional predictive map.

Example 61 is the computer implemented method of any or all previous examples, wherein controlling the controllable subsystem of the mobile agricultural sprayer based on the functional predictive map comprises:

controlling a machine height subsystem to actuate a machine height actuator of the mobile agricultural sprayer based on the functional predictive map.

Example 62 is the computer implemented method of any or all previous examples, wherein controlling the controllable subsystem of the mobile agricultural sprayer based on the functional predictive map comprises:

controlling a steering subsystem to adjust a heading of the mobile agricultural sprayer based on the functional predictive map.

Example 63 is the computer implemented method of any or all previous examples, wherein controlling the controllable subsystem of the mobile agricultural sprayer based on the functional predictive map comprises:

controlling an interface mechanism to provide an indication based on the functional predictive map.

Example 64 is a mobile agricultural sprayer comprising:

a communication system that receives an information map that maps values of a characteristic to different geographic locations in a worksite;

an in-situ height characteristic sensor that detects a value of a height characteristic corresponding to a geographic location;

a predictive model generator that generates a predictive height characteristic model indicative of a relationship between values of the characteristic and values of the height characteristic based on the value of the characteristic in the information map at the geographic location and the value of the height characteristic detected by the in-situ height characteristic sensor corresponding to the geographic location;

a predictive map generator that generates a functional predictive height characteristic map of the worksite that maps predictive values of the height characteristic to the different geographic locations in the worksite, based on the values of the characteristic in the information map at those different geographic locations and based on the predictive height characteristic model; and

a control system that generates a control signal to control a controllable subsystem of the mobile agricultural sprayer based on the functional predictive height characteristic map.

Example 65 is an agricultural spraying system comprising:

a control system that:

obtains a geographic location indicative of a geographic location of a mobile agricultural sprayer at a field;

obtains a map that maps predictive characteristic values to different geographic locations in the field; and

generates a control signal to control a controllable subsystem of the mobile agricultural sprayer based on the geographic location of the mobile agricultural sprayer and the map.

Example 66 is the agricultural spraying system of any or all previous examples and further comprising:

an in-situ sensor that detects a value of the characteristic corresponding to a geographic location;

a predictive model generator that:

receives an information map that maps values of an information map characteristic corresponding to different geographic locations in the field;

generates a predictive model that models a relationship between values of the information map characteristic and values of the characteristic based on the value of the characteristic detected by the in-situ sensor corresponding to the geographic location and a value of the information map characteristic in the information map at the geographic location to which the detected value of the characteristic corresponds; and

a predictive map generator that generates, as the map, a functional predictive map of the field that maps predictive values of the characteristic to the different geographic locations in the field, based on the values of the information map characteristic in the information map and based on the predictive model.

Example 67 is the agricultural spraying system of any or all previous examples wherein the controllable subsystem comprises one of:

a steering subsystem that is controllable to adjust a heading of the mobile agricultural sprayer;

a propulsion subsystem that is controllable to adjust a speed of the mobile agricultural sprayer;

a machine height subsystem that is controllable to adjust a height of the mobile agricultural sprayer;

a boom height subsystem that is controllable to adjust a height of a boom of the mobile agricultural sprayer; and

a tire pressure subsystem that is controllable to adjust a height a pressure of a tire of the mobile agricultural sprayer.

Example 68 is the agricultural spraying system of any or all previous examples and further comprising:

an in-situ sensor that detects a height characteristic value corresponding to a geographic location;

a predictive model generator that:

receives an information map that maps values of an information map characteristic corresponding to different geographic locations in the field;

generates a predictive height characteristic model that models a relationship between values of the information map characteristic and height characteristic values based on the height characteristic value detected by the in-situ sensor corresponding to the geographic location and a value of the information map characteristic in the information map at the geographic location to which the detected height characteristic value corresponds; and

a predictive map generator that generates, as the map, a functional predictive height characteristic map of the field that maps predictive height characteristic values to the different geographic locations in the field, based on the values of the information map characteristic in the information map and based on the predictive height characteristic model.

Example 69 is the agricultural spraying system of any or all previous examples, wherein the height characteristic is machine height.

Example 70 is the agricultural spraying system of any or all previous examples, wherein the height characteristic is boom height.

Example 71 is the agricultural spraying system of any or all previous examples and further comprising:

an in-situ sensor that detects a soil moisture value corresponding to a geographic location;

a predictive model generator that:

receives an information map that maps values of an information map characteristic corresponding to different geographic locations in the field;

generates a predictive soil moisture model that models a relationship between values of the information map characteristic and soil moisture values based on the soil moisture value detected by the in-situ sensor corresponding to the geographic location and a value of the information map characteristic in the information map at the geographic location to which the detected soil moisture value corresponds; and

a predictive map generator that generates, as the map, a functional predictive soil moisture map of the field that maps predictive soil moisture values to the different geographic locations in the field, based on the values of the information map characteristic in the information map and based on the predictive soil moisture model.

Example 72 is a method of controlling a mobile agricultural sprayer comprising:

receiving a predictive map of a field that maps predictive values of a characteristic to different geographic locations in the field;

detecting a geographic location of the mobile agricultural sprayer at the field; and

controlling the mobile agricultural sprayer based on the geographic location of the mobile planting machine and the predictive map.

Example 73 is the method of any or all previous examples and further comprising:

obtaining a height characteristic value corresponding to a geographic location in the field;

obtaining an information map that maps values of an information map characteristic corresponding to the different geographic locations in the field;

generating a predictive height characteristic model that models a relationship between the height characteristic and the information map characteristic based on the obtained height characteristic and the value of the information map characteristic at the geographic location to which the obtained height characteristic value corresponds; and

generating, as the predictive map, a functional predictive height characteristic map of the field, that maps predictive height characteristic values to the different geographic locations in the field based on values of the information map characteristic in the information map at those different geographic locations and the predictive height characteristic model.

Example 74 is the method of any or all previous examples and further comprising:

obtaining a soil moisture value corresponding to a geographic location in the field;

obtaining an information map that maps values of an information map characteristic corresponding to the different geographic locations in the field;

generating a predictive soil moisture model that models a relationship between soil moisture and the information map characteristic based on the obtained soil moisture value and the value of the information map characteristic at the geographic location to which the obtained soil moisture value corresponds; and

generating, as the predictive map, a functional predictive soil moisture map of the field, that maps predictive height characteristic values to the different geographic locations in the field based on values of the information map characteristic in the information map at those different geographic locations and the predictive soil moisture model.

Example 75 is the method of any or all previous examples, wherein controlling the mobile agricultural sprayer comprises one or more of:

controlling a steering subsystem to adjust a heading of the mobile agricultural sprayer based on the geographic location of the agricultural sprayer and the predictive map;

controlling a propulsion subsystem to adjust a speed of the mobile agricultural sprayer based on the geographic location of the agricultural sprayer and the predictive map;

controlling a machine height subsystem to adjust a height of a frame of the mobile agricultural sprayer above the field based on the geographic location of the agricultural sprayer and the predictive map;

controlling a boom height subsystem to adjust a height of at least a portion of a boom of the agricultural sprayer above the field based on the geographic location of the agricultural sprayer and the predictive map; and

controlling a tire pressure subsystem to adjust an internal pressure of a tire of the mobile agricultural sprayer based on the geographic location of the agricultural sprayer and the predictive map.

Example 76 is a mobile agricultural sprayer comprising:

a controllable subsystem;

a geographic position sensor that detects a geographic location of the mobile agricultural sprayer in a field; and

a control system that:

obtains a map of the field that maps predictive values of a characteristic to different geographic locations in the field; and

generates a control signal to control the controllable subsystem based on the geographic location of the mobile planting machine and a predictive value of depth in the map.

Example 77 is the mobile agricultural sprayer of any or all previous examples and further comprising:

a communication system that receives an information map that includes values of an information map characteristic corresponding to the different geographic locations in the field;

an in-situ sensor that detects a height characteristic value corresponding to a geographic location at the field;

a predictive model generator that generates a predictive height characteristic model that models a relationship between the information map characteristic and the height characteristic based on the height characteristic value detected by the in-situ sensor, corresponding to the geographic location and a value of the information map characteristic in the information map at the geographic location to which the detected height characteristic value corresponds; and

a predictive map generator that generates, as the map, a functional predictive height characteristic map of the field, that maps predictive height characteristic values to the different geographic locations in the field, based on the values of the information map characteristic in the information map and based on the predictive height characteristic model.

Example 78 is the mobile agricultural sprayer of any or all previous examples, wherein the controllable subsystem comprises one of:

a steering subsystem that is controllable to adjust a heading of the mobile agricultural sprayer;

a propulsion subsystem that is controllable to adjust a speed of the mobile agricultural sprayer;

a machine height subsystem that is controllable to adjust a height of the mobile agricultural sprayer;

a boom height subsystem that is controllable to adjust a height of a boom of the mobile agricultural sprayer; and

a tire pressure subsystem that is controllable to adjust a height a pressure of a tire of the mobile agricultural sprayer.

Example 79 is the mobile agricultural sprayer of any or all previous examples and further comprising:

a communication system that receives an information map that includes values of an information map characteristic corresponding to the different geographic locations in the field;

an in-situ sensor that detects a soil moisture value corresponding to a geographic location at the field;

a predictive model generator that generates a predictive soil moisture model that models a relationship between the information map characteristic and soil moisture based on the soil moisture value by the in-situ sensor, corresponding to the geographic location and a value of the information map characteristic in the information map at the geographic location to which the detected soil moisture value corresponds; and

a predictive map generator that generates, as the map, a functional predictive soil moisture map of the field, that maps predictive soil moisture values to the different geographic locations in the field, based on the values of the information map characteristic in the information map and based on the predictive soil moisture model.

Example 80 is the mobile agricultural sprayer of any or all previous examples, wherein the controllable subsystem comprises one of:

a steering subsystem that is controllable to adjust a heading of the mobile agricultural sprayer;

a propulsion subsystem that is controllable to adjust a speed of the mobile agricultural sprayer;

a machine height subsystem that is controllable to adjust a height of the mobile agricultural sprayer;

a boom height subsystem that is controllable to adjust a height of a boom of the mobile agricultural sprayer; and

a tire pressure subsystem that is controllable to adjust a height a pressure of a tire of the mobile agricultural sprayer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates one example of a mobile machine as an agricultural sprayer.

FIG. 2 illustrates one example of a mobile machine as an agricultural sprayer.

FIG. 3 is a block diagram showing some portions of an agricultural spraying system, including a mobile machine, such as an agricultural sprayer, in more detail, according to some examples of the present disclosure.

FIG. 4 is a block diagram showing one example of a predictive model generator and predictive map generator.

FIGS. 5A-5B (collectively referred to herein as FIG. 5) show a flow diagram illustrating one example of operation of an agricultural spraying system in generating a map.

FIG. 6 is a block diagram showing one example of a predictive model generator and predictive map generator.

FIGS. 7A-7B (collectively referred to herein as FIG. 7) show a flow diagram illustrating one example of operation of an agricultural spraying system in generating a map.

FIG. 8 is a block diagram showing one example of a mobile machine in communication with a remote server environment.

FIGS. 9-11 show examples of mobile devices that can be used in an agricultural spraying system.

FIG. 12 is a block diagram showing one example of a computing environment that can be used in an agricultural spraying system.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

In some examples, the present description relates to using in-situ data taken concurrently with an operation, such as an agricultural spraying operation, in combination with prior or predicted data, such as prior or predicted data represented in a map, to generate a predictive model and a predictive map, such as a predictive height characteristic model and a predictive height characteristic map or a predictive soil moisture model and a predictive soil moisture map. In some examples, the predictive map can be used to control a mobile machine, such as an agricultural sprayer.

As discussed above, agricultural sprayers apply products, such as fertilizer (or other nutrients), pesticide, insecticide, herbicide, as well as various other products to a field. Maintaining a distance between the boom (and components thereof) of the sprayer and field (or the crop on the field) is often desirable. For instance, the distance between the crop plants and the boom (or nozzles on the boom) can affect the product application. As the dispersal area of spray nozzles typically widens the further the distance from the spray nozzle, the distance between the nozzle and the crop plants will affect how the product is applied to the crop. Additionally, contact between the boom (or components thereof) can damage the crop plant. Thus, the machine can be controlled to maintain a height of the boom above the worksite or above the crop at the worksite. Machine height or the boom height can be controlled to maintain a distance between the boom and the crop plants.

During operation at the field, the height of the boom can be maintained in a closed-loop scheme, wherein a boom height sensor, such as an ultrasonic sensor (or various other sensors, such as cameras, lidar, radar, sonar, other distance measuring sensors, etc.), detects the distance between the boom and the worksite. or between the boom and the crop (crop canopy). Boom height actuators are controlled to actuate movement of the boom to maintain a height above the worksite based on the sensor data from the boom height sensor.

The moisture of the soil at the worksite may vary at different locations. Due to the moisture of the soil, the machine may sink into the soil, which in addition to the compaction of the soil and the creation of ruts, can cause the boom to deviate from the desired height above the worksite. In a closed-loop scheme of control, the height can be corrected, eventually, but due to the various latencies, there will be areas of the field for which the boom will not be at the desired height.

Thus, it would be useful to provide for predictive control of the sprayer to predictively control the sprayer to proactively compensate for boom height variation due to soil moisture.

In one example, the present description relates to obtaining an information map, such as a topographic map. The topographic map illustratively maps topographic characteristic values across different locations in a field of interest. The topographic values may indicate various topographic characteristics, such as elevation, slope, as well as ground profile (e.g., roughness). The topographic map may be derived from sensor readings, such as from sensors deployed on machines that previously operated on the worksite, or on machines that conduct flyovers of the worksite (e.g., satellites, planes, drones, etc.). For example, lidar (as well as other distance measuring sensors) can be used generate topographic values. Additionally, machine location and orientation during prior operations can be used to generated topographic values. These are merely some examples. The topographic map may be derived in other ways as well.

In one example, the present description relates to obtaining an information map, such as a soil type map. The soil type map illustratively maps soil type values across different geographic locations in a field of interest. Soil type can refer to taxonomic units in soil science, wherein each soil type includes defined sets of shared properties. Soil types can include, for example, sandy soil, clay soil, silt soil, peat soil, chalk soil, loam soil, and various other types of soil. The soil type map may be derived from sensor readings, such as from sensors deployed on machines that previously operated at the worksite, or on machines that conduct fly-over operations at the worksite (e.g., satellites, planes, drones, etc.). The soil type map may be derived from soil surveys, such as core sampling. In other examples, the soil type map may be derived in other ways.

In one example, the present description relates to obtaining an information map, such as a soil moisture map. The soil moisture map illustratively maps soil moisture values across different geographic locations in a field of interest. The soil moisture map may be derived from sensor readings, such as from sensors deployed on machines that previously operated at the worksite, or on machines that conduct fly-over operations at the worksite (e.g., satellites, planes, drones, etc.). The sensors may include cameras or optical sensors that detect one or more bands of electromagnetic radiation. The sensors may include capacitive sensors that detect capacitance changes related to changes in the dielectric properties of the soil, for instance, a capacitive sensor could be included on a component that engages (and sometimes penetrates) the soil, such as a disk on a tillage machine, a row unit wheel on a planting machine, on a seed firmer, as well as various other components. The sensors may include optical sensors that detect the presence of water or moisture, or detect color characteristics of the soil as indicative of soil moisture. Thus, the measured soil moisture at the time of tilling or seeding can be used to generate the soil moisture map. The soil moisture map may be derived from soil surveys, such as soil sampling. The soil moisture map may be derived from sensor readings of the soil conducted during human scouting of the field. In other examples, the soil moisture map may be derived from a soil moisture index. In some examples, the soil moisture map may be derived from data provided by third-party sources, such as government or research institutions that provide public soil moisture data. In other examples, the soil moisture map may be derived in other ways.

In one example, the present description relates to obtaining an information map, such as a predictive soil moisture map. The predictive soil moisture map illustratively maps georeferenced predictive soil moisture values across different geographic locations in a field of interest. The predictive soil moisture map may be derived from soil moisture modeling, which may include, as inputs, a variety of data, such as weather data, soil type data, crop residue data, prior operation data (e.g., tillage operation data, irrigation operation data, etc.) as well as a variety of other data. In other examples, the predictive soil moisture map may be derived from historical soil moisture data in combination with soil moisture modeling. In other examples, the predictive soil moisture map may be derived in other ways.

The soil moisture map provides measured values of soil moisture whereas the predictive soil moisture map provides predictive values of soil moisture.

In one example, the present description relates to obtaining an information map such as an optical characteristic map. The optical characteristic map illustratively maps georeferenced electromagnetic radiation values (optical characteristic values) across different geographic locations in a field of interest. Electromagnetic radiation values can be from across the electromagnetic spectrum. This disclosure uses electromagnetic radiation values from infrared, visible light and ultraviolet portions of the electromagnetic spectrum as examples only and other portions of the spectrum are also envisioned. An optical characteristic map may map datapoints by wavelength (e.g., a vegetative index). In other examples, an optical characteristic map identifies textures, patterns, color, shape, or other relations of data points. Textures, patterns, or other relations of data points can be indicative of presence or identification of an object in the field, such as crop, as well as characteristics of the crop such as crop state (e.g., downed/lodged or standing crop), plant presence, plant type, insect presence, insect type, etc. For example, plant type can be identified by a given leaf pattern or plant structure which can be used to identify the plant. For instance, a canopied vine weed growing amongst crop plants can be identified by a pattern. Or for example, an insect silhouette or a bite pattern in a leaf can be used to identify the insect. In some examples, the optical characteristic values (electromagnetic radiation values) can be indicative of the presence and location of moist areas at the field, such as locations of standing water and muddy areas. The optical characteristic map can be derived using satellite images, optical sensors on flying vehicles such as UAVS, or optical sensors on a ground-based system, such as another machine operating in the field before the spraying operation. In some examples, optical characteristic maps may map three-dimensional values as well such as crop height when a stereo camera or lidar system is used to generate the map. The optical characteristic map can be derived in other ways as well.

In one example, the present description relates to obtaining an information map, such as a tiling map. The tiling map illustratively maps georeferenced tiling characteristic values across different geographic locations in a field of interest. The tiling characteristics can include A tiling operation refers to an operation in which tiling (e.g., tile drainage, such as field tile, for instance, tubing or pipe) is installed at the field of interest. Tiling operation characteristic values can indicate the location, direction, as well as positional information (e.g., spacing, depth, etc.) of tiling placed at the field. The machine performing the tiling operation may be outfitted with one or more sensors that detect the tiling operation characteristic values. In some examples, the tiling operation characteristic values can be provided by an operator or user. In some examples, the tiling operation characteristic values can be derived from a map, such as a prescriptive tiling map used in the control of the tiling operation. These are merely some examples. In other examples, the tiling operation characteristic map may be derived in other ways.

In one example, the present description relates to obtaining an information map, such as an irrigation map. The irrigation map illustratively maps georeferenced values of irrigation characteristics across different geographic locations in a field of interest. The irrigation characteristics can include location information indicative of locations on the field of interest where irrigation substance (e.g., water) was applied and/or was not applied, the timing of the application of irrigation substance, and the amount of irrigation substance applied. The irrigation map may be derived from sensor readings during one or more prior irrigation operations at the field of interest. For example, the irrigation machine may include one or more sensors, such as one or more of flow rate sensors, pressure sensors, geographic position sensors, timing circuitry (e.g., a clock) as well as various other sensors, that may provide sensor data indicative of irrigation characteristics. In other examples, the irrigation map may be derived in other ways.

In one example, the present description relates to obtaining an information map, such as a prior operation characteristic map. The prior operation characteristic map illustratively maps georeferenced values of prior operation characteristics across different geographic locations in a field of interest. The prior operation characteristics can include data indicative of the machine, operating in the prior operation, getting stuck or creating ruts, such as sensor data indicative of wheel slip during the prior operation. The prior operation characteristic map may be derived from sensor readings during a prior operation. For example, the machine operating in the prior operation may include a variety of sensors that may provide sensor data indicative of the characteristics, for example, sensors that sense the rotation of ground engaging elements to indicate wheel slippage as well as sensors that sense and track the geographic location of the machine. In some examples, where the prior operation is a prior spraying operation, boom height sensors and/or machine height sensors may provide data indicative of the machine sinking. In other examples, the prior operation characteristic map may be derived in other ways.

In one example, a prior operation characteristic map can be a prior tillage operation characteristic map that illustratively maps, as georeferenced values of prior operation characteristics, georeferenced tillage characteristic values across different geographic locations in a field of interest. The prior tillage operation map illustratively maps georeferenced tillage characteristic values across different geographic locations in a field of interest. The tillage characteristics can include location information indicative of locations on the field of interest where tilling occurred and/or where tilling did not occur, operating parameters of the tillage machine (such as operating depth, aggressiveness, speed, etc.), tillage quality, and the timing of the tillage operation. The tilling map may be derived from sensor readings during one or more prior tillage operations at the field of interest. For example, the tillage machine may include one or more sensors, such as operating characteristic sensors (e.g., speed sensors, position sensors, etc.), geographic position sensors, timing circuitry (e.g., a clock), as well as various other sensors, that may provide data indicative of tillage characteristics. These are merely some examples. In other examples, the prior tillage operation characteristic map may be derived in other ways.

The present discussion proceeds, in some examples, with respect to systems that obtain one or more maps of a worksite, such as one or more of a topographic map, a soil type map, a soil moisture map, an optical characteristic map, a tiling map, an irrigation map, a prior operation characteristic map, and another type of map, and also use an in-situ sensor to detect a characteristic, such as soil moisture. The systems generate a model that models a relationship between the values on the one or more obtained maps and the output values from the in-situ sensor. The model is used to generate a predictive map that predicts, for example, soil moisture values to different geographic locations in the worksite. The predictive map (e.g., predictive soil moisture map), generated during an operation, can be presented to an operator or other user or used in automatically controlling a mobile machine, such as an agricultural sprayer, during an operation, or both.

In one example, the present discussion proceeds in some examples, with respect to systems that obtain one or more maps of a worksite, such as one or more of a soil moisture map, or a predictive soil moisture map (such as the predictive soil moisture map generated during the operation described above, or another type of predictive soil moisture map), and also use an in-situ sensor to detect a height characteristic, such as boom height or machine height. The systems generate a model that models a relationship between the values on the one or more obtained maps and the output values from the in-situ sensor. The model is used to generate a predictive map that predicts, for example, height characteristic values (e.g., boom height values and/or machine height values). The predictive map (e.g., predictive height map), generated during an operation, can be presented to an operator or other user or used in automatically controlling a mobile machine, such as an agricultural sprayer, during an operation, or both.

While the various examples described herein proceed with respect to mobile agricultural machines, such as agricultural sprayers, and with respect to agricultural operations, such as agricultural spraying operations, it will be appreciated that the systems and methods described herein are applicable to various other mobile machines and various other machine operations, for example forestry machines and forestry operations, constructions machines and construction operations, and turf management machines and turf management operations. Additionally, while examples herein proceed with respect to certain example product application machines, such as certain example spraying machines, it will be appreciated that the systems and methods described herein are applicable to various other types of product application machines, including various other types of agricultural spraying machines, as well as, for example, but not by limitation, dry material spreaders. For illustration, but not by limitation, a dry material spreader can include a dry material receptacle that receives, holds, and transports dry material, such as dry fertilizer, that is to be spread on a worksite.

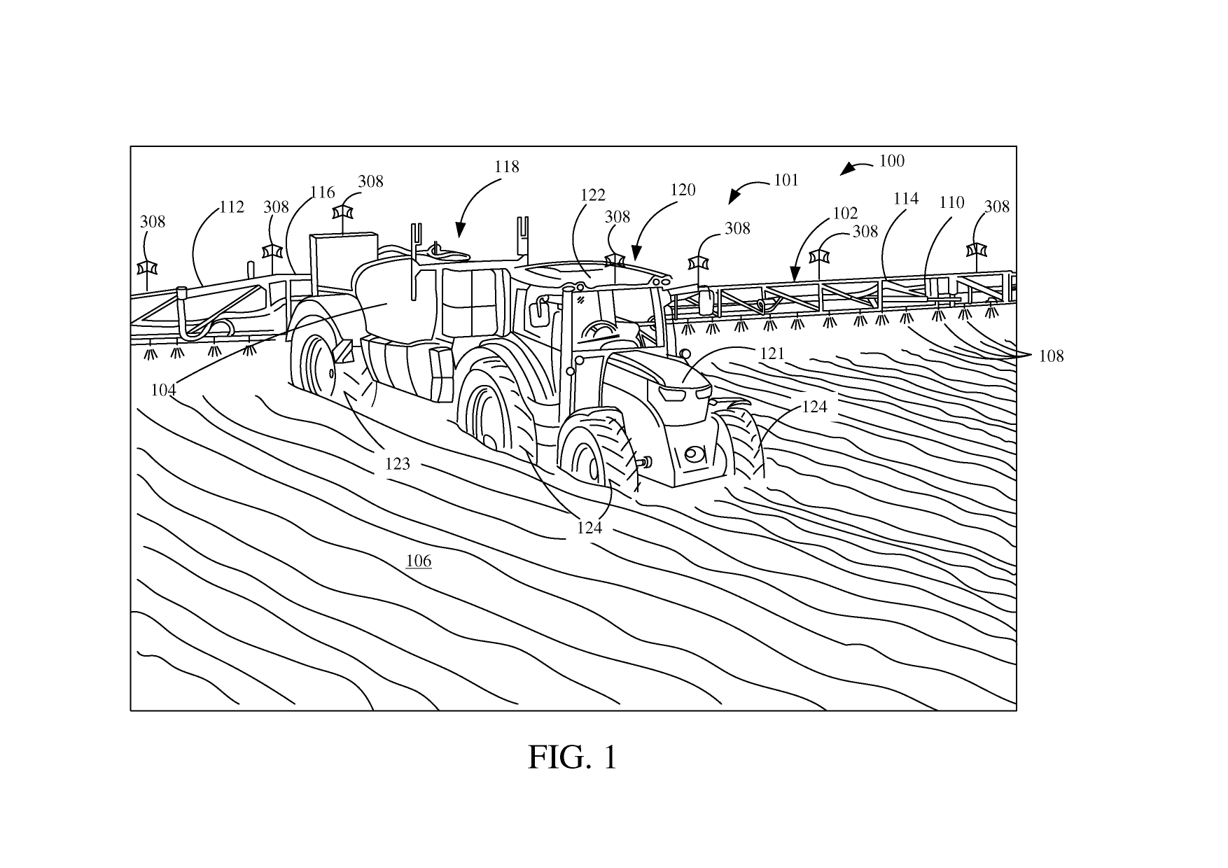

FIG. 1 illustrates an agricultural spraying machine (or agricultural sprayer) 101 as one example of a mobile machine 100. Sprayer 101 includes a spraying system 102 having a tank 104 containing a product, such as a liquid product, that is to be applied to field 106. Tank 104 is fluidically coupled to spray nozzles 108 by a delivery system comprising a set of conduits. A fluid pump is configured to pump the product from tank 104 through the conduits and through nozzles 108 to apply the product to the field 106. In some examples, the fluid pump is actuated by operation of a motor, such as an electric motor or hydraulic motor, that drives the pump.

Spray nozzles 108 are coupled to, and spaced apart along, boom 110. Boom 110 includes arms 112 and 114 which are coupled to a center frame 116. In some examples, arms 112 and 114 can articulate and pivot relative to center frame 116. In some examples, center frame can be actuated up and down to adjust its height above field 106. In some examples, arms 112 and 114 can articulate and pivot relative to center frame 116 and center frame 116 can be actuated up and down. Thus, in some examples, arms 112 and 114 are movable between a storage or transport position and an extended or deployed position (shown in FIG. 1). The boom 110, including each arm 112 and 114, can include multiple discrete and controllable sections which are supplied product from tank 104 by the fluid pump through a respective conduit of each section.

Each section can include a respective set of one or more spray nozzles 108. Each section can be activated or deactivated through the actuation of a corresponding controllable valve, for instance, a section can be deactivated, that is the section or the nozzles of the section, or both, are prevented from receiving fluid, by actuation of a controllable valve that is upstream of the section or the nozzles, or both. In some examples, the nozzles of the section may each have an associated controllable valve which can be actuated to activate or deactivate the nozzles. The application rate of product is the rate (volumetric rate) at which product is applied to the field over which sprayer 100 travels. The application rate corresponds to a volumetric flow rate of the product from the tank 104 through the spray nozzles 108. The volumetric flow rate is controlled by operation of the pump, such as by varying the speed of actuation of the pump with an associated motor. In some examples, where the application rate is controlled for individual sections or for individual nozzles, a controllable valve, such as solenoid valve, a piezo valve, or the like, that corresponds to each section or to each nozzle, can be operable to reciprocate (e.g., pulse) between a closed state and an open state at variable frequency (e.g., pulse width modulation control) to control the rate at which the product is discharged from the set of spray nozzles 108 of the respective section or from the respective individual spray nozzle 108.

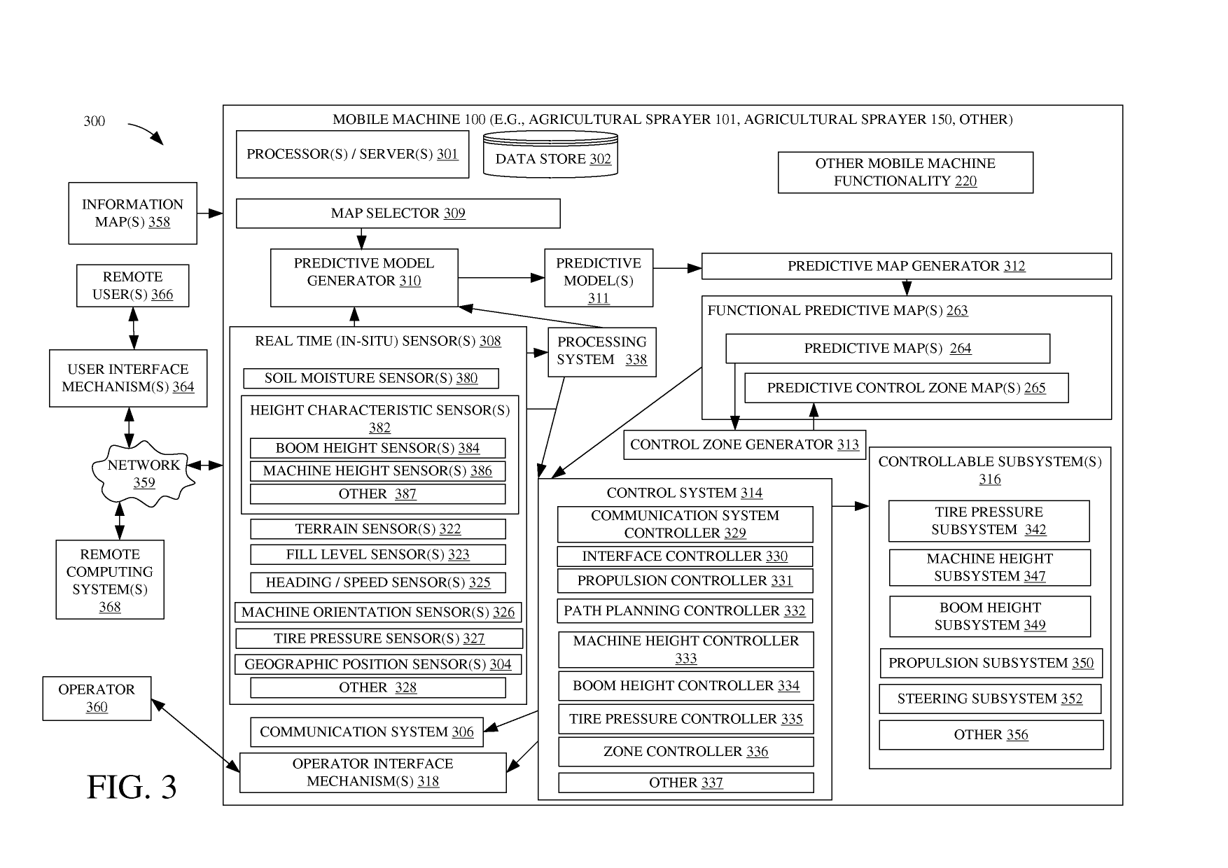

In the example illustrated in FIG. 1, agricultural sprayer 101 comprises a towed implement 118 that carries the spraying assembly, and a towing or support machine 120 (illustratively a tractor) that tows the towed spraying implement 118. Towed implement 118 includes a set of ground engaging elements, such as wheels 123 (which can include tires). Towing machine 120 includes a power plant 121, such as internal combustion engine that drives rotation of a set of ground engaging elements, such as wheels 124, to propel the sprayer 101 over field 106 at variable speeds. The ground engaging elements can also be tracks, or other traction elements as well. In the example illustrated, towing machine 120 includes an operator compartment or cab 122, which can include a variety of different operator interface mechanisms (e.g., 318 shown in FIG. 3) for controlling agricultural sprayer 101.

Agricultural sprayer 101 can include a variety of in-situ sensors 308 (some of which will be described in more detail in FIG. 3). The in-situ sensors 308 can be disposed at a plurality of different locations on sprayer 101. Some of which are shown in FIG. 1, such as on towing machine 120 or towed implement 118, as well as a plurality of in-situ sensors 308 mounted to and spaced apart along boom 110. In-situ sensors 308 can include one or more different types of sensors, such an imaging system, for instance a camera (e.g., a stereo camera), optical sensors, lidar, radar, sonar, ultrasonic, capacitive sensors, as well as various other sensors, including, but not limited to those described below in FIG. 3. As will be described in more detail below, in-situ sensors 308 can detect various characteristics at the worksite, such as, but not limited to, soil moisture, height characteristics, such as boom height or machine, or both, as well as various other characteristics.

Additionally, agricultural sprayer 101 can include a machine height subsystem which includes one or more machine height actuators, such as hydraulic actuators, or pneumatic actuators (such as inflatable and deflatable air bags), electromechanical actuators, etc., which can adjust the height of a main frame of implement 118 above field 106, such as by adjusting a distance between the main frame and the corresponding axles of ground engaging elements 123. Thus, machine height actuators, in one example, act as an adjustable suspension that can raise and lower the height of the sprayer 101 above the surface over which it travels. These are merely some examples.

Further, agricultural sprayer 101 can include a boom height subsystem which includes one or more boom height actuators such as hydraulic actuators, pneumatic actuators, electromechanical actuators, etc., which raise and lower the height of boom 110 above the surface over which sprayer 101 travels. In some examples, the boom height actuators drive movement of center frame 116. In some examples, the boom height actuators drive rotation of arms 112 and 114. In some examples, each arm 112 and 114 can have multiple sections, each section having a corresponding boom height actuator that drives movement (e.g., rotation) of its corresponding section. These are merely some examples.

The agricultural sprayer 101 can also include a tire pressure subsystem that controllably inflates and deflates ground engaging elements in the form of wheels with tires. The tire pressure subsystem can controllably supply gas (such as air) to one or more tires to increase their internal pressure and can controllably release gas (such as air) from one or more tires to decrease their internal pressure.

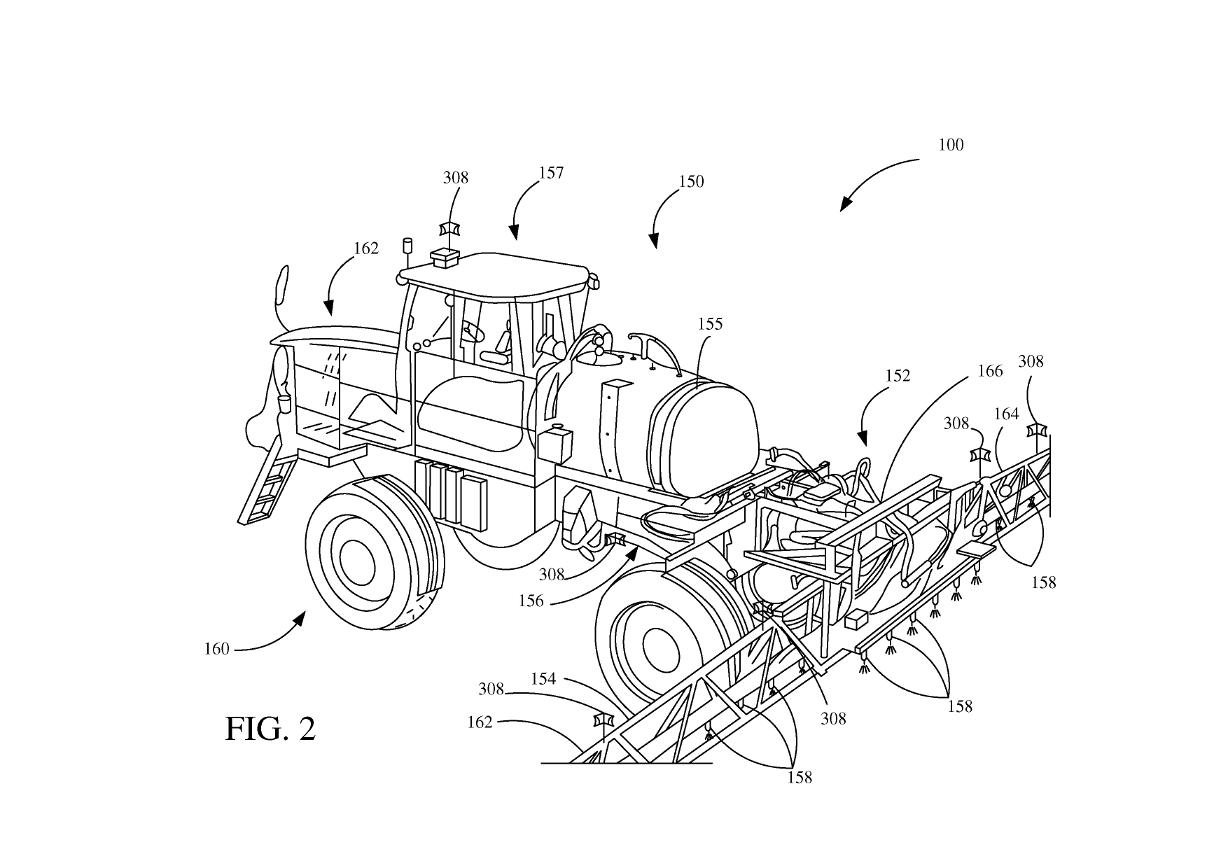

FIG. 2 illustrates one example of an agricultural sprayer 150 that is self-propelled as an example mobile machine 100. Sprayer 150 has an on-board spraying system 152, including, among other things, a tank 155 containing a product and a boom 154, that is carried on a machine frame 156 having an operator compartment 157, a set of ground engaging elements 160, such as wheels (with corresponding tires) or tracks, and a power plant 162, such as an internal combustion engine, that drives rotation of ground engaging elements 160 to propel sprayer 150 over the worksite (field) at which it operates. Operator compartment 157 can include a variety of different operator interface mechanisms (e.g., 318 shown in FIG. 3) for controlling agricultural sprayer 150. Tank 155 is fluidically coupled to spray nozzles 158 by a delivery system comprising a set of conduits. A fluid pump is configured to pump the product from tank 155 through the conduits and through nozzles 158 to apply the product to the field over which agricultural sprayer 150 travels. In some examples, the fluid pump is actuated by operation of a motor, such as an electric motor or hydraulic motor, that drives the pump.

Spray nozzles 158 are coupled to, and spaced apart along, boom 154. Boom 154 includes arms 162 and 164 which are coupled to a center frame 166. In some examples, arms 162 can articulate or pivot relative to center frame 166, such as by actuation of one or more actuators. Thus, arms 162 and 164 are movable between a storage or transport position and an extended or deployed position (shown in FIG. 2). In some examples, center frame 166 can be actuated up and down (by one or more actuators) to change a height of center frame 166 above the worksite. The boom 154, including each arm 162 and 164, can include multiple discrete and controllable sections which are supplied product from tank 155 by the fluid pump through a respective conduit of each section.

Each section can include a respective set of one or more spray nozzles 158. Each section can be activated or deactivated through the actuation of a corresponding controllable valve, for instance, a section can be deactivated, that is the section or the nozzles of the section, or both, are prevented from receiving fluid, by actuation of a controllable valve that is upstream of the section or the nozzles, or both. In some examples, the nozzles of the section may each have an associated controllable valve which can be actuated to activate or deactivate the nozzles. The application rate of product is the rate (volumetric rate) at which product is applied to the field over which sprayer 150 travels. The application rate corresponds to a volumetric flow rate of the product from the tank 155 through the spray nozzles 158. The volumetric flow rate is controlled by operation of the pump, such as by varying the speed of actuation of the pump with an associated motor. In some examples, where the application rate is controlled for individual sections or for individual nozzles, a controllable valve, such as solenoid valve, a piezo valve, or the like, that corresponds to each section or to each nozzle, can be operable to reciprocate (e.g., pulse) between a closed state and an open state at variable frequency (e.g., pulse width modulation control) to control the rate at which the product is discharged from the set of spray nozzles 158 of the respective section or from the respective individual spray nozzle 158.

Agricultural sprayer 150 can include a variety of in-situ sensors 308 (some of which will be described in more detail in FIG. 3). The in-situ sensors 308 can be disposed at a plurality of different locations on sprayer 150. Some of which are shown in FIG. 2. In-situ sensors 308 can include one or more different types of sensors, such an imaging system, for instance a camera (e.g., a stereo camera), optical sensors, lidar, radar, sonar, ultrasonic, capacitive sensors, as well as various other sensors, including, but not limited to those described below in FIG. 3. As will be described in more detail below, in-situ sensors 308 can detect various characteristics at the worksite, such as, but not limited to, soil moisture, height characteristics, such as boom height or machine, or both, as well as various other characteristics.

Additionally, agricultural sprayer 150 can include a machine height subsystem which includes one or more machine height actuators, such as hydraulic actuators, or pneumatic actuators (such as inflatable and deflatable air bags), electromechanical actuators, etc., which can adjust the height of a main frame 156 of sprayer 150 above the field, such as by adjusting a distance between the main frame 156 and the corresponding axles of ground engaging elements 160. Thus, machine height actuators, in one example, act as an adjustable suspension that can raise and lower the height of the sprayer 150 above the surface over which it travels. These are merely some examples.

Further, agricultural sprayer 150 can include a boom height subsystem which includes a plurality of boom height actuators such as hydraulic actuators, pneumatic actuators, electromechanical actuators, etc., which raise and lower the height of boom 110 above the surface over which sprayer 150 travels. In some examples, the boom height actuators drive movement of center frame 166. In some examples, the boom height actuators drive rotation of arms 162 and 164. In some examples, each arm 162 and 164 can have multiple sections, each section having a corresponding boom height actuator that drives movement (e.g., rotation) of its corresponding section. These are merely some examples.

The agricultural sprayer 150 can also include a tire pressure subsystem that controllably inflates and deflates ground engaging elements in the form of wheels with tires. The tire pressure subsystem can controllably supply gas (such as air) to one or more tires to increase their internal pressure and can controllably release gas (such as air) from one or more tires to decrease their internal pressure.

FIG. 3 is a block diagram showing some portions of an agricultural spraying system architecture 300. FIG. 3 shows that agricultural spraying system architecture 300 includes mobile machine 100 (e.g., sprayer 101 or 150), one or more remote computing systems 368, one or more remote user interfaces 364, network 359, and one or more information maps 358. Mobile machine 100, itself, illustratively includes one or more processors or servers 301, data store 302, communication system 306, one or more in-situ sensors 308 that sense one or more characteristics at a worksite concurrent with an operation, and a processing system 338 that processes the sensors signals generated by in-situ sensors 308 to generate processed sensor data. The in-situ sensors 308 generate values corresponding to the sensed characteristics. Mobile machine 100 also includes a predictive model or relationship generator (collectively referred to hereinafter as “predictive model generator 310”), predictive model or relationship (collectively referred to hereinafter as “predictive model 311”), predictive map generator 312, control zone generator 313, control system 314, one or more controllable subsystems 316, and an operator interface mechanism 318. The mobile machine 100 can also include a wide variety of other machine functionality 320.

The in-situ sensors 308 can be on-board mobile machine 100, remote from mobile machine 100, such as deployed at fixed locations on the worksite or on another machine operating in concert with mobile machine 100, such as an aerial vehicle, and other types of sensors, or a combination thereof. In-situ sensors 308 sense characteristics at a worksite during the course of an operation. In-situ sensors 308 illustratively include one or more soil moisture sensors 380, one or more height characteristic sensors 382, one or more terrain sensors 322, one or more fill level sensors 323, one or more boom height sensors 324, one or more heading/speed sensors 325, one or more machine orientation sensors 326, one or more tire pressure sensors 327, one or more geographic position sensors 304, and can include various other sensors 328. Height characteristic sensors 382 can include boom height sensors 384, machine height sensors 386, and can include other sensors 328 as well.

Geographic position sensors 304 illustratively sense or detect the geographic position or location of mobile machine 100. Geographic position sensors 304 can include, but are not limited to, a global navigation satellite system (GNSS) receiver that receives signals from a GNSS satellite transmitter. Geographic position sensors 304 can also include a real-time kinematic (RTK) component that is configured to enhance the precision of position data derived from the GNSS signal. Geographic position sensors 304 can include a dead reckoning system, a cellular triangulation system, or any of a variety of other geographic position sensors. In some examples, the geographic position or location detected by geographic position sensors 304 can be processed to derive a geographic position or location of a given component of mobile machine 100, such as the geographic position or location of an individual section of a boom or the geographic position or location of an individual spray nozzle. The dimensions of the mobile machine, such as the distance of certain components from the geographic position sensors 304, which can be stored in data store 302 or otherwise provided, can be used, in combination with detected geographic position or location, to derive the geographic position or location of the component. This processing can be implemented by processing system 338.

Soil moisture sensors 380 illustratively sense soil moisture at the worksite at which mobile machine 100 is operating. Soil moisture values can be specific unit measurements, such as percentage, or can be a more general value such wet (moisture present) or not wet (moisture not present) or wet or dry, such as wet or dry relative to a threshold. Soil moisture sensors 380 can include imaging systems, such as cameras (e.g., stereo cameras), that capture images of the soil and identify wetness of the soil, sensors that detect electromagnetic radiation, such as infrared, as well as various other wavelengths of electromagnetic radiation. Soil moisture sensors 380 can also include a sensing device that engages the soil at the worksite such as capacitive sensor. Various other forms of soil moisture sensors are also contemplated herein.

Height characteristic sensors 382 sense height of components of the mobile machine 100 above the worksite at which mobile machine 100 is operating. Height characteristic sensors 382 can include one or more of imaging systems, such as a camera (e.g., stereo camera), optical sensors, lidar, radar, ultrasound, sonar, as well as a variety of other types of sensors, such as potentiometers and hall effect sensors.

Height characteristic sensors 382 include boom height sensors 384. Boom height sensors 384 illustratively detect a height of the boom (e.g., 110 or 154, etc.) of mobile machine 100 above the worksite or above the crop (crop canopy) at the worksite at which mobile machine 100 is operating. Boom height sensors 384 may include imaging systems, such as cameras (e.g., stereo cameras), optical sensors, lidar, radar, ultrasound, sonar, as well as various other types of sensors. One or more boom height sensors 384 can be mounted on and spaced apart along the boom of mobile machine 100 and disposed to detect a surface of the worksite or to detect the canopy of the crop. In other examples, boom height sensors 384 may include sensors that detect the operating parameters of the boom height actuators (e.g., displacement of the boom height actuator, etc.), along with various other data (e.g., geographic position data, terrain/topography, machine orientation, machine dimensions, etc.) to derive machine height. In some examples, boom height sensors 384 may detect a distance between the boom and another component of the mobile machine 100.

Height characteristic sensors 382 also include machine height sensors 386. Machine height sensors 386 illustratively detect a height of a main frame of mobile machine 100 above a surface of the worksite at which mobile machine 100 is operating. Machine height sensors 386 may include imaging systems, such as cameras boom height sensors 324 may include imaging systems, such as cameras (e.g., stereo cameras), optical sensors, lidar, radar, ultrasound, sonar, as well as various other types of sensors. One or more machine height sensors 386 can be mounted on the main frame of mobile machine 100 and be disposed to detect a surface of the worksite. In other examples, machine height sensors 386 may include sensors that detect the operating parameters of the machine height actuators (e.g., displacement of the machine actuator, fill or pressure of air bags, etc.), along with various other data (e.g., geographic position data, terrain/topography, machine orientation, machine dimensions, etc.) to derive machine height. In some examples, machine height sensors 386 may detect a distance between the main frame and another component of the mobile machine 100, such as an axle or ground engaging element.

Heading/speed sensors 325 detect a heading and speed at which mobile machine 100 is traversing the worksite during the operation. This can include sensors that sense the movement of ground-engaging elements (e.g., wheels or tracks 123, 124, 160, etc.) or can utilize signals received from other sources, such as geographic position sensor 304, thus, while heading/speed sensors 325 as described herein are shown as separate from geographic position sensor 304, in some examples, machine heading/speed is derived from signals received from geographic positions sensors and subsequent processing. In other examples, heading/speed sensors 325 are separate sensors and do not utilize signals received from other sources.

Terrain sensors 322 illustratively detect terrain characteristics of the worksite at which mobile machine 100 is operating, such as a terrain surface profile (e.g., slope) of the worksite around mobile machine 100. Terrain sensors 322 may include imaging systems, such as cameras (e.g., stereo cameras), optical sensors, lidar, radar, ultrasound, sonar, as well as various other types of sensors. Terrain sensors 322 can include inertial measurement units (IMUs), accelerometers, gyroscopes, or magnetometers, that sense machine dynamics, such as machine orientation (e.g., pitch, roll, and yaw) which can be used, in combination with other data (e.g., machine dimensions), to derive a terrain profile. Terrain data can be used to predict machine orientation at areas of the worksite ahead of (or around) mobile machine 100.

Fill level sensors 323 illustratively detect a fill level of the product tank (e.g., 104, 155, etc.) of mobile machine 100. Fill level sensors may include float gauges, inductive or capacitive sensors, as well as a variety of other suitable fill level sensors.

Machine orientation sensors 326 illustratively detect machine orientation characteristics (e.g., pitch, roll, and yaw) of mobile machine 100 at the worksite. Machine orientation sensors 326 can include one or more inertial measurement units (IMUs). The one or more IMUs can include accelerometers, gyroscopes, and magnetometers.

Tire pressure sensors 327 illustratively detect an internal pressure of a tire of a ground engaging element of mobile machine 100. Tire pressure sensors can be mounted on the wheel of a ground engaging elements and be disposed to have sensing access to an internal volume of the tire.

Other in-situ sensors 328 can be on-board mobile machine 100 or can be remote from mobile machine 100, such as other in-situ sensors 328 on-board another mobile machine that capture in-situ data at the worksite or sensors at fixed locations throughout the worksite. The remote data from remote sensors can be obtained by mobile machine 100 via communication system 306 over network 359. Some examples of other sensors 328 are flow rate sensors, such as flowmeters, pressure sensors, such as pressure transducers.

In-situ data includes data taken from a sensor on-board the mobile machine 100 or taken by any sensor where the data are detected during the operation of mobile machine 100 at a field.

Processing system 338 processes the sensor data (e.g., signals, images, etc.) generated by in-situ sensors 308 to generate processed sensor data indicative of the sensed variables. For example, processing system 338 generates processed sensor data indicative of sensed variable values based on the sensor data generated by in-situ sensors, such as soil moisture values based on sensor data generated by soil moisture sensors 380. In another example, processing system 338 generates processed sensor data indicative of height characteristic values based on sensor data generated by height characteristic sensors 382. For example, processing system 338 generates processed sensor data indicative of boom height values based on sensor data generated by boom height sensors 384. In another example, processing system 338 generates processed sensor data indicative of machine height values based on sensor data generated by machine height sensors 386. Additionally, processing system 338 can generate processed sensor data indicative of other sensed variable values such as geographic location values based on sensor data generated by geographic position sensors 304, terrain value based on sensor data generated by terrain sensors 322, fill level values based on sensor data generated by fill level sensors 323, machine speed (travel speed, acceleration, deceleration, etc.) values or heading values, or both, based on sensor data generated by heading/speed sensors 325, machine orientation values based on sensor data generated by machine orientation sensors 326, tire pressure values based on sensor data generated by tire pressure sensors 327, as well as various other values based on sensors signals generated by various other in-situ sensors 328. It will also be understood that in generating processed sensor data and the variable values, processing system 338 can utilize sensor data from multiple different sensors.

It will be understood that processing system 338 can be implemented by one or more processers or servers, such as processors or servers 301. Additionally, processing system 338 can utilize various sensor signal filtering techniques, noise filtering techniques, sensor signal categorization, aggregation, normalization, as well as various other processing functionalities. Similarly, processing system 338 can utilize various image processing techniques such as, sequential image comparison, RGB color extraction, edge detection, black/white analysis, machine learning, neural networks, pixel testing, pixel clustering, shape detection, as well any number of other suitable image processing and data extraction functionalities.

FIG. 3 shows that an operator 360 may operate mobile machine 100. The operator 360 interacts with operator interface mechanisms 318. In some examples, operator interface mechanisms 318 may include joysticks, levers, a steering wheel, linkages, pedals, buttons, key fobs, wireless devices, such as mobile computing devices, dials, keypads, a display device with actuatable display elements (such as icons, buttons, etc.), a microphone and speaker (where speech recognition and speech synthesis are provided), among a wide variety of other types of control devices. Where a touch sensitive display system is provided, operator 360 may interact with operator interface mechanisms 318 using touch gestures. These examples described above are provided as illustrative examples and are not intended to limit the scope of the present disclosure. Consequently, other types of operator interface mechanisms 318 may be used and are within the scope of the present disclosure.

FIG. 3 also shows one or more remote users 366 interacting with mobile machine 100 or remote computing systems 368, or both, through user interface mechanisms 364 over network 359. User interface mechanisms 364 can include joysticks, levers, a steering wheel, linkages, pedals, buttons, key fobs, wireless devices, such as mobile computing devices, dials, keypads, a display device with actuatable display elements (such as icons, buttons, etc.), a microphone and speaker (where speech recognition and speech synthesis are provided), among a wide variety of other types of control devices. Where a touch sensitive display system is provided, a remote user 364 may interact with user interface mechanisms 364 using touch gestures. These examples described above are provided as illustrative examples and are not intended to limit the scope of the present disclosure. Consequently, other types of user interface mechanisms 364 may be used and are within the scope of the present disclosure.

Remote computing systems 368 can be a wide variety of different types of systems, or combinations thereof. For example, remote computing systems 368 can be in a remote server environment. Further, remote computing systems 368 can be remote computing systems, such as mobile devices, a remote network, a farm manager system, a vendor system, or a wide variety of other remote systems. In one example, mobile machine 100 can be controlled remotely by remote computing systems 368 or by remote users 366, or both. As will be described below, in some examples, one or more of the components shown being disposed on mobile machine 100 in FIG. 3 can be located elsewhere, such as at remote computing systems 368 and/or user interface mechanisms 364, as well as various other locations.

Control system 314 includes communication system controller 329, operator interface controller 330, propulsion controller 331, path planning controller 332, machine height controller 333, boom height controller 334, tire pressure controller 335, zone controller 336, and control system 314 can include other items 337, such as various other controllers. Controllable subsystems 316 include tire pressure subsystem 342, machine height subsystem 347, boom height subsystem 349, propulsion subsystem 350, steering subsystem 352, and controllable subsystems 316 can include a wide variety of other controllable subsystems 356.

Tire pressure subsystem 342 illustratively includes a one or more pressure sources, such as one or more compressors or sources of compressed gas, as well as associated controllable valves. The controllable valves can be activated or deactivated to control a supply of gas (such as air) from the one or more pressure sources to the tires, to inflate the tires as well as to release gas (such as air) from the tires to deflate the tires. For instance, each tire can have one or more corresponding controllable valves that control the flow of gas (from the one or more pressure source) into the tire and control the flow of gas out of the tire.

Machine height subsystem 347 illustratively includes a plurality of machine height actuators, such as hydraulic actuators, pneumatic actuators (e.g., inflatable and deflatable air bags, as well as other types of pneumatic actuators), electromechanical actuators, as well as various other types of actuators. The machine height actuators can be controllably adjusted to vary a height of the mobile machine 100 above a surface of the worksite (e.g., vary a height of a frame of the mobile machine 100 above the worksite). In some examples, a machine height actuator can be disposed between an axle and the frame of the mobile machine 100. The machine height subsystem 347 includes respective supply elements (e.g., hydraulic fluid source and hydraulic pump, air compressor, electric motor, etc.), as well as, in some examples, one or more controllable valves, to controllably adjust the respective actuators. In the example of a hydraulic actuator, hydraulic fluid can be controllably supplied to or withdrawn from the hydraulic actuator to control extension and retraction of the hydraulic actuator. In the example of a pneumatic actuator, air can be controllably supplied to or withdrawn from the pneumatic actuator to control the extension and retraction of the pneumatic actuator. For instance, in the case of air bags, the air bags can be supplied with additional air to inflate (and thus extend or expand) or air can be withdrawn from the air bags to deflate (and thus retract or shrink) the air bags. In the example of an electromechanical actuator, the rotation of the electric motor can be controlled to extend or retract the electromechanical actuator. Various other forms of actuators and corresponding supply elements can be used.

Boom height subsystem 349 illustratively includes one or more boom height actuators, such as hydraulic actuators, pneumatic actuators, electromechanical actuators, as well as various other types of actuators. The boom height actuators can be controllably adjusted to vary a height of the boom (e.g., 110, 154, 202, etc.), or individual boom arms (e.g., 112, 114 or 162, 164), or individual boom sections, above the worksite at which mobile machine 100 is operating. In some examples, one or more boom height actuators controllable extend and retract to actuate movement of a center frame (e.g., 116 or 166) to which the boom arms are coupled to controllably vary a height of the boom above the worksite. In some examples, the boom arms are pivotally coupled to the center frame and a respective boom height actuator extends and retracts to rotate its respective boom arm to adjust the height of the boom arm above the worksite. In some examples, each boom arm includes multiple sections, the first pivotally coupled to the center frame, and the subsequent sections each pivotally coupled to the preceding section. Each section includes a respective boom height actuator that extends and retracts to rotate its respective section to adjust the height of the section above the worksite. The boom height subsystem 349 also includes supply elements appropriate for the particular type of actuators as well as, in some examples, one or more controllable valves, to controllably adjust the respective actuators.

Propulsion subsystem 350 illustratively includes the mobile machine powertrain, which includes a power plant (e.g., 121, 162, etc.) and drivetrain elements. The operating parameters of the propulsion subsystem 350 can be controlled to adjust a speed characteristic (e.g., travel speed, acceleration, deceleration, etc.) of the mobile machine 100.

Steering subsystem 352 illustratively includes the steering wheel, steering column, rack and pinion, tie rods, one or more actuators (e.g., hydraulic actuators, pneumatic actuators, electromechanical actuators, etc.), as well as various other components. The actuators of the steering subsystem can be controlled to indirectly drive movement of the tie rods (such as by driving movement of the steering column) which in turn adjust the steering angle of the associated ground engaging elements and thus heading of mobile machine 100. Other forms of steering subsystems are also contemplated herein.

FIG. 3 also shows that mobile machine 100 can obtain one or more information maps 358. As described herein, the information maps 358 include, for example, a topographic map, a soil type map, a soil moisture map, an optical characteristic map, a tiling map, an irrigation map, a prior operation characteristic map, and a predictive soil moisture map. However, information maps 358 may also encompass other types of data, such as other types of data that were obtained prior to a spraying operation or a map from a prior operation. Additionally, information maps 358 may also encompass other types of maps that provide the same data but are derived from a different source. In other examples, information maps 358 can be generated during a current operation, such a map generated by predictive map generator 312 based on a predictive model 311 generated by predictive model generator 310.

Information maps 358 may be downloaded onto mobile machine 100 over network 359 and stored in data store 302, using communication system 306 or in other ways. In some examples, communication system 306 may be a cellular communication system, a system for communicating over a wide area network or a local area network, a system for communicating over a near field communication network, or a communication system configured to communicate over any of a variety of other networks or combinations of networks. Network 359 illustratively represents any or a combination of any of the variety of networks. Communication system 306 may also include a system that facilitates downloads or transfers of information to and from a secure digital (SD) card or a universal serial bus (USB) card or both.

Predictive model generator 310 generates a model that is indicative of a relationship between the values sensed by the in-situ sensors 308 and a value mapped to the field by the information maps 358. For example, if the information map 358 maps topographic characteristic values to different locations in the worksite, and the in-situ sensor 308 (e.g., soil moisture sensor 380) is sensing values indicative of soil moisture, then model generator 310 generates a predictive soil moisture model that models the relationship between the topographic characteristic values and the soil moisture values. In another example, if the information map 358 maps soil type values to different locations in the worksite, and the in-situ sensor 308 (e.g., soil moisture sensor 380) is sensing values indicative of soil moisture, then model generator 310 generates a predictive soil moisture model that models the relationship between the soil type values and the soil moisture values. In another example, if the information map 358 maps soil moisture values to different locations in the worksite, and the in-situ sensor 308 (e.g., soil moisture sensor 380) is sensing values indicative of in-situ soil moisture, then model generator 310 generates a predictive soil moisture model that models the relationship between the soil moisture values in the information map and in-situ soil moisture values. In another example, if the information map 358 maps optical characteristic values to different locations in the worksite, and the in-situ sensor 308 (e.g., soil moisture sensor 380) is sensing values indicative of soil moisture, then model generator 310 generates a predictive soil moisture model that models the relationship between the optical characteristic values and the soil moisture values. In another example, if the information map 358 maps tiling characteristic values to different locations in the worksite, and the in-situ sensor 308 (e.g., soil moisture sensor 380) is sensing values indicative of soil moisture, then model generator 310 generates a predictive soil moisture model that models the relationship between the tiling characteristic values and the soil moisture values. In another example, if the information map 358 maps irrigation operation characteristic values to different locations in the worksite, and the in-situ sensor 308 (e.g., soil moisture sensor 380) is sensing values indicative of soil moisture, then model generator 310 generates a predictive soil moisture model that models the relationship between the irrigation operation characteristic values and the soil moisture values. In another example, if the information map 358 maps prior operation characteristic values to different locations in the worksite, and the in-situ sensor 308 (e.g., soil moisture sensor 380) is sensing values indicative of soil moisture, then model generator 310 generates a predictive soil moisture model that models the relationship between the prior operation characteristic values and the soil moisture values. In another example, if the information map 358 maps other characteristic values to different locations in the worksite, and the in-situ sensor 308 (e.g., soil moisture sensor 380) is sensing values indicative of soil moisture, then model generator 310 generates a predictive soil moisture model that models the relationship between the other characteristic values and the soil moisture values.

In another example, if the information map 358 maps soil moisture values (predictive or measured) to different locations in the worksite, and the in-situ sensor 308 (e.g., height characteristic sensors 382) is sensing values indicative of height characteristics (e.g., boom height values, machine height values, etc.), then model generator 310 generates a predictive height characteristic model (e.g., predictive boom height model, predictive machine height model, etc.) that models the relationship between the soil moisture values and the height characteristic values (e.g., boom height values, machine height values, etc.). In another example, if the information map 358 maps other characteristic values to different locations in the field, and the in-situ sensor 308 is sensing values indicative of a height characteristic (e.g., boom height values, machine height values, etc.), then model generator 310 generates a predictive height characteristic model (e.g., predictive boom height model, predictive machine height model, etc.) that models the relationship between the other characteristic values and the height characteristic values.

In some examples, the predictive map generator 312 uses the predictive models generated by predictive model generator 310 to generate one or more functional predictive maps 263 that predict the value of a characteristic, such as soil moisture values or height characteristic values (e.g., boom height values, machine height values, etc.), sensed by the in-situ sensors 308 at different locations in the worksite based upon one or more of the information maps 358. For example, where the predictive model is a predictive soil moisture model that models a relationship between soil moisture values sensed by soil moisture sensors 380 and one or more of topographic characteristic values from a topographic map, soil type values from a soil type map, soil moisture values from a soil moisture map, optical characteristic values from an optical characteristic map, tiling characteristic values from a tiling map, irrigation values from an irrigation map, prior operation characteristic values from a prior operation characteristic map, and other characteristic values from another type of information map, then predictive map generator 312 generates a functional predictive soil moisture map that predicts soil moisture values at different locations at the worksite field based on one or more of the topographic characteristic values, the soil type values, the soil moisture values, the optical characteristic values, the tiling characteristic values, the irrigation values, the prior operation characteristic values, and the other characteristic values at those locations and the predictive soil moisture model.

In another example, where the predictive model is a predictive height characteristic model that models a relationship between height characteristic values sensed by height characteristic sensors 382 and one or more of soil moisture values from a soil moisture map, predictive soil moisture values from a predictive soil moisture map, and other characteristic values from another type of information map, then predictive map generator 312 generates a functional predictive height characteristic map that predicts height characteristic values at different locations at the worksite field based on one or more of the soil moisture values, the predictive soil moisture values, and the other characteristic values at those locations and the predictive crop characteristic model.

In some examples, the type of values in the functional predictive map 263 may be the same as the in-situ data type sensed by the in-situ sensors 308. In some instances, the type of values in the functional predictive map 263 may have different units from the data sensed by the in-situ sensors 308. In some examples, the type of values in the functional predictive map 263 may be different from the data type sensed by the in-situ sensors 308 but have a relationship to the type of data type sensed by the in-situ sensors 308. For example, in some examples, the data type sensed by the in-situ sensors 308 may be indicative of the type of values in the functional predictive map 263. In some examples, the type of data in the functional predictive map 263 may be different than the data type in the information maps 358. In some instances, the type of data in the functional predictive map 263 may have different units from the data in the information maps 358. In some examples, the type of data in the functional predictive map 263 may be different from the data type in the information map 358 but has a relationship to the data type in the information map 358. For example, in some examples, the data type in the information maps 358 may be indicative of the type of data in the functional predictive map 263. In some examples, the type of data in the functional predictive map 263 is different than one of, or both of, the in-situ data type sensed by the in-situ sensors 308 and the data type in the information maps 358. In some examples, the type of data in the functional predictive map 263 is the same as one of, or both of, of the in-situ data type sensed by the in-situ sensors 308 and the data type in information maps 358. In some examples, the type of data in the functional predictive map 263 is the same as one of the in-situ data type sensed by the in-situ sensors 308 or the data type in the information maps 358, and different than the other.

As an example, the information map 358 can be a topographic map and the in-situ sensor 308 is a soil moisture sensor 380 that senses a value indicative of soil moisture, predictive map generator 312 can use the topographic characteristic values in information map 358, and the model generated by predictive model generator 310, to generate a functional predictive map 263 that predicts the soil moisture value at different locations in the field. Predictive map generator 212 thus outputs predictive map 264. In another example, the information map can be a soil moisture map and the in-situ sensor 308 is a height characteristic sensor 382 (e.g., boom height sensor 384, machine height sensor 386, etc.) that senses a value indicative of a height characteristic (e.g., boom height value, machine height value, etc.), predictive map generator 312 can use the soil moisture values in information map 358, and the model generated by predictive model generator 310, to generate a functional predictive map 263 that predicts the height characteristic value at different locations in the field. Predictive map generator 212 thus outputs predictive map 264. These are merely some examples.

As shown in FIG. 3, predictive map 264 predicts the value of a sensed characteristic (sensed by in-situ sensors 308), or a characteristic related to the sensed characteristic, at various locations across the worksite based upon one or more information values in one or more information maps 358 at those locations and using the predictive model. For example, if predictive model generator 310 has generated a predictive model indicative of a relationship between optical characteristic values and soil moisture values, then, given the optical characteristic value at different locations across the worksite, predictive map generator 312 generates a predictive map 264 that predicts soil moisture values at those different locations across the worksite. The optical characteristic value, obtained from the optical characteristic map, at those locations and the relationship between optical characteristic values and soil moisture values, obtained from the predictive model, are used to generate the predictive map 264. In another example, if predictive model generator 310 has generated a predictive model indicative of a relationship between soil moisture values (measured or predictive) and height characteristic values (e.g., boom height values, machine height values, etc.), then, given the soil moisture value at different locations across the worksite, predictive map generator 312 generates a predictive map 264 that predicts height characteristic values at those different locations across the worksite. The soil moisture value, obtained from the soil moisture map, at those locations and the relationship between soil moisture values and height characteristic values, obtained from the predictive model, are used to generate the predictive map 264. These are merely some examples.

Some variations in the data types that are mapped in the information maps 358, the data types sensed by in-situ sensors 308, and the data types predicted on the predictive map 264 will now be described.

In some examples, the data type in one or more information maps 358 is different from the data type sensed by in-situ sensors 308, yet the data type in the predictive map 264 is the same as the data type sensed by the in-situ sensors 308. For instance, the information map 358 may be a topographic map, and the variable sensed by the in-situ sensors 308 may be soil moisture. The predictive map may then be a predictive soil moisture map that maps predictive soil moisture values to different geographic locations in the worksite. In another example, the information map may be a soil moisture map, and the variable sensed by the in-situ sensors may be a height characteristic, such as boom height or machine height. The predictive map 264 may then be a predictive height characteristic map, such as predictive boom height map or predictive machine height map, that maps predictive height characteristic values, such as predictive boom height values or predictive machine height values, to different geographic locations in the in the worksite.

Also, in other examples, the data type in the information map 358 is different from the data type sensed by in-situ sensors 308, and the data type in the predictive map 264 is different from both the data type in the information map 358 and the data type sensed by the in-situ sensors 308. For example, the information map 358 may be a prior operation characteristic map that maps, as prior operation characteristic values, residue characteristic values (e.g., residue distribution values) detected during a prior harvesting operation, and the variable sensed by the in-situ sensors 308 may be soil moisture. The predictive map may then be a predictive machine height characteristic map that maps predictive machine height characteristic values to different geographic locations in the worksite.

In other examples, the information map 358 is from a prior pass through the field during a prior operation and the data type is different from the data type sensed by in-situ sensors 308, yet the data type in the predictive map 264 is the same as the data type sensed by the in-situ sensors 308. For instance, the information map 358 may be an irrigation map generated during a previous irrigation operation on the worksite, and the variable sensed by the in-situ sensors 308 may be soil moisture. The predictive map 264 may then be a predictive soil moisture map that maps predictive soil moisture values to different geographic locations in the worksite. In another example, the information map 358 may be a soil moisture map generated during a previous operation on the worksite, and the variable sensed by the in-situ sensors 308 may be a height characteristic (e.g., boom height, machine height, etc.). The predictive map 264 may then be a predictive height characteristic map (e.g., predictive boom height map, predictive machine height map, etc.) that maps predictive height characteristic values (e.g., predictive boom height values, predictive machine height values, etc.) to different geographic locations in the worksite.

In some examples, the information map 358 is from a prior pass through the field during a prior operation and the data type is the same as the data type sensed by in-situ sensors 308, and the data type in the predictive map 264 is also the same as the data type sensed by the in-situ sensors 308. For instance, the information map 358 may be a machine height characteristic map generated during a previous year, and the variable sensed by the in-situ sensors 308 may be machine height characteristics. The predictive map 264 may then be a predictive machine height characteristic map that maps predictive machine height characteristic values to different geographic locations in the field. In such an example, the relative machine height characteristic differences in the georeferenced information map 358 from the prior year can be used by predictive model generator 310 to generate a predictive model that models a relationship between the relative machine height characteristic differences on the information map 358 and the machine height characteristic values sensed by in-situ sensors 308 during the current operation. The predictive model is then used by predictive map generator 310 to generate a predictive machine height characteristic map. In another example, the information map 358 may be a soil moisture map generated earlier in the same year, and the variable sensed by the in-situ sensors 308 may be soil moisture. The predictive map 264 may then be a predictive soil moisture map that maps predictive soil moisture values to different geographic locations in the field. In such an example, the relative soil moisture differences in the georeferenced information map 358 from earlier in the same year can be used by predictive model generator 310 to generate a predictive model that models a relationship between the relative soil moisture differences on the information map 358 and the soil moisture values sensed by in-situ sensors 308 during the current operation. The predictive model is then used by predictive map generator 310 to generate a predictive soil moisture map.

In some examples, predictive map 264 can be provided to the control zone generator 313. Control zone generator 313 groups adjacent portions of an area into one or more control zones based on data values of predictive map 264 that are associated with those adjacent portions. A control zone may include two or more contiguous portions of a worksite, such as a field, for which a control parameter corresponding to the control zone for controlling a controllable subsystem is constant. For example, a response time to alter a setting of controllable subsystems 316 may be inadequate to satisfactorily respond to changes in values contained in a map, such as predictive map 264. In that case, control zone generator 313 parses the map and identifies control zones that are of a defined size to accommodate the response time of the controllable subsystems 316. In another example, control zones may be sized to reduce wear from excessive actuator movement resulting from continuous adjustment. In some examples, there may be a different set of control zones for each controllable subsystem 316 or for groups of controllable subsystems 316. The control zones may be added to the predictive map 264 to obtain predictive control zone map 265. Predictive control zone map 265 can thus be similar to predictive map 264 except that predictive control zone map 265 includes control zone information defining the control zones. Thus, a functional predictive map 263, as described herein, may or may not include control zones. Both predictive map 264 and predictive control zone map 265 are functional predictive maps 263. In one example, a functional predictive map 263 does not include control zones, such as predictive map 264. In another example, a functional predictive map 263 does include control zones, such as predictive control zone map 265. In some examples, multiple crop genotypes (e.g., species, hybrids, cultivars, etc.) may be simultaneously present in a field. In that case, predictive map generator 312 and control zone generator 313 are able to identify the location and characteristics of the two or more crop genotypes and then generate predictive map 264 and predictive map with control zones 265 accordingly.

It will also be appreciated that control zone generator 313 can cluster values to generate control zones and the control zones can be added to predictive control zone map 265, or a separate map, showing only the control zones that are generated. In some examples, the control zones may be used for controlling or calibrating mobile machine 100 or both. In other examples, the control zones may be presented to the operator 360 or a user 366, or both, and used to control or calibrate mobile machine 100, and, in other examples, the control zones may be presented to the operator 360 or another user, such as a remote user 366, or stored for later use.

Predictive map 264 or predictive control zone map 265, or both, are provided to control system 314, which generates control signals based upon the predictive map 264 or predictive control zone map 265 or both. In some examples, communication system controller 329 controls communication system 306 to communicate the predictive map 264 or predictive control zone map 265 or control signals based on the predictive map 264 or predictive control zone map 265 to other mobile machines that are operating at the same worksite or in the same operation. In some examples, communication system controller 329 controls the communication system 306 to send the predictive map 264, predictive control zone map 265, or both to other remote systems, such as remote computing systems 368.

Communication system controller 329 is operable to generate control signals to control communication system 306 to communicate predictive map 264 or predictive control zone map 265, or both, or the data therefrom, to other systems, such as user interface mechanisms 364, remote computing systems 368, as well as various other systems, such as other mobile machines operating at the worksite. Additionally, communication system controller 329 is operable to generate control signals to control communication system 306 to communicate control signal (or data indicative of control commands) generated by other controllers of control system 314 to other systems, such as user interface mechanisms 364, remote computing systems 368, as well as various other systems, such as other mobile machine operating at the worksite.

Interface controller 330 is operable to generate control signals to control interface mechanisms, such as operator interface mechanisms 318 or user interface mechanisms 364, or both based on the predictive map 264, the predictive control zone map 265, or both. The interface controller 330 is also operable to present the predictive map 264 or predictive control zone map 265, or both, or other information derived from or based on the predictive map 264, predictive control zone map 265, or both, to operator 360 or a remote user 366, or both. Operator 360 may be a local operator or a remote operator. As an example, interface controller 330 generates control signals to control a display mechanism to display one or both of predictive map 264 and predictive control zone map 265 for the operator 360 or a remote user 366, or both. Interface controller 330 may generate operator or user actuatable mechanisms that are displayed and can be actuated by the operator or user to interact with the displayed map. The operator or user can edit the map by, for example, correcting a value displayed on the map, based on the operator’s or the user’s observation or desire. In other examples, interface controller is operable to generate control signals to control interface mechanisms, such as operator interface mechanisms 318 or user interface mechanisms 364, or both, to generate an alert, such as when a predictive value on predictive map 264 or predictive control zone map 265, is within a threshold or deviates from a threshold. For instance, a predictive soil moisture value may be within a threshold range of soil moisture values or outside of a range of threshold range of soil moisture values such that machine sinking (and thus height variation) is likely. In such an instance, an interface mechanism can be controlled to generate an alert that indicates this information. In another example, a predictive height characteristic value (e.g., predictive boom height value, predictive machine height value, etc.) may deviate, such as by a threshold amount, from a height characteristic value threshold or setpoint (e.g., boom height threshold or setpoint, machine height threshold or setpoint, etc.). In such an instance, an interface mechanism can be controlled to generate an alert that indicates this information. In some examples, in response to the alerts, the operator or user may control the mobile machine 100. In other examples, the mobile machine 100 may be automatically controlled and the alert is generated as well.

Propulsion controller 331 illustratively generates control signals to control propulsion subsystem 350 to control a speed setting, such as one or more of travel speed, acceleration, and deceleration, based on the predictive map 264, the predictive control zone map 265, or both. Propulsion subsystem includes a powerplant of the machine 100 (e.g., 121 or 162) as well as other powertrain components.

Path planning controller 332 illustratively generates control signals to control steering subsystem 352 to steer mobile machine 100 based on the predictive map 264, the predictive control zone map 265, or both. In some examples, path planning controller 332 can control a path planning system to generate a route for mobile machine 100 and can control propulsion subsystem 350 and steering subsystem 352 to propel and steer mobile machine along that route based on the predictive map 264, the predictive control zone map 265, or both.

Machine height controller 333 illustratively generates control signals to control machine height subsystem 347 to control a machine height setting, that is, a height of the mobile machine 100 (or a frame of the mobile machine 100) above the worksite at which mobile machine 100 operates, based on the predictive map 264, the predictive control zone map 265, or both.

Boom height controller 334 illustratively generates control signals to control boom height subsystem 349 to control a boom height setting, such as a height of the boom of mobile machine 100, a height of individual boom arms of mobile machine 100, or a height of individual boom sections of mobile machine 100, above the worksite at which mobile machine 100 operates, based on the predictive map 264, the predictive control zone map 265, or both.

Tire pressure controller 335 illustratively generates control signals to control tire pressure subsystem 342 to activate and increase pressure or decrease pressure in one or more tires of mobile machine 100 (e.g., tires of ground engaging elements 123 and/or 124 or 160) based on the predictive map 264, the predictive control zone map 265, or both.

Zone controller 336 illustratively generates control signals to control one or more controllable subsystems 316 to control operation of the one or more controllable subsystems 316 based on the predictive control zone map 265.

Other controllers 337 included on the mobile machine 100, or at other locations in agricultural spraying system 300, can control other subsystems based on one or more of the predictive map 264 and the predictive control zone map 265.

While the illustrated example of FIG. 3 shows that various components of agricultural spraying system architecture 300 are located on mobile machine 100, it will be understood that in other examples one or more of the components illustrated on mobile machine 100 in FIG. 3 can be located at other locations, such as one or more remote computing systems 368 or user interface mechanisms 364. For instance, one or more of data stores 302, map selector 309, predictive model generator 310, predictive model 311, predictive map generator 312, functional predictive maps 263 (e.g., 264 and 265), and control zone generator 313, can be located remotely from mobile machine 100 but can communicate with or be communicated to mobile machine 100 via communication system 306 and network 359. Thus, the predictive models 311 and functional predictive maps 263 may be generated at remote locations away from mobile machine 100 and be communicated to mobile machine 100 over network 359, for instance, communication system 306 can download the predictive models 311 and functional predictive maps 263 from the remote locations and store them in data store 302. In other examples, mobile machine 100 may access the predictive models 311 and functional predictive maps 263 at the remote locations without downloading the predictive models 311 and functional predictive maps 263. The information used in the generation of the predictive models 311 and functional predictive maps 263 may be provided to the predictive model generator 310 and the predictive map generator 312 at those remote locations over network 359, for example in-situ sensor data generator by in-situ sensors 308 can be provided over network 359 to the remote locations. Similarly, information maps 358 can be provided to the remote locations. These are merely examples.

In some examples, control system 314 can be located remotely from mobile machine 100 such as at one or more of remote computing systems 368 and remote user interface mechanisms 364. In other examples, a remote location, such as remote computing systems 368 or user interface mechanisms 364, or both, may include a respective control system which generates control values that can be communicated to mobile machine 100 and used by on-board control system 314 to control the operation of mobile machine 100. These are merely examples.

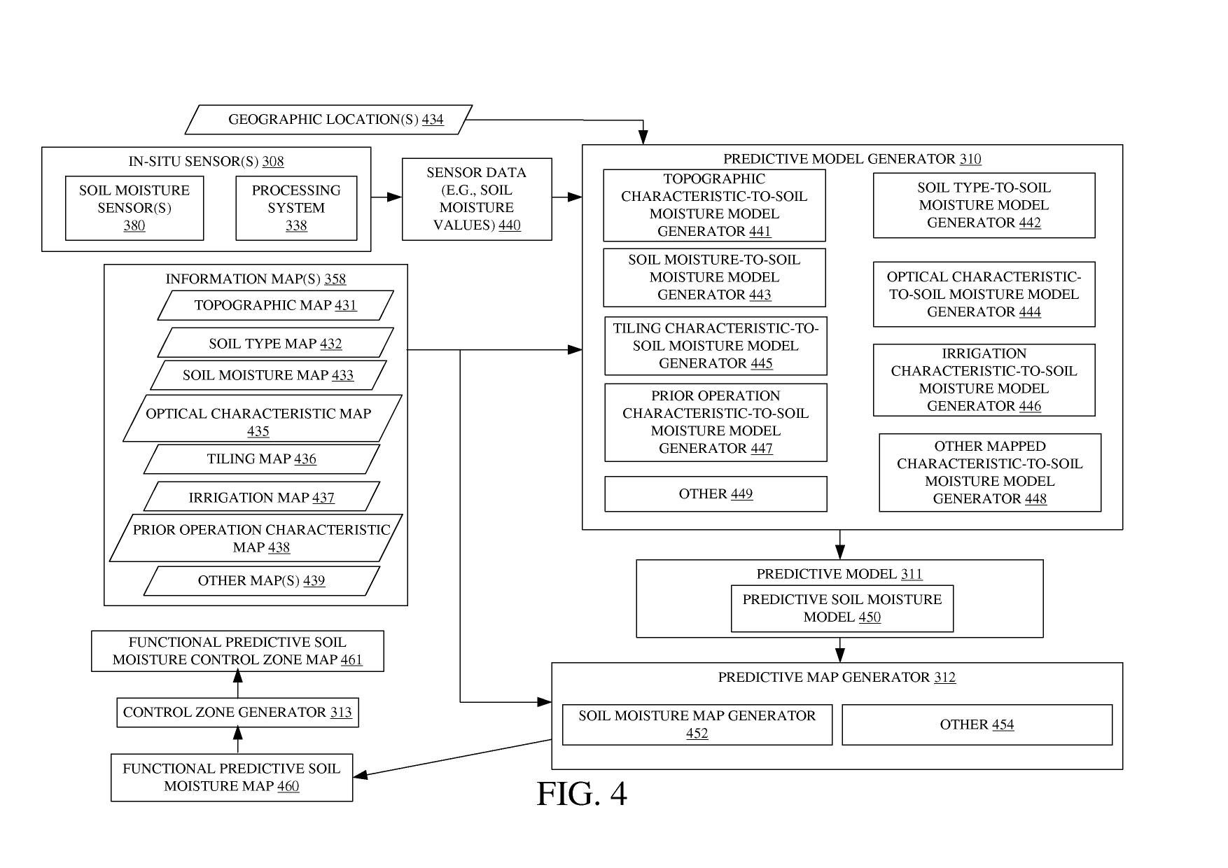

FIG. 4 is a block diagram of a portion of the agricultural spraying system architecture 300 shown in FIG. 3. Particularly, FIG. 4 shows, among other things, examples of the predictive model generator 310 and the predictive map generator 312 in more detail. FIG. 4 also illustrates information flow among the various components shown. The predictive model generator 310 receives one or more of a topographic map 431, a soil type map 432, a soil moisture map 433, an optical characteristic map 435, a tiling map 436, an irrigation map 437, a prior operation characteristic map 438, and another type of map 439. Predictive model generator 310 also receives one or more geographic locations 434, or an indication of one or more geographic locations, from a geographic position sensor 304, indicative of one or more geographic locations at the worksite corresponding to values detected by in-situ sensors 308. In-situ sensors 308 illustratively include soil moisture sensors 380, as well as a processing system 338. In some instances, soil moisture sensors 380 may be located on-board mobile machine 100. The processing system 338 processes sensor data generated from soil moisture sensors 380 to generate processed sensor data 440 indicative of soil moisture values. While the example shown in FIG. 4 illustrates processing system 338 as a component of in-situ sensors 308, in other examples, such as the example shown in FIG. 3, processing system 338 can be separate from in-situ sensors 308 but in operative communication with in-situ sensors 308.

It will be understood that in some examples, the geographic location detected by geographic position sensor 304 may not directly indicate the geographic location at the worksite to which the detected value corresponds. For instance, a soil moisture value may be detected by a soil moisture sensor 380 that is a given distance away from the geographic position sensor 304. In that case, the geographic location detected and provided by geographic position sensor 304 can be processed to derive a geographic location of the particular soil moisture sensor 380 such that the detected soil moisture value can be more precisely georeferenced. The distance between the soil moisture sensor 380 and geographic position sensor 304 can be known and stored in a data store. In any case, it will be understood that geographic locations 434 illustratively represented geographic locations on the worksite to which the detected values correspond.

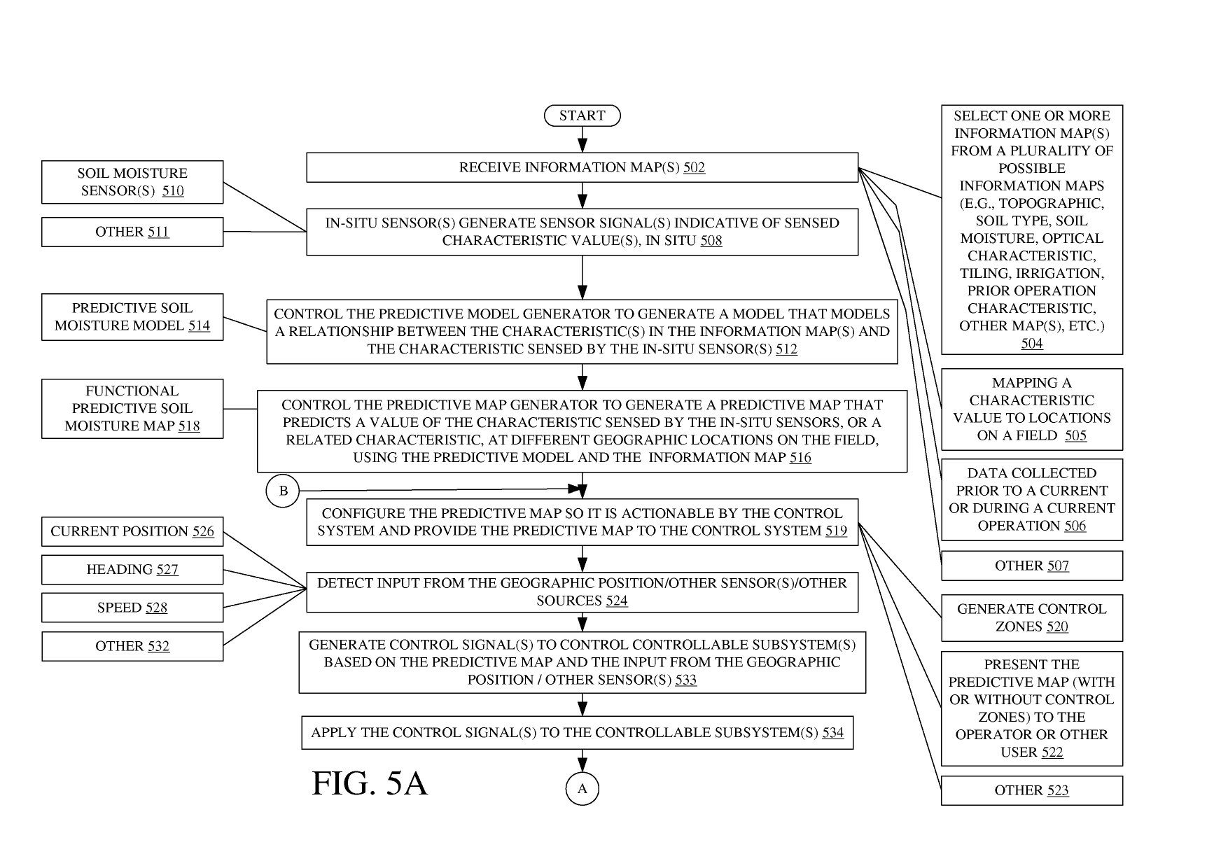

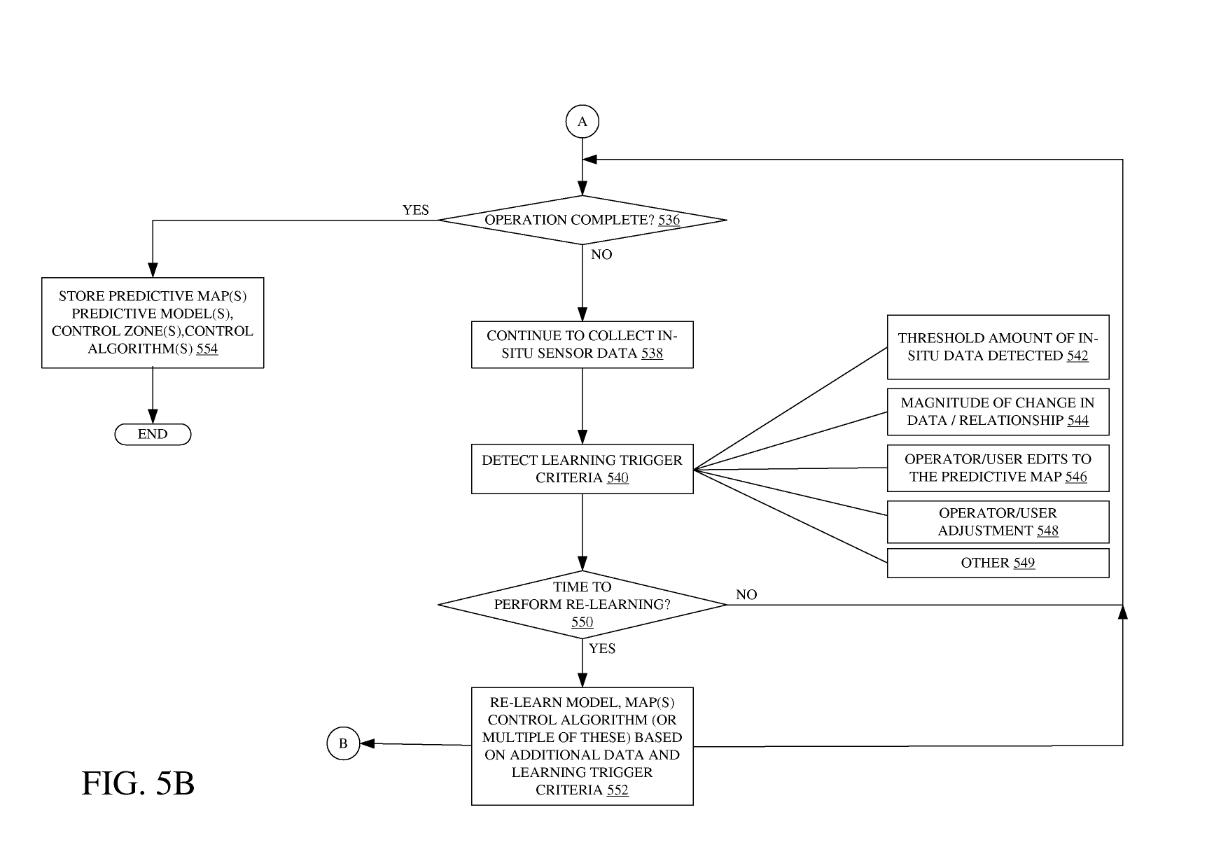

As shown in FIG. 5, the example predictive model generator 310 includes one or more of a topographic characteristic-to-soil moisture model generator 441, a soil type-to-soil moisture model generator 442, a soil moisture-to-soil moisture model generator 443, an optical characteristic-to-soil moisture model generator 444, a tiling characteristic-to-soil moisture model generator 445, an irrigation characteristic-to-soil moisture model generator 446, a prior operation characteristic-to-soil moisture model generator 447, and an other mapped characteristic-to-soil moisture model generator 448. In other examples, the predictive model generator 310 may include additional or different components than those shown in the example of FIG. 4. Consequently, in some examples, the predictive model generator 310 may include other items 449 as well, which may include other types of predictive model generators to generate other types of models.

Topographic characteristic-to-soil moisture model generator 441 identifies a relationship between soil moisture values detected in in-situ sensor data 440 and topographic characteristic values, from the topographic map 431, corresponding to the geographic location of the detected soil moisture values. Based on this relationship established by topographic characteristic-to-soil moisture model generator 441, topographic characteristic-to-soil moisture model generator 441 generates a predictive soil moisture model. The predictive soil moisture model is used by soil moisture map generator 452 to predict values of soil moisture (or the sensor values indicative of soil moisture values) at different locations in the worksite based upon the georeferenced topographic characteristic values contained in the topographic map 431 at those different locations in the worksite. Thus, for a given location in the worksite, soil moisture can be predicted at the given location based on the predictive soil moisture model generated by topographic characteristic-to-soil moisture model generator 441 and the topographic characteristic value, from the topographic map 431, at that given location.

Soil type-to-soil moisture model generator 442 identifies a relationship between soil moisture values detected in in-situ sensor data 440 and soil type values, from the soil type map 432, corresponding to the geographic location of the detected soil moisture values. Based on this relationship established by soil type-to-soil moisture model generator 442, soil type-to-soil moisture model generator 442 generates a predictive soil moisture model. The predictive soil moisture model is used by soil moisture map generator 452 to predict values of soil moisture (or the sensor values indicative of soil moisture values) at different locations in the worksite based upon the georeferenced soil type values contained in the soil type map 432 at those different locations in the worksite. Thus, for a given location in the worksite, soil moisture can be predicted at the given location based on the predictive soil moisture model generated by soil type-to-soil moisture model generator 442 and the soil type value, from the soil type map 432, at that given location.

Soil moisture-to-soil moisture model generator 443 identifies a relationship between soil moisture values detected in in-situ sensor data 440 and soil moisture values, from the soil moisture map 433, corresponding to the geographic location of the detected soil moisture values. Based on this relationship established by soil moisture-to-soil moisture model generator 443, soil moisture-to-soil moisture model generator 443 generates a predictive soil moisture model. The predictive soil moisture model is used by soil moisture map generator 452 to predict values of soil moisture (or the sensor values indicative of soil moisture values) at different locations in the worksite based upon the georeferenced soil moisture values contained in the soil moisture map 433 at those different locations in the worksite. Thus, for a given location in the worksite, soil moisture can be predicted at the given location based on the predictive soil moisture model generated by soil moisture-to-soil moisture model generator 443 and the soil moisture value, from the soil moisture map 433, at that given location.

Optical characteristic-to-soil moisture model generator 444 identifies a relationship between soil moisture values detected in in-situ sensor data 440 and optical characteristic values, from the optical characteristic map 435, corresponding to the geographic location of the detected soil moisture values. Based on this relationship established by optical characteristic-to-soil moisture model generator 444, optical characteristic-to-soil moisture model generator 444 generates a predictive soil moisture model. The predictive soil moisture model is used by soil moisture map generator 452 to predict values of soil moisture (or the sensor values indicative of soil moisture values) at different locations in the worksite based upon the georeferenced optical characteristic values contained in the optical characteristic map 435 at those different locations in the worksite. Thus, for a given location in the worksite, soil moisture can be predicted at the given location based on the predictive soil moisture model generated by optical characteristic-to-soil moisture model generator 444 and the optical characteristic value, from the optical characteristic map 435, at that given location.

Tiling characteristic-to-soil moisture model generator 445 identifies a relationship between soil moisture values detected in in-situ sensor data 440 and tiling characteristic values, from the tiling map 436, corresponding to the geographic location of the detected soil moisture values. Based on this relationship established by tiling characteristic-to-soil moisture model generator 445, tiling characteristic-to-soil moisture model generator 445 generates a predictive soil moisture model. The predictive soil moisture model is used by soil moisture map generator 452 to predict values of soil moisture (or the sensor values indicative of soil moisture values) at different locations in the worksite based upon the georeferenced tiling characteristic values contained in the tiling map 436 at those different locations in the worksite. Thus, for a given location in the worksite, soil moisture can be predicted at the given location based on the predictive soil moisture model generated by tiling characteristic-to-soil moisture model generator 445 and the tiling characteristic value, from the tiling map 436, at that given location.

Irrigation characteristic-to-soil moisture model generator 446 identifies a relationship between soil moisture values detected in in-situ sensor data 440 and irrigation characteristic values, from the irrigation map 437, corresponding to the geographic location of the detected soil moisture values. Based on this relationship established by irrigation characteristic-to-soil moisture model generator 446, irrigation characteristic-to-soil moisture model generator 446 generates a predictive soil moisture model. The predictive soil moisture model is used by soil moisture map generator 452 to predict values of soil moisture (or the sensor values indicative of soil moisture values) at different locations in the worksite based upon the georeferenced irrigation characteristic values contained in the irrigation map 437 at those different locations in the worksite. Thus, for a given location in the worksite, soil moisture can be predicted at the given location based on the predictive soil moisture model generated by irrigation characteristic-to-soil moisture model generator 446 and the irrigation characteristic value, from the irrigation map 437, at that given location.

Prior operation characteristic-to-soil moisture model generator 447 identifies a relationship between soil moisture values detected in in-situ sensor data 440 and prior operation characteristic values, from the prior operation characteristic map 438, corresponding to the geographic location of the detected soil moisture values. Based on this relationship established by prior operation characteristic-to-soil moisture model generator 447, prior operation characteristic-to-soil moisture model generator 447 generates a predictive soil moisture model. The predictive soil moisture model is used by soil moisture map generator 452 to predict values of soil moisture (or the sensor values indicative of soil moisture values) at different locations in the worksite based upon the georeferenced prior operation characteristic values contained in the prior operation characteristic map 438 at those different locations in the worksite. Thus, for a given location in the worksite, soil moisture can be predicted at the given location based on the predictive soil moisture model generated by prior operation characteristic-to-soil moisture model generator 447 and the prior operation characteristic value, from the prior operation characteristic map 438, at that given location.

Other mapped characteristic-to-soil moisture model generator 448 identifies a relationship between soil moisture values detected in in-situ sensor data 440 and other mapped characteristic values from an other map 439, corresponding to the geographic location of the detected soil moisture values. Based on this relationship established by other mapped characteristic-to-soil moisture model generator 448, other mapped characteristic-to-soil moisture model generator 448 generates a predictive soil moisture model. The predictive soil moisture model is used by soil moisture map generator 452 to predict values of soil moisture (or the sensor values indicative of soil moisture values) at different locations in the worksite based upon the georeferenced other characteristic values contained in the other map 439 at those different locations in the worksite. Thus, for a given location in the worksite, soil moisture can be predicted at the given location based on the predictive soil moisture model generated by other mapped characteristic-to-soil moisture model generator 448 and the other characteristic value, from the other map 439, at that given location.

In light of the above, the predictive model generator 310 is operable to produce a plurality of predictive soil moisture models, such as one or more of the predictive soil moisture models generated by model generators 441, 442, 443, 444, 445, 446, 447, 448 and 449. In another example, two or more of the predictive models described above may be combined into a single predictive soil moisture model, such as a predictive soil moisture model that predicts soil moisture based upon two or more of the topographic characteristic values, the soil type values, the soil moisture values, the optical characteristic values, the tiling characteristic values, the irrigation characteristic values, the prior operation characteristic values, and other mapped characteristic values at different locations in the field. Any of these soil moisture models, or combinations thereof, are represented collectively by predictive soil moisture model 450 in FIG. 4. Predictive soil moisture model 450 is an example of a predictive soil moisture model 311.

The predictive soil moisture model 450 is provided to predictive map generator 312. In the example of FIG. 4, predictive map generator 312 includes a soil moisture map generator 452. In other examples, predictive map generator 312 may include additional or different map generators. Thus, in some examples, predictive map generator 312 may include other items 454 which may include other types of map generators to generate other types of maps.

Soil moisture map generator 452 receives one or more of the topographic map 431, the soil type map 432, the soil moisture map 433, the optical characteristic map 435, the tiling map 436, the irrigation map 437, the prior operation characteristic map 438, and the other map 439 along with the predictive soil moisture model 450 which predicts soil moisture based upon one or more of a topographic characteristic value, a soil type value, a soil moisture value, an optical characteristic value, a tiling characteristic value, an irrigation characteristic value, a prior operation characteristic value, and an other mapped characteristic value and generates a predictive map that maps predictive soil moisture values at different locations in the worksite.

Predictive map generator 312 outputs a functional predictive soil moisture map 460 that is predictive of soil moisture. The functional predictive soil moisture map 460 is an example of a predictive map 264. The functional predictive soil moisture map 460 predicts soil moisture values at different locations in a worksite. The functional predictive soil moisture map 460 may be provided to control zone generator 313, control system 314, or both. Control zone generator 313 generates control zones and incorporates those control zones into the functional predictive soil moisture map 460 to produce a predictive control zone map 265, that is, a functional predictive soil moisture control zone map 461. One or both of functional predictive soil moisture map 460 and functional predictive soil moisture control zone map 461 can be provided to control system 314, which generates control signals to control one or more of the controllable subsystems 316 based upon the functional predictive soil moisture map 460, the functional predictive soil moisture control zone map 461, or both. Alternatively, or additionally, one or more of the functional predictive soil moisture map 460 and functional predictive soil moisture control zone map 461 can be provided to operator 360 on an operator interface mechanism 318 or to a remote user 366 on a user interface mechanism 364, or both.

FIGS. 5A-5B (collectively referred to herein as FIG. 5) show a flow diagram illustrating one example of the operation of agricultural spraying system architecture 300 in generating a predictive model and a predictive map.

At block 502, agricultural system 300 receives one or more information maps 358. Examples of information maps 358 or receiving information maps 358 are discussed with respect to blocks 504, 505, 506, and 507. As discussed above, information maps 358 map values of a variable, corresponding to a characteristic, to different locations in the field, as indicated at block 505. As indicated at block 504, receiving the information maps 358 may involve map selector 309, operator 360, or a user 364 selecting one or more of a plurality of possible information maps 358 that are available. For instance, one information map 358 may be a topographic map, such as topographic map 431. Another information map 358 may be a soil type map, such as soil type map 432. Another information map 358 may be a soil moisture map, such as soil moisture map 433. Another information map 358 may be an optical characteristic map, such as optical characteristic map 435. Another information map 358 may be a tiling map, such as tiling map 436. Another information map 358 may be an irrigation map, such as irrigation map 437. Another information map 358 may be a prior operation characteristic map, such as prior operation characteristic map 438. Other types of information maps that map other characteristics (or values thereof) are also contemplated, such as other maps 439. The process by which one or more information maps 358 are selected can be manual, semi-automated, or automated. The information maps 358 can be based on data collected prior to a current operation. For instance, the data may be collected based on aerial images taken during a previous year, or earlier in the current season, or at other times. The data may be based on data detected in ways other than using aerial images. For instance, the data may be collected during a previous operation on the worksite, such an operation during a previous year, or a previous operation earlier in the current season, or at other times. The machines performing those previous operations may be outfitted with one or more sensors that generate sensor data indicative of one or more characteristics. For example, values at the worksite in a prior operation during the same season may be used as data to generate the information maps 358. In other examples, and as described above, the information maps 358 may be predictive maps having predictive values. The predictive information map 358 can be generated by predictive map generator 312 based on a model generated by predictive model generator 310. The data for the information maps 358 can be obtained by agricultural spraying system 300 using communication system 306 and stored in data store 302. The data for the information maps 358 can be obtained by agricultural spraying system 300 using communication system 306 in other ways as well, and this is indicated by block 507 in the flow diagram of FIG. 5.

At block 508, as mobile machine 100 is operating, in-situ sensors 308 generate sensor data indicative of one or more in-situ data values indicative of a characteristic, such as soil moisture sensors 380 generating sensor data indicative of one or more in-situ data values indicative of soil moisture, as indicated by block 510. In some examples, data from in-situ sensors 308 is georeferenced using position, heading, or speed data from geographic position sensor 304 and in some cases also using dimensions of mobile machine 100, such as when deriving the geographic location of characteristic values detected by in-situ sensors 308 spaced apart from the geographic position sensor 304. In-situ sensors 308 can generate a variety of other sensor data indicative of a variety of other in-situ data values indicative of a variety of other characteristics, as indicated by block 511.

In one example, at block 512, predictive model generator 310 controls one or more of the topographic characteristic-to-soil moisture model generator 441, the soil type-to-soil moisture model generator 442, the soil moisture-to-soil moisture model generator 443, the optical characteristic-to-soil moisture model generator 444, the tiling characteristic-to-soil moisture model generator 445, the irrigation characteristic-to-soil moisture model generator 446, the prior operation characteristic-to-soil moisture model generator 447, and the other mapped characteristic-to-soil moisture model generator 448, to generate a model that models the relationship between the mapped values, such as the topographic characteristic values, the soil type values, the soil moisture values, the optical characteristic values, the tiling characteristic values, the irrigation characteristic values, the prior operation characteristic values, and other mapped characteristic values contained in the respective information map and the in-situ values sensed by the in-situ sensors 308. Predictive model generator 310 generates a predictive soil moisture model 450 as indicated by block 514.

At block 516, the relationship(s) or model(s) generated by predictive model generator 310 are provided to predictive map generator 312. In one example, at block 516, predictive map generator 312 controls predictive soil moisture map generator 452 to generate a functional predictive soil moisture map 460 that predicts soil moisture (or sensor value(s) indictive of soil moisture) at different geographic locations in a worksite at which mobile machine 100 is operating using the predictive soil moisture model 450 and one or more of the information maps, such as topographic map 431, soil type map 432, soil moisture map 433, optical characteristic map 435, tiling map 436, irrigation map 437, prior operation characteristic map 438, and other map 439 as indicated by block 518.

It should be noted that, in some examples, the functional predictive soil moisture map 460 may include two or more different map layers. Each map layer may represent a different data type, for instance, a functional predictive soil moisture map 460 that provides two or more of a map layer that provides predictive soil moisture based on topographic characteristic values from topographic map 431, a map layer that provides predictive soil moisture based on soil type values from soil type map 432, a map layer that provides predictive soil moisture based on soil moisture values from soil moisture map 433, a map layer that provides predictive soil moisture based on optical characteristic values from optical characteristic map 435, a map layer that provides predictive soil moisture based on tiling characteristic values from tiling map 436, a map layer that provides predictive soil moisture based on irrigation characteristic values from irrigation map 437, a map layer that provides predictive soil moisture based on prior operation characteristic values from prior operation characteristic map 438, and a map layer that provides predictive soil moisture based on other mapped characteristics values from other maps 439. In other examples, functional predictive soil moisture map 460 may include a layer that provides predictive soil moisture based on one or more of topographic characteristic values from topographic map 431, soil type values from soil type map 432, soil moisture values from soil moisture map 433, optical characteristic values from optical characteristic map 435, tiling characteristic values from tiling map 436, irrigation characteristic values from irrigation map 437, prior operation characteristic values from prior operation characteristic map 438, and other mapped characteristic values from other maps 439. Various other combinations are also contemplated.

At block 519, predictive map generator 312 configures the functional predictive soil moisture map 460 so that the functional predictive soil moisture map 460 is actionable (or consumable) by control system 314. Predictive map generator 312 can provide the functional predictive soil moisture map 460 to the control system 314 or to control zone generator 313, or both. Some examples of the different ways in which the functional predictive soil moisture map 460 can be configured or output are described with respect to blocks 519, 520, 522, and 523. For instance, predictive map generator 312 configures functional predictive soil moisture map 460 or so that functional predictive soil moisture map 460 includes values that can be read by control system 314 and used as the basis for generating control signals for one or more of the different controllable subsystems 316 of mobile machine 100, as indicated by block 519.

At block 520, control zone generator 313 can divide the functional predictive soil moisture map 460 into control zones based on the values on the functional predictive soil moisture map 460 to generate functional predictive soil moisture control zone map 461. Contiguously-geolocated values that are within a threshold value of one another can be grouped into a control zone. The threshold value can be a default threshold value, or the threshold value can be set based on an operator or user input, based on an input from an automated system, or based on other criteria. A size of the zones may be based on a responsiveness of the control system 314, the controllable subsystems 316, based on wear considerations, or on other criteria.

At block 522, predictive map generator 312 configures functional predictive soil moisture map 460 or functional predictive soil moisture control zone map 461, or both, for presentation to an operator or other user.

When presented to an operator or other user, the presentation of the functional predictive soil moisture map 460 or of the functional predictive soil moisture control zone map 461, or both, may contain one or more of the predictive values on the functional predictive soil moisture map 460 correlated to geographic location, the control zones of functional predictive soil moisture control zone map 461 correlated to geographic location, and settings values or control parameters that are used based on the predicted values on predictive map 460 or control zones on predictive control zone map 461. The presentation can, in another example, include more abstracted information or more detailed information. The presentation can also include a confidence level that indicates an accuracy with which the predictive values on predictive map 460 or the control zones on predictive control zone map 461 conform to measured values that may be measured by sensors on mobile machine 100 as mobile machine 100 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of mobile machine 100 may be unable to see the information corresponding to the predictive map 460 or predictive control zone map 461, or both, or make any changes to machine operation. A supervisor, such as a supervisor at a remote location, however, may be able to see the predictive map 460 or predictive control zone map 461, or both, on the display but be prevented from making any changes. A manager, who may be at a separate remote location, may be able to see all of the elements on predictive map 460 or predictive control zone map 461, or both, and also be able to change the predictive map 460 or predictive control zone map 461, or both. In some instances, the predictive map 460 or predictive control zone map 461, or both, accessible and changeable by a manager located remotely, may be used in machine control. This is one example of an authorization hierarchy that may be implemented.

The predictive map 460 or predictive control zone map 461, or both, can be configured in other ways as well, as indicated by block 523.

At block 524, input from geographic position sensor 304 and other in-situ sensors 308 are received by the control system 314. Particularly, at block 526, control system 314 detects an input from the geographic position sensor 304 identifying a geographic location of mobile machine 100. Block 527 represents receipt by the control system 314 of sensor inputs indicative of trajectory or heading of mobile machine 100, and block 528 represents receipt by the control system 314 of a speed of mobile machine 100. Block 532 represents receipt by the control system 314 of other information from various in-situ sensors 308 such as one or more of terrain information from terrain sensors 322, fill level information from fill level sensors 323, machine orientation information from machine orientation sensors 326, tire pressure information from tire pressure sensors 327, height characteristic information from height characteristic sensors 382, and other sensor information from other sensors 328, or other sources (e.g., maps of the worksite, such as a topographic map).

In one example, at block 533, control system 314 generates control signals to control the controllable subsystems 316 based on the functional predictive soil moisture map 460 or the functional predictive soil moisture control zone map 461, or both, and one or more of the input from the geographic position sensor 304 (or the derived geographic location of one or more particular components of the mobile machine 100), the heading of the mobile machine 100 as provided by heading/speed sensors 325, the speed of the mobile machine as provided by heading/speed sensors 325, the fill level of the one or more tanks or reservoirs of the mobile machine 100 as provided by fill level sensors 323, the terrain or topography of the worksite as provided by terrain sensors 322 (or other sources, such as a topographic map of the worksite), the orientation characteristics of mobile machine 100 as provided by machine orientation sensors 326, as well as a variety of other information, such as height of mobile machine 100 as provided by machine height sensors 327, height of a boom, boom arms, or boom sections, as provided by boom height sensors 324, and pressure of one or more tires as provided by tire pressure sensors 327. At block 534, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive soil moisture map 460 or functional predictive soil moisture control zone map 461 or both that is being used. Similarly, the control signals that are generated and the controllable subsystems 316 that are controlled, and the timing of the control signals can be based on various latencies of mobile machine 100 and the responsiveness of the controllable subsystems 316.

By way of example, at blocks 533 and 534, interface controller 330 can generate and apply control signals to control one or more interface mechanisms (e.g., 318 or 364, or both) to generate an alert or other indication, such as an alert that indicates that there is a risk that the mobile machine 100 will sink into the ground or that the mobile machine 100 will deviate from a height setpoint (e.g., boom height setpoint or machine height setpoint, or both). In one example, the alert or indication may be accompanied by a recommendation, such as recommendation for the operator to steer around the area or to display a new route that avoids driving in that area. Additionally, or alternatively, interface controller can generate control signals to control one or more interface mechanisms to display the functional predictive soil moisture map 460 or functional predictive soil moisture control zone map 461, or both, to an operator or user, or both.

By way of another example, at blocks 533 and 534, propulsion controller 331 can generate and apply control signals to control propulsion subsystem 350 to vary a speed setting, such as a travel speed, acceleration, or deceleration, of mobile machine 100.

By way of another example, at blocks 533 and 534, path planning controller 332 can generate and apply control signals to control steering subsystem 352 to adjust a heading of mobile machine 100. For instance, it may be that the predictive soil moisture values indicate (e.g., by exceeding a threshold) that the machine may sink into the ground (and thus affect the height of the boom above the worksite, as well as potentially create ruts) at an area ahead of the mobile machine 100 along its current heading, in which case, path planning controller 332 can control steering subsystem 352 to steer the ground engaging elements around that area. Additionally, or alternatively, path planning controller 331 can control a path planning system to generate a new route for mobile machine 100 and control propulsion subsystem 350 and steering subsystem 352 to propel and steer mobile machine 100 along the new route. For instance, it may be that the predictive soil moisture values indicate that the machine may sink into the ground (an thus affect the height of the boom above the worksite, as well as potentially create ruts) at an area ahead of the mobile machine 100 along its current route, in which case, path planning controller 332 can control a path planning system to generate a new route and control propulsion subsystem 350 and steering subsystem 352 to propel and steer mobile machine 100 along the new route to avoid driving the ground engaging elements in that area.

By way of another example, at blocks 533 and 534, machine height controller 333 can generate and apply control signals to control machine height subsystem 347 to vary a machine height setting (height of the mobile machine 100 or frame of mobile machine 100 above the worksite) of mobile machine 100. For instance, it may be that the predictive soil moisture values indicate (e.g., by exceeding a threshold) that the machine may sink into the ground (and thus affect the height of the boom above the worksite, as well as potentially create ruts) at an area ahead of the mobile machine 100. In such an example, the machine height (and thus the boom height) can be increased to compensate for the ground engaging elements sinking into the ground at areas of the field.

By way of another example, at blocks 533 and 534, boom height controller 334 can generate and apply control signals to control boom height subsystem 349 to vary a height setting of the boom, one or more boom arms, or one or more booms sections of mobile machine 100 to control the height of the boom, one or more boom arms, or one or more boom sections of mobile machine 100 above the worksite. For instance, it may be that the predictive soil moisture values indicate (e.g., by exceeding a threshold) that the machine may sink into the ground (and thus affect the height of the boom above the worksite, as well as potentially create ruts) at an area ahead of the mobile machine 100. In such an example, the boom height can be increased to compensate for the ground engaging elements sinking into the ground at areas of the field.

By way of another example, at blocks 533 and 534, tire pressure controller 335 can generate and apply control signals to control tire pressure subsystem 342 to vary an internal pressure of one or more tires of mobile machine 100. For example, where the predictive soil moisture values indicate (e.g., by exceeding a threshold) that the machine may sink into the ground or where the soil moisture values are relatively high, the pressure of the tires can be decreased to increase the surface area of the tires that contact the ground (e.g., increase the size of the contact patch) and thus eliminate or reduce the level to which the tires will sink into the ground. In another example, where the predictive soil moisture values indicate that sinking is not likely or where the soil moisture values are relatively low, the pressure of the tires can be increased which may improve fuel efficiency (due to less rolling resistance), improve tire longevity (e.g., reduce wear), as well as other benefits.

It should be noted that a combination of the controls described above may be implemented. For instance, based on the functional predictive soil moisture map 460 or the functional predictive soil moisture control zone map 461, as well as, in some examples, the other information obtained at block 524, a combination of control actions can be implemented. For example, two or more of controlling the speed of mobile machine 100, controlling the route/heading of the mobile machine 100, controlling the machine height of mobile machine 100, controlling the height of the boom, boom arms, or boom sections, controlling the pressure of one or more tires of mobile machine 100, and controlling one or more interface mechanisms such as to provide alert(s) and/or recommendations or to display the maps, or both.

These are merely some examples. Control system 314 can generate a variety of different control signals to control a variety of different controllable subsystems 316 based on functional predictive soil moisture map 460 or functional predictive soil moisture control zone map 461, or both. Additionally, it will be understood that the timing of the control signals can be based on the travel speed of the mobile machine 100, the location of the mobile machine 100, the heading of the mobile machine 100, as well as various other information obtained at block 524, as well as latencies of the system.

At block 536, a determination is made as to whether the operation has been completed. If the operation is not completed, the processing advances to block 538 where in-situ sensor data from geographic position sensor 304, heading/speed sensors 325, and other in-situ sensors 308 (and perhaps other sensors) continue to be read.

In some examples, at block 540, agricultural system 300 can also detect learning trigger criteria to perform machine learning on one or more of the functional predictive soil moisture map 460, the functional predictive soil moisture control zone map 461, the predictive soil moisture model 450, the zones generated by control zone generator 313, one or more control algorithms implemented by the controllers in the control system 314, and other triggered learning.

The learning trigger criteria can include any of a wide variety of different criteria. Some examples of detecting trigger criteria are discussed with respect to blocks 542, 544, 546, 548, and 549. For instance, in some examples, triggered learning can involve recreation of a relationship used to generate a predictive model when a threshold amount of in-situ sensor data are obtained from in-situ sensors 308. In such examples, receipt of an amount of in-situ sensor data from the in-situ sensors 308 that exceeds a threshold trigger or causes the predictive model generator 310 to generate a new predictive model that is used by predictive map generator 312. Thus, as mobile machine 100 continues an operation, receipt of the threshold amount of in-situ sensor data from the in-situ sensors 308 triggers the creation of a new relationship represented by a new predictive soil moisture model 450 generated by predictive model generator 310. Further, a new functional predictive soil moisture map 460, a new functional predictive soil moisture control zone map 461, or both, can be generated using the new predictive soil moisture model 450. Block 542 represents detecting a threshold amount of in-situ sensor data used to trigger creation of a new predictive model.

In other examples, the learning trigger criteria may be based on how much the in-situ sensor data from the in-situ sensors 308 are changing, such as over time or compared to previous values. For example, if variations within the in-situ sensor data (or the relationship between the in-situ sensor data and the information in the one or more information maps 358) are within a selected range or is less than a defined amount, or below a threshold value, then a new predictive model is not generated by the predictive model generator 310. As a result, the predictive map generator 312 does not generate a new functional predictive soil moisture map 460, a new functional predictive soil moisture control zone map 461, or both. However, if variations within the in-situ sensor data are outside of the selected range, are greater than the defined amount, or are above the threshold value, for example, then the predictive model generator 310 generates a new predictive soil moisture model 450 using all or a portion of the newly received in-situ sensor data that the predictive map generator 312 uses to generate a new functional predictive soil moisture map 460 which can be provided to control zone generator 313 for the creation of a new functional predictive soil moisture control zone map 461. At block 544, variations in the in-situ sensor data, such as a magnitude of an amount by which the data exceeds the selected range or a magnitude of the variation of the relationship between the in-situ sensor data and the information in the one or more information maps, can be used as a trigger to cause generation of one or more of a new predictive model, a new predictive map, and a new predictive control zone map. Keeping with the examples described above, the threshold, the range, and the defined amount can be set to default values; set by an operator or user interaction through an interface mechanism; set by an automated system; or set in other ways.

Other learning trigger criteria can also be used. For instance, if predictive model generator 310 switches to a different information map (different from the originally selected information map), then switching to the different information map may trigger re-learning by predictive model generator 310, predictive map generator 312, control zone generator 313, control system 314, or other items. In another example, transitioning of mobile machine 100 to a different area of the field or to a different control zone may be used as learning trigger criteria as well.

In some instances, operator 360 or a user 366 can also edit the functional predictive soil moisture map 460 or functional predictive soil moisture control zone map 461, or both. The edits can change a value on the functional predictive soil moisture map 460, change a size, shape, position, or existence of a control zone on functional predictive soil moisture control zone map 461, or both. Block 546 shows that edited information can be used as learning trigger criteria.

In some instances, it may also be that operator 360 or user 366 observes that automated control of a controllable subsystem 316, is not what the operator or user desires. In such instances, the operator 360 or user 366 may provide a manual adjustment to the controllable subsystem 316 reflecting that the operator 360 or user 366 desires the controllable subsystem 316 to operate in a different way than is being commanded by control system 314. Thus, manual alteration of a setting by the operator 360 or user 366 can cause one or more of predictive model generator 310 to relearn predictive soil moisture model 450, predictive map generator 312 to generate a new functional predictive soil moisture map 460, control zone generator 313 to generate one or more new control zones on functional predictive soil moisture control zone map 461, and control system 314 to relearn a control algorithm or to perform machine learning on one or more of the controller components 329 through 337 in control system 314 based upon the adjustment by the operator 360 or user 366, as shown in block 548. Block 549 represents the use of other triggered learning criteria.

In other examples, relearning may be performed periodically or intermittently based, for example, upon a selected time interval such as a discrete time interval or a variable time interval, as indicated by block 550.

If relearning is triggered, whether based upon learning trigger criteria or based upon passage of a time interval, as indicated by block 550, then one or more of the predictive model generator 310, predictive map generator 312, control zone generator 313, and control system 314 performs machine learning to generate new predictive model(s), new predictive map(s), new control zone(s), and new control algorithm(s), respectively, based upon the learning trigger criteria or based upon the passage of a time interval. The new predictive model(s), the new predictive map(s), the new control zone(s), and the new control algorithm(s) are generated using any additional data that has been collected since the last learning operation was performed. Performing relearning is indicated by block 552.

If the operation has not been completed, operation moves from block 552 to block 519 such that the new predictive model(s), the new predictive map(s), the new control zone(s), and/or the new predictive control algorithm(s) can be used to control mobile machine 100. If the operation has been completed, operation moves from block 552 to block 554 where one or more of the functional predictive soil moisture map 460, the functional predictive soil moisture control zone map 461, the predictive soil moisture model 450, control zone(s), and control algorithm(s), are stored. The functional predictive map(s), functional predictive control zone map(s), predictive model(s), the control zone(s), and the control algorithm(s) may be stored locally on data store 302 or sent to a remote system using communication system 306 for later use.

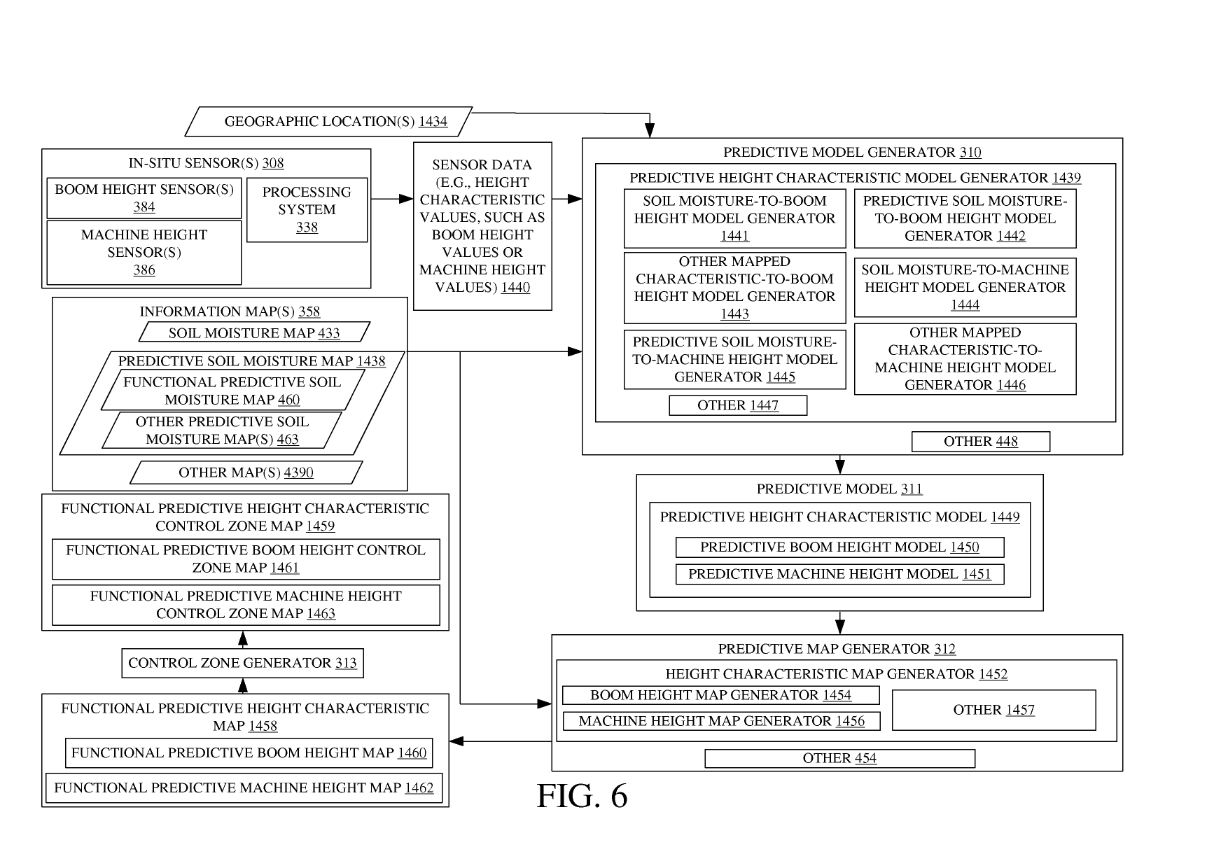

FIG. 6 is a block diagram of a portion of the agricultural spraying system architecture 300 shown in FIG. 3. Particularly, FIG. 6 shows, among other things, examples of the predictive model generator 310 and the predictive map generator 312 in more detail. FIG. 6 also illustrates information flow among the various components shown. The predictive model generator 310 receives one or more of a soil moisture map 433, a predictive soil moisture map 1438, and another type of map 4390. Other maps 4390 may include one or more of the other information maps 358 discussed herein but not shown explicitly in FIG. 6 (e.g., maps 431, 432, 435, 436, 437, 438, and 439) as well as various other information maps that map various other characteristics. Predictive soil moisture maps 1438 includes functional predictive soil moisture map 460 and other types of predictive soil moisture maps 463. Predictive model generator 310 also receives one or more geographic locations 1434, or an indication of one or more geographic locations, from a geographic position sensor 304, indicative of one or more geographic locations at the worksite corresponding to values detected by in-situ sensors 308. In-situ sensors 308 illustratively include, as height characteristic sensors 382, boom height sensors 384 and machine height sensors 386, as well as a processing system 338. In some instances, the boom height sensors 384 and machine height sensors 386 may be located on-board mobile machine 100. The processing system 338 processes sensor data generated from boom height sensors 384 to generate processed sensor data 1440 indicative of heigh characteristics values, such as boom height values or machine height values, or both. While the example shown in FIG. 6 illustrates processing system 338 as a component of in-situ sensors 308, in other examples, such as the example shown in FIG. 3, processing system 338 can be separate from in-situ sensors 308 but in operative communication with in-situ sensors 308.

It will be understood it will be understood that geographic locations 1434 illustratively represent geographic locations on the worksite to which the values detected by in-situ sensors 308 correspond. In some examples, the geographic location provided by geographic position sensors 304 will not be the geographic location of a value detected by boom height sensors or machine height sensors 386. For example, the sensors 384 and 386 may be spaced apart from the geographic position sensors 304. Thus, the geographic location, provided by geographic position sensors 304, can be used, in combination with other data (e.g., machine dimensionality, machine dynamics/orientation, sensor positions, etc.), to derive the geographic location to which the value detected by the sensors 384 or 386 corresponds.

As shown in FIG. 6, the example predictive model generator 310 includes a predictive height characteristic model generator 1439. Predictive height characteristic model generator 1439 includes one or more of a soil moisture-to-boom height model generator 1441, a predictive soil moisture-to-boom height model generator 1442, an other mapped characteristic-to-boom height model generator 1443, a soil moisture-to-machine height model generator 1444, a predictive soil moisture-to-machine height model generator 1445, and an other mapped characteristic-to-machine height model generator 1446. In other examples, the predictive height characteristic generator 1439 may include additional or different components than those shown in the example of FIG. 6. Consequently, in some examples, predictive height characteristic model generator 1439 may include other items 1447, which may include other types of predictive height characteristic model generators to generate other types of predictive height characteristic models. In other examples, the predictive model generator 310 may include additional or different components than those shown in the example of FIG. 6. Consequently, in some examples, the predictive model generator 310 may include other items 448 as well, which may include other types of predictive model generators to generate other types of models.

Soil moisture-to-boom height model generator 1441 identifies a relationship between boom height values detected in in-situ sensor data 1440 and soil moisture values, from the soil moisture map 433, corresponding to the geographic location of the detected boom height values. Based on this relationship established by soil moisture-to-boom height model generator 1441, soil moisture-to-boom height model generator 1441 generates a predictive boom height model, as a predictive height characteristic model. The predictive boom height model is used by boom height map generator 1454 to predict values of boom height (or the sensor values indicative of boom height values) at different locations in the worksite based upon the georeferenced soil moisture values contained in the soil moisture map 433 at those different locations in the worksite. Thus, for a given location in the worksite, boom height can be predicted at the given location based on the predictive boom height model generated by soil moisture-to-boom height model generator 1441 and the soil moisture value, from the soil moisture map 433, at that given location.

Predictive soil moisture-to-boom height model generator 1442 identifies a relationship between boom height values detected in in-situ sensor data 1440 and predictive soil moisture values, from the predictive soil moisture map 1438, corresponding to the geographic location of the detected boom height values. The predictive soil moisture map 1438 can be functional predictive soil moisture map 460 or another type of predictive soil moisture map 463. Based on this relationship established by predictive soil moisture-to-boom height model generator 1442, predictive soil moisture-to-boom height model generator 1442 generates a predictive boom height model, as a predictive height characteristic model. The predictive boom height model is used by boom height map generator 1454 to predict values of boom height (or the sensor values indicative of boom height values) at different locations in the worksite based upon the georeferenced predictive soil moisture values contained in the predictive soil moisture map 1438 at those different locations in the worksite. Thus, for a given location in the worksite, boom height can be predicted at the given location based on the predictive boom height model generated by predictive soil moisture-to-boom height model generator 1442 and the predictive soil moisture value, from the predictive soil moisture map 1438, at that given location.

Other mapped characteristic-to-boom height model generator 1443 identifies a relationship between boom height values detected in in-situ sensor data 1440 and other mapped characteristic values from an other map 439, corresponding to the geographic location of the detected boom height values. Based on this relationship established by other mapped characteristic-to-boom height model generator 1443, other mapped characteristic-to-boom height model generator 1443 generates a predictive boom height model, as a predictive height characteristic model. The predictive boom height model is used by boom height map generator 1454 to predict values of boom height (or the sensor values indicative of boom height values) at different locations in the worksite based upon the georeferenced other characteristic values contained in the other map 439 at those different locations in the worksite. Thus, for a given location in the worksite, boom height can be predicted at the given location based on the predictive boom height model generated by other mapped characteristic-to-boom height model generator 1443 and the other characteristic value, from the other map 439, at that given location.

Soil moisture-to-machine height model generator 1444 identifies a relationship between machine height values detected in in-situ sensor data 1440 and soil moisture values, from the soil moisture map 433, corresponding to the geographic location of the detected machine height values. Based on this relationship established by soil moisture-to-machine height model generator 1444, soil moisture-to-machine height model generator 1444 generates a predictive machine height model, as a predictive height characteristic model. The predictive machine height model is used by machine height map generator 1456 to predict values of machine height (or the sensor values indicative of machine height values) at different locations in the worksite based upon the georeferenced soil moisture values contained in the soil moisture map 433 at those different locations in the worksite. Thus, for a given location in the worksite, machine height can be predicted at the given location based on the predictive machine height model generated by soil moisture-to-machine height model generator 1444 and the soil moisture value, from the soil moisture map 433, at that given location.

Predictive soil moisture-to-machine height model generator 1445 identifies a relationship between machine height values detected in in-situ sensor data 1440 and predictive soil moisture values, from the predictive soil moisture map 1438, corresponding to the geographic location of the detected machine height values. The predictive soil moisture map 1438 can be functional predictive soil moisture map 460 or another type of predictive soil moisture map 463. Based on this relationship established by predictive soil moisture-to-machine height model generator 1445, predictive soil moisture-to-machine height model generator 1445 generates a predictive machine height model, as a predictive height characteristic model. The predictive machine height model is used by machine height map generator 1456 to predict values of machine height (or the sensor values indicative of machine height values) at different locations in the worksite based upon the georeferenced predictive soil moisture values contained in the predictive soil moisture map 1438 at those different locations in the worksite. Thus, for a given location in the worksite, machine height can be predicted at the given location based on the predictive machine height model generated by predictive soil moisture-to-machine height model generator 1445 and the predictive soil moisture value, from the predictive soil moisture map 1438, at that given location.

Other mapped characteristic-to-machine height model generator 1446 identifies a relationship between machine height values detected in in-situ sensor data 1440 and other mapped characteristic values from an other map 439, corresponding to the geographic location of the detected machine height values. Based on this relationship established by other mapped characteristic-to-machine height model generator 1446, other mapped characteristic-to-machine height model generator 1446 generates a predictive machine height model, as a predictive height characteristic model. The predictive machine height model is used by machine height map generator 1456 to predict values of machine height (or the sensor values indicative of machine height values) at different locations in the worksite based upon the georeferenced other characteristic values contained in the other map 439 at those different locations in the worksite. Thus, for a given location in the worksite, machine height can be predicted at the given location based on the predictive machine height model generated by other mapped characteristic-to-machine height model generator 1446 and the other characteristic value, from the other map 439, at that given location.

In light of the above, the predictive model generator 310 is operable to produce a plurality of predictive boom height models, such as one or more of the predictive boom height models generated by model generators 1441, 1442, 1443, and 1447. In another example, two or more of the predictive models described above may be combined into a single predictive boom height model, such as a predictive boom height model that predicts boom height based upon two or more of the soil moisture values, the predictive soil moisture values, and other mapped characteristic values at different locations in the field. Any of these boom height models, or combinations thereof, are represented collectively by predictive boom height model 1450 in FIG. 6. Predictive boom height model 1450 is an example of a predictive height characteristic model 1449 and predictive model 311.

Further, in light of the above, the predictive model generator 310 is operable to produce a plurality of predictive machine height models, such as one or more of the predictive machine height models generated by model generators 1444, 1445, 1446, and 1447. In another example, two or more of the predictive models described above may be combined into a single predictive machine height model, such as a predictive machine height model that predicts machine height based upon two or more of the soil moisture values, the predictive soil moisture values, and other mapped characteristic values at different locations in the field. Any of these machine height models, or combinations thereof, are represented collectively by predictive machine height model 1451 in FIG. 6. Predictive machine height model 1451 is an example of a predictive height characteristic model 1449 and predictive model 311.

The predictive boom height model 1450 or the predictive machine height model 1451, or both, can be provided to predictive map generator 312. In the example of FIG. 6, predictive map generator 312 includes a height characteristic map generator 1452. In other examples, predictive map generator 312 may include additional or different map generators. Thus, in some examples, predictive map generator 312 may include other items 454 which may include other types of map generators to generate other types of maps. Height characteristic map generator includes a boom height map generator 1454 and a machine height map generator 1456. In other examples, height characteristic map generator 1452 may include additional or different map generators. Thus, in some examples, height characteristic map generator 1452 may include other items 1457 which may include other types of map generators to generate other types of height characteristic maps.

Boom height map generator 1454 receives one or more of the soil moisture map 433, the predictive soil moisture map 1438, and the other map 439 along with the predictive boom height model 1450 which predicts boom height based upon one or more of a soil moisture value, a predictive soil moisture value, and an other mapped characteristic value and generates a predictive map that maps predictive boom height values at different locations in the worksite.

Predictive map generator 312 outputs a functional predictive boom height map 1460 that is predictive of boom height. The functional predictive boom height map 1460 is an example of a functional predictive height characteristic map 1458 and is a predictive map 264. The functional predictive boom height map 1460 predicts boom height values at different locations in a worksite. The functional predictive boom height map 1460 may be provided to control zone generator 313, control system 314, or both. Control zone generator 313 generates control zones and incorporates those control zones into the functional predictive boom height map 1460 to produce a predictive control zone map 265, that is, a functional predictive boom height control zone map 1461. Functional predictive boom height control zone map 1461 is an example of a functional predictive height characteristic control zone map 1459. One or both of functional predictive boom height map 1460 and functional predictive boom height control zone map 1461 can be provided to control system 314, which generates control signals to control one or more of the controllable subsystems 316 based upon the functional predictive boom height map 1460, the functional predictive boom height control zone map 1461, or both. Alternatively, or additionally, one or more of the functional predictive boom height map 1460 and functional predictive boom height control zone map 1461 can be provided to operator 360 on an operator interface mechanism 318 or to a remote user 366 on a user interface mechanism 364, or both.

Machine height map generator 1456 receives one or more of the soil moisture map 433, the predictive soil moisture map 1438, and the other map 439 along with the predictive machine height model 1451 which predicts machine height based upon one or more of a soil moisture value, a predictive soil moisture value, and an other mapped characteristic value and generates a predictive map that maps predictive machine height values at different locations in the worksite.

Predictive map generator 312 outputs a functional predictive machine height map 1461 that is predictive of machine height. The functional predictive machine height map 1462 is an example of a functional predictive height characteristic map 1458 and is a predictive map 264. The functional predictive machine height map 1462 predicts machine height values at different locations in a worksite. The functional predictive machine height map 1462 may be provided to control zone generator 313, control system 314, or both. Control zone generator 313 generates control zones and incorporates those control zones into the functional predictive machine height map 1462 to produce a predictive control zone map 265, that is, a functional predictive machine height control zone map 1463. Functional predictive machine height control zone map 1463 is an example of a functional predictive height characteristic control zone map 1459. One or both of functional predictive machine height map 1462 and functional predictive machine height control zone map 1463 can be provided to control system 314, which generates control signals to control one or more of the controllable subsystems 316 based upon the functional predictive machine height map 1462, the functional predictive machine height control zone map 1463, or both. Alternatively, or additionally, one or more of the functional predictive machine height map 1462 and functional predictive machine height control zone map 1463 can be provided to operator 360 on an operator interface mechanism 318 or to a remote user 366 on a user interface mechanism 364, or both.

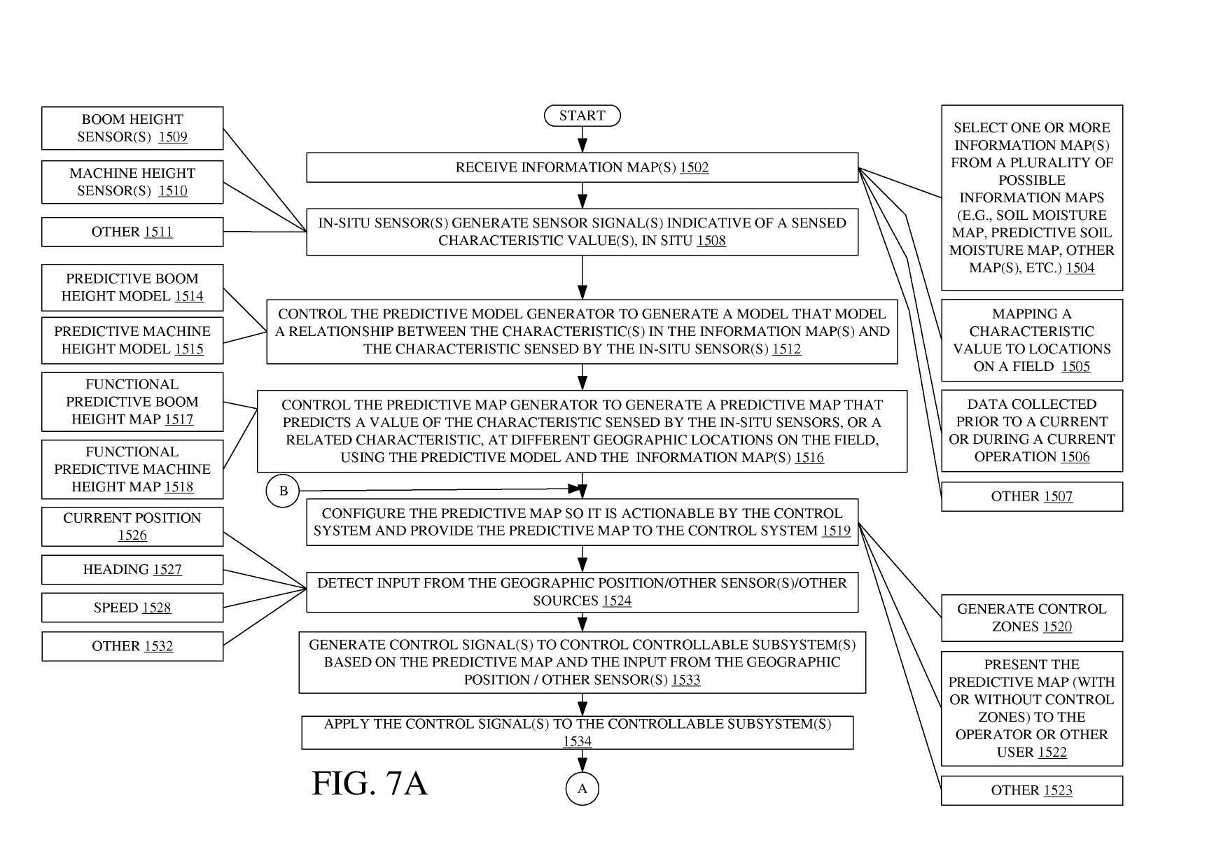

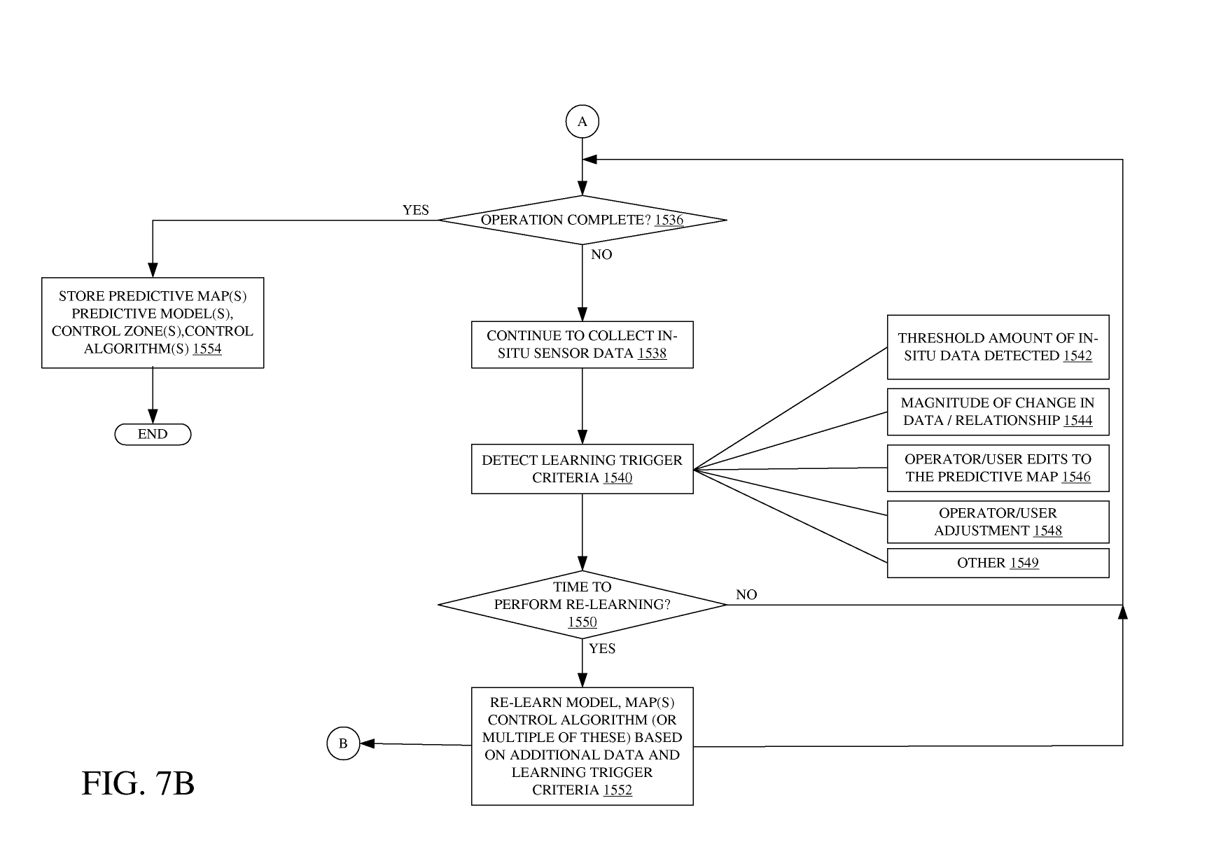

FIGS. 7A-7B (collectively referred to herein as FIG. 7) show a flow diagram illustrating one example of the operation of agricultural spraying system architecture 300 in generating a predictive model and a predictive map.

At block 1502, agricultural system 300 receives one or more information maps 358. Examples of information maps 358 or receiving information maps 358 are discussed with respect to blocks 1504, 1505, 1506, and 1507. As discussed above, information maps 358 map values of a variable, corresponding to a characteristic, to different locations in the field, as indicated at block 1505. As indicated at block 504, receiving the information maps 358 may involve map selector 309, operator 360, or a user 364 selecting one or more of a plurality of possible information maps 358 that are available. For instance, one information map 358 may be a soil moisture map, such as soil moisture map 433. Another information map 358 may be a predictive soil moisture map, such as predictive soil moisture seeding map 1438. Predictive soil moisture map 1438 may be in the form of functional predictive soil moisture map 460 or may be another type of predictive soil map 463. Other types of information maps that map other characteristics (or values thereof) are also contemplated, such as other maps 439. The process by which one or more information maps 358 are selected can be manual, semi-automated, or automated. The information maps 358 can be based on data collected prior to a current operation. For instance, the data may be collected based on aerial images taken during a previous year, or earlier in the current season, or at other times. The data may be based on data detected in ways other than using aerial images. For instance, the data may be collected during a previous operation on the worksite, such an operation during a previous year, or a previous operation earlier in the current season, or at other times. The machines performing those previous operations may be outfitted with one or more sensors that generate sensor data indicative of one or more characteristics. For example, the values (e.g., soil moisture values) at the worksite in a prior operation during the same season may be used as data to generate the information maps 358. In other examples, and as described above, the information maps 358 may be predictive maps having predictive values (e.g., predictive soil moisture map 1438). The predictive information map 358 can be generated by predictive map generator 312 based on a model generated by predictive model generator 310 (e.g., functional predictive soil moisture map 460). The data for the information maps 358 can be obtained by agricultural spraying system 300 using communication system 306 and stored in data store 302. The data for the information maps 358 can be obtained by agricultural spraying system 300 using communication system 306 in other ways as well, and this is indicated by block 507 in the flow diagram of FIG. 7.

At block 1508, as mobile machine 100 is operating, in-situ sensors 308 generate sensor data indicative of one or more in-situ data values indicative of a characteristic, such as height characteristic sensors 382 generating sensor data indicative of one or more in-situ data values indicative of a height characteristic. For example, boom height sensors 384 generate sensor data indicative of one or more in-situ data values indicative of boom height, as indicated by block 1509. In another example, machine height sensors 386 generate sensor data indicative of one or more in-situ data values indicative of machine height, as indicated by block 1510. In some examples, data from in-situ sensors 308 is georeferenced using position, heading, or speed data from geographic position sensor 304 and in some cases also using dimensions of mobile machine 100, such as when deriving the geographic location of characteristic values detected by in-situ sensors 308 spaced apart from the geographic position sensor 304. In-situ sensors 308 can generate a variety of other sensor data indicative of a variety of other in-situ data values indicative of a variety of other characteristics, as indicated by block 1511.

In one example, at block 1512, predictive model generator 310 controls one or more of the soil moisture-to-boom height model generator 1441, predictive soil moisture-to-boom height model generator 442, and other mapped characteristic-to-boom height model generator 1443, to generate a model that models the relationship between the mapped values, such as the soil moisture values, the predictive soil moisture values, and other mapped characteristic values contained in the respective information map and the in-situ values sensed by the in-situ sensors 308. Predictive model generator 310 generates a predictive boom height model 1450 as indicated by block 1514.

In another example, at block 1512, predictive model generator 310 controls one or more of the soil moisture-to-machine height model generator 1444, predictive soil moisture-to-machine height model generator 1445, and other mapped characteristic-to-machine height model generator 1446, to generate a model that models the relationship between the mapped values, such as the soil moisture values, the predictive soil moisture values, and other mapped characteristic values contained in the respective information map and the in-situ values sensed by the in-situ sensors 308. Predictive model generator 310 generates a predictive machine height model 1451 as indicated by block 1515.

At block 1516, the relationship(s) or model(s) generated by predictive model generator 310 are provided to predictive map generator 312. In one example, predictive map generator 312 controls predictive boom height map generator 1454 to generate a functional predictive boom height map 1460 that predicts boom height (or sensor value(s) indictive of boom height) at different geographic locations in a worksite at which mobile machine 100 is operating using the predictive boom height model 1450 and one or more of the information maps, such as soil moisture map 433, predictive soil moisture map 1438, and other maps 439 as indicated by block 517.

It should be noted that, in some examples, the functional predictive boom height map 1460 may include two or more different map layers. Each map layer may represent a different data type, for instance, a functional predictive boom height map 1460 that provides two or more of a map layer that provides predictive boom height based on soil moisture values from soil moisture map 433, a map layer that provides predictive boom height based on predictive soil moisture values from predictive soil moisture map 1438, and a map layer that provides predictive boom height based on other mapped characteristics values from other maps 439. In other examples, functional predictive boom height map 1460 may include a layer that provides predictive boom height based on two or more of soil moisture values from soil moisture map 433, predictive soil moisture values from predictive soil moisture map 1438, and other mapped characteristic values from other maps 439. Various other combinations are also contemplated.

In another example, at block 1516, predictive map generator 312 controls predictive machine height map generator 1456 to generate a functional predictive machine height map 1462 that predicts machine height (or sensor value(s) indictive of machine height) at different geographic locations in a worksite at which mobile machine 100 is operating using the predictive machine height model 1451 and one or more of the information maps, such as soil moisture map 433, predictive soil moisture map 1438, and other maps 439 as indicated by block 1518.

It should be noted that, in some examples, the functional predictive machine height map 1462 may include two or more different map layers. Each map layer may represent a different data type, for instance, a functional predictive machine height map 1462 that provides two or more of a map layer that provides predictive machine height based on soil moisture values from soil moisture map 433, a map layer that provides predictive machine height based on predictive soil moisture values from predictive soil moisture map 1438, and a map layer that provides predictive machine height based on other mapped characteristics values from other maps 439. In other examples, functional predictive machine height map 1462 may include a layer that provides predictive machine height based on two or more of soil moisture values from soil moisture map 433, predictive soil moisture values from predictive soil moisture map 1438, and other mapped characteristic values from other maps 439. Various other combinations are also contemplated.

Additionally, it should be noted that predictive map generator 312 can generate a functional predictive height characteristic map 1458 that provides both predictive boom height and predictive machine height. That is, the predictive boom height values and predictive machine height values can be combined into a single predictive height characteristic map or, the functional predictive boom height map 1460 and the functional predictive machine height map 1462 can be layers of the functional predictive height characteristic map 1458.

At block 1519, predictive map generator 312 configures the functional predictive boom height map 1460 or the functional predictive machine height map 1462, or both, so that the functional predictive boom height map 1460 or the functional predictive machine height map 1462, or both, are actionable (or consumable) by control system 314. Predictive map generator 312 can provide the functional predictive boom height map 1460 or the functional predictive machine height map 1462, or both, to the control system 314 or to control zone generator 313, or both. Some examples of the different ways in which the functional predictive boom height map 1460 or the functional predictive machine height map 1462, or both, can be configured or output are described with respect to blocks 1519, 1520, 1522, and 1523. For instance, predictive map generator 312 configures functional predictive boom height map 1460 or functional predictive machine height map 1462, or both, so that functional predictive boom height map 1460 or functional predictive machine height map 1462, or both, include values that can be read by control system 314 and used as the basis for generating control signals for one or more of the different controllable subsystems 316 of mobile machine 100, as indicated by block 1519.

At block 1520, control zone generator 313 can divide the functional predictive boom height map 1460 into control zones based on the values on the functional predictive boom height map 1460 to generate functional predictive boom height control zone map 1461. Alternatively, or additionally, at block 1520, control zone generator 313 can divide the functional predictive machine height map 1462 into control zones based on the values on the functional predictive machine height map 1462 to generate functional predictive machine height control zone map 1463. Contiguously-geolocated values that are within a threshold value of one another can be grouped into a control zone. The threshold value can be a default threshold value, or the threshold value can be set based on an operator or user input, based on an input from an automated system, or based on other criteria. A size of the zones may be based on a responsiveness of the control system 314, the controllable subsystems 316, based on wear considerations, or on other criteria.

At block 1522, predictive map generator 312 configures functional predictive boom height map 1460 or functional predictive machine height map 1462, or both, for presentation to an operator or other user. At block 1522, control zone generator 313 can configure functional predictive boom height control zone map 1461 or functional predictive machine height control zone map 1463, or both, for presentation to an operator or other user.

When presented to an operator or other user, the presentation of the functional predictive boom height map 1460 or of the functional predictive boom height control zone map 1461, or both, may contain one or more of the predictive values on the functional predictive boom height map 1460 correlated to geographic location, the control zones of functional predictive boom height control zone map 1461 correlated to geographic location, and settings values or control parameters that are used based on the predicted values on predictive map 1460 or control zones on predictive control zone map 1461. The presentation can, in another example, include more abstracted information or more detailed information. The presentation can also include a confidence level that indicates an accuracy with which the predictive values on predictive map 1460 or the control zones on predictive control zone map 1461 conform to measured values that may be measured by sensors on mobile machine 100 as mobile machine 100 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of mobile machine 100 may be unable to see the information corresponding to the predictive map 1460 or predictive control zone map 1461, or both, or make any changes to machine operation. A supervisor, such as a supervisor at a remote location, however, may be able to see the predictive map 1460 or predictive control zone map 1461, or both, on the display but be prevented from making any changes. A manager, who may be at a separate remote location, may be able to see all of the elements on predictive map 1460 or predictive control zone map 1461, or both, and also be able to change the predictive map 1460 or predictive control zone map 1461, or both. In some instances, the predictive map 1460 or predictive control zone map 1461, or both, are accessible and changeable by a manager located remotely, may be used in machine control. This is one example of an authorization hierarchy that may be implemented.

The predictive map 1460 or predictive control zone map 1461, or both, can be configured in other ways as well, as indicated by block 1523.

When presented to an operator or other user, the presentation of the functional predictive machine height map 1462 or of the functional predictive machine height control zone map 1463, or both, may contain one or more of the predictive values on the functional predictive machine height map 1462 correlated to geographic location, the control zones of functional predictive machine height control zone map 1463 correlated to geographic location, and settings values or control parameters that are used based on the predicted values on predictive map 1462 or control zones on predictive control zone map 1463. The presentation can, in another example, include more abstracted information or more detailed information. The presentation can also include a confidence level that indicates an accuracy with which the predictive values on predictive map 1462 or the control zones on predictive control zone map 1463 conform to measured values that may be measured by sensors on mobile machine 100 as mobile machine 100 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of mobile machine 100 may be unable to see the information corresponding to the predictive map 1462 or predictive control zone map 146, or both, or make any changes to machine operation. A supervisor, such as a supervisor at a remote location, however, may be able to see the predictive map 1462 or predictive control zone map 1463, or both, on the display but be prevented from making any changes. A manager, who may be at a separate remote location, may be able to see all of the elements on predictive map 1462 or predictive control zone map 1463, or both, and also be able to change the predictive map 1462 or predictive control zone map 1463, or both. In some instances, the predictive map 1462 or predictive control zone map 1463, or both, are accessible and changeable by a manager located remotely, may be used in machine control. This is one example of an authorization hierarchy that may be implemented.

The predictive map 1462 or predictive control zone map 1463, or both, can be configured in other ways as well, as indicated by block 1523.

At block 1524, input from geographic position sensor 304 and other in-situ sensors 308 are received by the control system 314. Particularly, at block 1526, control system 314 detects an input from the geographic position sensor 304 identifying a geographic location of mobile machine 100. Block 1527 represents receipt by the control system 314 of sensor inputs indicative of trajectory or heading of mobile machine 100, and block 1528 represents receipt by the control system 314 of a speed of mobile machine 100. Block 1532 represents receipt by the control system 314 of other information from various in-situ sensors 308 such as one or more of terrain information from terrain sensors 322, fill level information from fill level sensors 323, machine orientation information from machine orientation sensors 326, tire pressure information from tire pressure sensors 327, soil moisture information from soil moisture sensors 380, and other sensor information from other sensors 328, or other sources (e.g., maps of the worksite, such as a topographic map).

In one example, at block 1533, control system 314 generates control signals to control the controllable subsystems 316 based on the functional predictive boom height map 1460 or the functional predictive boom height control zone map 1461, or both, and one or more of the input from the geographic position sensor 304 (or the derived geographic location of one or more particular components of the mobile machine 100), the heading of the mobile machine 100 as provided by heading/speed sensors 325, the speed of the mobile machine as provided by heading/speed sensors 325, the fill level of the one or more tanks or reservoirs of the mobile machine 100 as provided by fill level sensors 323, the terrain or topography of the worksite as provided by terrain sensors 322 (or other sources, such as a topographic map of the worksite), the orientation characteristics of mobile machine 100 as provided by machine orientation sensors 326, as well as a variety of other information, such as soil moisture as provided by soil moisture sensors 380. At block 1534, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive boom height map 1460 or functional predictive boom height control zone map 1461 or both that is being used. Similarly, the control signals that are generated and the controllable subsystems 316 that are controlled, and the timing of the control signals can be based on various latencies of mobile machine 100 and the responsiveness of the controllable subsystems 316.

By way of example, at blocks 1533 and 1534, interface controller 330 can generate and apply control signals to control one or more interface mechanisms (e.g., 318 or 364, or both) to generate an alert or other indication, such as an alert that indicates that the mobile machine 100 will sink into the ground or that the mobile machine 100 will deviate from a boom height setpoint. In one example, the alert or indication may be accompanied by a recommendation, such as recommendation for the operator to steer around the area or to display a new route that avoids driving the ground engaging elements in that area. Additionally, or alternatively, interface controller 330 can generate control signals to control one or more interface mechanisms to display the functional predictive boom height map 1460 or functional predictive boom height control zone map 1461, or both, to an operator or user, or both.

By way of another example, at blocks 1533 and 1534, propulsion controller 331 can generate and apply control signals to control propulsion subsystem 350 to vary a speed setting, such as a travel speed, acceleration, or deceleration, of mobile machine 100.

By way of another example, at blocks 1532 and 1534, path planning controller 332 can generate and apply control signals to control steering subsystem 352 to adjust a heading of mobile machine 100. For instance, it may be that the predictive boom height values indicate that the boom height will deviate from a setpoint (e.g., due to the tires sinking into the ground) at an area ahead of the mobile machine 100 along its current heading, in which case, path planning controller 332 can control steering subsystem 352 to steer the ground engaging elements around that area. Additionally, or alternatively, path planning controller 331 can control a path planning system to generate a new route for mobile machine 100 and control propulsion subsystem 350 and steering subsystem 352 to propel and steer mobile machine 100 along the new route. For instance, it may be that the predictive boom height values indicate that the boom height will deviate from a setpoint (e.g., due to the tires sinking into the ground) at an area ahead of the mobile machine 100 along its current route, in which case, path planning controller 332 can control a path planning system to generate a new route and control propulsion subsystem 350 and steering subsystem 352 to propel and steer mobile machine 100 along the new route to avoid driving the ground engaging elements in that area.

By way of another example, at blocks 1533 and 1534, machine height controller 333 can generate and apply control signals to control machine height subsystem 347 to vary a machine height setting (height of the mobile machine 100 or frame of mobile machine 100 above the worksite) of mobile machine 100. For instance, it may be that the predictive boom height values indicate that the boom height will deviate from a setpoint (e.g., due to the tires sinking into the ground) at an area ahead of the mobile machine 100. In such an example, the machine height (and thus the boom height) can be increased to compensate for the ground engaging elements sinking into the ground at areas of the field.

By way of another example, at blocks 1533 and 1534, boom height controller 334 can generate and apply control signals to control boom height subsystem 349 to vary a height setting of the boom, one or more boom arms, or one or more booms sections of mobile machine 100 to control the height of the boom, one or more boom arms, or one or more boom sections of mobile machine 100 above the worksite. For instance, it may be that the predictive boom height values indicate that the boom height will deviate from a setpoint (e.g., due to the tires sinking into the ground) at an area ahead of the mobile machine 100. In such an example, the boom height can be increased to compensate for the ground engaging elements sinking into the ground at areas of the field.

By way of another example, at blocks 1533 and 1534, tire pressure controller 335 can generate and apply control signals to control tire pressure subsystem 342 to vary an internal pressure of one or more tires of mobile machine 100. For example, where the predictive boom height values indicate that the boom height will deviate from a setpoint (e.g., due to the tires sinking into the ground), the pressure of the tires can be decreased to increase the surface area of the tires that contact the ground (e.g., increase the size of the contact patch) and thus eliminate or reduce the level to which the tires will sink into the ground. In another example, where the predictive boom height values indicate that the boom height will not deviate from a setpoint (e.g., because sinking is not likely), the pressure of the tires can be increased which may improve fuel efficiency (due to less rolling resistance), improve tire longevity (e.g., reduce wear), as well as other benefits.

It should be noted that a combination of the controls described above may be implemented. For instance, based on the functional predictive boom height map 1460 or the functional predictive boom height control zone map 1461, as well as, in some examples, the other information obtained at block 1524, a combination of control actions can be implemented. For example, two or more of controlling the speed of mobile machine 100, controlling the route/heading of the mobile machine 100, controlling the machine height of mobile machine 100, controlling the height of the boom, boom arms, or boom sections, controlling the pressure of one or more tires of mobile machine 100, and controlling one or more interface mechanisms such as to provide alert(s) and/or recommendations or to display the maps, or both.

These are merely some examples. Control system 314 can generate a variety of different control signals to control a variety of different controllable subsystems 316 based on functional predictive boom height map 1460 or functional predictive boom height control zone map 1461, or both. Additionally, it will be understood that the timing of the control signals can be based on the travel speed of the mobile machine 100, the location of the mobile machine 100 or the location of a particular component of the mobile machine 100, as well as various other information obtained at block 524, as well as latencies of the system.

In another example, at block 1533, control system 314 generates control signals to control the controllable subsystems 316 based on the functional predictive machine height map 1462 or the functional predictive machine height control zone map 1463, or both, and one or more of the input from the geographic position sensor 304 (or the derived geographic location of one or more particular components of the mobile machine 100), the heading of the mobile machine 100 as provided by heading/speed sensors 325, the speed of the mobile machine as provided by heading/speed sensors 325, the fill level of the one or more tanks or reservoirs of the mobile machine 100 as provided by fill level sensors 323, the terrain or topography of the worksite as provided by terrain sensors 322 (or other sources, such as a topographic map of the worksite), the orientation characteristics of mobile machine 100 as provided by machine orientation sensors 326, as well as a variety of other information, such as soil moisture as provided by soil moisture sensors 380. At block 1534, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive machine height map 1462 or functional predictive machine height control zone map 1463 or both that is being used. Similarly, the control signals that are generated and the controllable subsystems 316 that are controlled, and the timing of the control signals can be based on various latencies of mobile machine 100 and the responsiveness of the controllable subsystems 316.

By way of example, at blocks 1533 and 1534, interface controller 330 can generate and apply control signals to control one or more interface mechanisms (e.g., 318 or 364, or both) to generate an alert or other indication, such as an alert that indicates that the mobile machine 100 will sink into the ground or that the mobile machine 100 will deviate from a machine height setpoint. In one example, the alert or indication may be accompanied by a recommendation, such as recommendation for the operator to steer around the area or to display a new route that avoids driving the ground engaging elements in that area. Additionally, or alternatively, interface controller 330 can generate control signals to control one or more interface mechanisms to display the functional predictive boom height map 1460 or functional predictive boom height control zone map 1461, or both, to an operator or user, or both.

By way of another example, at blocks 1533 and 1534, propulsion controller 331 can generate and apply control signals to control propulsion subsystem 350 to vary a speed setting, such as a travel speed, acceleration, or deceleration, of mobile machine 100.

By way of another example, at blocks 1533 and 1534, path planning controller 332 can generate and apply control signals to control steering subsystem 352 to adjust a heading of mobile machine 100. For instance, it may be that the predictive machine height values indicate that the machine height will deviate from a setpoint (e.g., due to the tires sinking into the ground) at an area ahead of the mobile machine 100 along its current heading, in which case, path planning controller 332 can control steering subsystem 352 to steer the ground engaging elements around that area. Additionally, or alternatively, path planning controller 331 can control a path planning system to generate a new route for mobile machine 100 and control propulsion subsystem 350 and steering subsystem 352 to propel and steer mobile machine 100 along the new route. For instance, it may be that the predictive machine height values indicate that the machine height will deviate from a setpoint (e.g., due to the tires sinking into the ground) at an area ahead of the mobile machine 100 along its current route, in which case, path planning controller 332 can control a path planning system to generate a new route and control propulsion subsystem 350 and steering subsystem 352 to propel and steer mobile machine 100 along the new route to avoid driving the ground engaging elements in that area.

By way of another example, at blocks 1533 and 1534, machine height controller 333 can generate and apply control signals to control machine height subsystem 347 to vary a machine height setting (height of the mobile machine 100 or frame of mobile machine 100 above the worksite) of mobile machine 100. For instance, it may be that the predictive machine height values indicate that the machine height will deviate from a setpoint (e.g., due to the tires sinking into the ground) at an area ahead of the mobile machine 100. In such an example, the machine height (and thus the boom height) can be increased to compensate for the ground engaging elements sinking into the ground at areas of the field.

By way of another example, at blocks 1533 and 1534, boom height controller 334 can generate and apply control signals to control boom height subsystem 349 to vary a height setting of the boom, one or more boom arms, or one or more booms sections of mobile machine 100 to control the height of the boom, one or more boom arms, or one or more boom sections of mobile machine 100 above the worksite. For instance, it may be that the predictive machine height values indicate that the machine height will deviate from a setpoint (e.g., due to the tires sinking into the ground) at an area ahead of the mobile machine 100. In such an example, the boom height can be increased to compensate for the ground engaging elements sinking into the ground at areas of the field.

By way of another example, at blocks 1533 and 1534, tire pressure controller 335 can generate and apply control signals to control tire pressure subsystem 342 to vary an internal pressure of one or more tires of mobile machine 100. For example, where the predictive machine height values indicate that the machine height will deviate from a setpoint (e.g., due to the tires sinking into the ground), the pressure of the tires can be decreased to increase the surface area of the tires that contact the ground (e.g., increase the size of the contact patch) and thus eliminate or reduce the level to which the tires will sink into the ground. In another example, where the predictive machine height values indicate that the machine height will not deviate from a setpoint (e.g., because sinking is not likely), the pressure of the tires can be increased which may improve fuel efficiency (due to less rolling resistance), improve tire longevity (e.g., reduce wear), as well as other benefits.

It should be noted that a combination of the controls described above may be implemented. For instance, based on the functional predictive machine height map 1462 or the functional predictive machine height control zone map 1463, as well as, in some examples, the other information obtained at block 1524, a combination of control actions can be implemented. For example, two or more of controlling the speed of mobile machine 100, controlling the route/heading of the mobile machine 100, controlling the machine height of mobile machine 100, controlling the height of the boom, boom arms, or boom sections, controlling the pressure of one or more tires of mobile machine 100, and controlling one or more interface mechanisms such as to provide alert(s) and/or recommendations or to display the maps, or both.

These are merely some examples. Control system 314 can generate a variety of different control signals to control a variety of different controllable subsystems 316 based on functional predictive machine height map 1462 or functional predictive machine height control zone map 1463, or both. Additionally, it will be understood that the timing of the control signals can be based on the travel speed of the mobile machine 100, the location of the mobile machine 100 or the location of a particular component of the mobile machine 100, as well as various other information obtained at block 524, as well as latencies of the system.

At block 1536, a determination is made as to whether the operation has been completed. If the operation is not completed, the processing advances to block 1538 where in-situ sensor data from geographic position sensor 304, heading/speed sensors 325, and other in-situ sensors 308 (and perhaps other sensors) continue to be read.

In some examples, at block 1540, agricultural system 300 can also detect learning trigger criteria to perform machine learning on one or more of the functional predictive boom height map 1460, the functional predictive boom height control zone map 1461, the predictive boom height model 1450, the functional predictive machine height map 1462, the functional predictive machine height control zone map 1462, the predictive machine height model 1451, the zones generated by control zone generator 313, one or more control algorithms implemented by the controllers in the control system 314, and other triggered learning.

The learning trigger criteria can include any of a wide variety of different criteria. Some examples of detecting trigger criteria are discussed with respect to blocks 1542, 1544, 1546, 1548, and 1549. For instance, in some examples, triggered learning can involve recreation of a relationship used to generate a predictive model when a threshold amount of in-situ sensor data are obtained from in-situ sensors 308. In such examples, receipt of an amount of in-situ sensor data from the in-situ sensors 308 that exceeds a threshold trigger or causes the predictive model generator 310 to generate a new predictive model that is used by predictive map generator 312. Thus, as mobile machine 100 continues an operation, receipt of the threshold amount of in-situ sensor data from the in-situ sensors 308 triggers the creation of a new relationship represented by a new predictive boom height model 1450 or a new predictive machine height model 1451, or both, generated by predictive model generator 310. Further, a new functional predictive boom height map 1460, a new functional predictive boom height control zone map 1461, or both, can be generated using the new predictive boom height model 1450. Further, a new functional predictive machine height map 1462, a new functional predictive machine height control zone map 1463, or both, can be generated using the new predictive machine height model 1451. Block 1542 represents detecting a threshold amount of in-situ sensor data used to trigger creation of a new predictive model.

In other examples, the learning trigger criteria may be based on how much the in-situ sensor data from the in-situ sensors 308 are changing, such as over time or compared to previous values. For example, if variations within the in-situ sensor data (or the relationship between the in-situ sensor data and the information in the one or more information maps 358) are within a selected range or is less than a defined amount, or below a threshold value, then a new predictive model is not generated by the predictive model generator 310. As a result, the predictive map generator 312 does not generate a new functional predictive height characteristic map 1458, a new functional predictive height characteristic control zone map 1459, or both. However, if variations within the in-situ sensor data are outside of the selected range, are greater than the defined amount, or are above the threshold value, for example, then the predictive model generator 310 generates a new predictive height characteristic model 449 (e.g., 1450 or 1451, or both) using all or a portion of the newly received in-situ sensor data that the predictive map generator 312 uses to generate a new predictive height characteristic map 1458 (e.g., 1460 or 1462, or both) which can be provided to control zone generator 313 for the creation of a new predictive height characteristic control zone map 459 (e.g., 1461 or 1463, or both). At block 1544, variations in the in-situ sensor data, such as a magnitude of an amount by which the data exceeds the selected range or a magnitude of the variation of the relationship between the in-situ sensor data and the information in the one or more information maps, can be used as a trigger to cause generation of one or more of a new predictive model, a new predictive map, and a new predictive control zone map. Keeping with the examples described above, the threshold, the range, and the defined amount can be set to default values; set by an operator or user interaction through an interface mechanism; set by an automated system; or set in other ways.

Other learning trigger criteria can also be used. For instance, if predictive model generator 310 switches to a different information map (different from the originally selected information map), then switching to the different information map may trigger re-learning by predictive model generator 310, predictive map generator 312, control zone generator 313, control system 314, or other items. In another example, transitioning of mobile machine 100 to a different area of the field or to a different control zone may be used as learning trigger criteria as well.

In some instances, operator 360 or a user 366 can also edit the functional predictive height characteristic map 1458 (e.g., 1460 or 1462, or both) or functional predictive height characteristic control zone map 1459 (e.g., 1461 or 1463, or both), or both. The edits can change a value on the functional predictive height characteristic map 1458 (e.g., 1460 or 1462, or both), change a size, shape, position, or existence of a control zone on functional predictive height characteristic control zone map 1459 (e.g., 1461 or 1463), or both. Block 1546 shows that edited information can be used as learning trigger criteria.

In some instances, it may also be that operator 360 or user 366 observes that automated control of a controllable subsystem 316, is not what the operator or user desires. In such instances, the operator 360 or user 366 may provide a manual adjustment to the controllable subsystem 316 reflecting that the operator 360 or user 366 desires the controllable subsystem 316 to operate in a different way than is being commanded by control system 314. Thus, manual alteration of a setting by the operator 360 or user 366 can cause one or more of predictive model generator 310 to relearn predictive height characteristic model 1449 (e.g., 1450 or 1451, or both), predictive map generator 312 to generate a new functional predictive height characteristic map 1458 (e.g., 1460 or 1462, or both), control zone generator 313 to generate one or more new control zones on functional predictive height characteristic control zone map 1459 (e.g., 1461 or 1463, or both), and control system 314 to relearn a control algorithm or to perform machine learning on one or more of the controller components 329 through 337 in control system 314 based upon the adjustment by the operator 360 or user 366, as shown in block 1548. Block 1549 represents the use of other triggered learning criteria.

In other examples, relearning may be performed periodically or intermittently based, for example, upon a selected time interval such as a discrete time interval or a variable time interval, as indicated by block 1550.

If relearning is triggered, whether based upon learning trigger criteria or based upon passage of a time interval, as indicated by block 1550, then one or more of the predictive model generator 310, predictive map generator 312, control zone generator 313, and control system 314 performs machine learning to generate new predictive model(s), new predictive map(s), new control zone(s), and new control algorithm(s), respectively, based upon the learning trigger criteria or based upon the passage of a time interval. The new predictive model(s), the new predictive map(s), the new control zone(s), and the new control algorithm(s) are generated using any additional data that has been collected since the last learning operation was performed. Performing relearning is indicated by block 1552.

If the operation has not been completed, operation moves from block 1552 to block 1519 such that the new predictive model(s), the new predictive map(s), the new control zone(s), and/or the new predictive control algorithm(s) can be used to control mobile machine 100. If the operation has been completed, operation moves from block 1552 to block 1554 where one or more of the functional predictive boom height map 1460, functional predictive boom height control zone map 1461, the predictive boom height model 1450, the functional predictive machine height map 1462, the functional predictive machine height control zone map 1463, the predictive machine height model 1451, control zone(s), and control algorithm(s), are stored. The functional predictive map(s), functional predictive control zone map(s), predictive model(s), the control zone(s), and the control algorithm(s) may be stored locally on data store 302 or sent to a remote system using communication system 306 for later use.

The examples herein describe the generation of a predictive model and, in some examples, the generation of a functional predictive map based on the predictive model. The examples described herein are distinguished from other approaches by the use of a model which is at least one of multi-variate or site-specific (i.e., georeferenced, such as map-based). Furthermore, the model is revised as the work machine is performing an operation and while additional in-situ sensor data is collected. The model may also be applied in the future beyond the current worksite. For example, the model may form a baseline (e.g., starting point) for a subsequent operation at a different worksite or at the same worksite at a future time.

The revision of the model in response to new data may employ machine learning methods. Without limitation, machine learning methods may include memory networks, Bayes systems, decisions trees, Eigenvectors, Eigenvalues and Machine Learning, Evolutionary and Genetic Algorithms, Cluster Analysis, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning. Learning may be supervised or unsupervised.

Model implementations may be mathematical, making use of mathematical equations, empirical correlations, statistics, tables, matrices, and the like. Other model implementations may rely more on symbols, knowledge bases, and logic such as rule-based systems. Some implementations are hybrid, utilizing both mathematics and logic. Some models may incorporate random, non-deterministic, or unpredictable elements. Some model implementations may make uses of networks of data values such as neural networks. These are just some examples of models.

The predictive paradigm examples described herein differ from non-predictive approaches where an actuator or other machine parameter is fixed at the time the machine, system, or component is designed, set once before the machine enters the worksite, is reactively adjusted manually based on operator perception, or is reactively adjusted based on a sensor value.

The functional predictive map examples described herein also differ from other map-based approaches. In some examples of these other approaches, an a priori control map is used without any modification based on in-situ sensor data or else a difference determined between data from an in-situ sensor and a predictive map are used to calibrate the in-situ sensor. In some examples of the other approaches, sensor data may be mathematically combined with a priori data to generate control signals, but in a location-agnostic way; that is, an adjustment to an a priori, georeferenced predictive setting is applied independent of the location of the work machine at the worksite. The continued use or end of use of the adjustment, in the other approaches, is not dependent on the work machine being in a particular defined location or region within the worksite.

In examples described herein, the functional predictive maps and predictive actuator control rely on obtained maps and in-situ data that are used to generate predictive models. The predictive models are then revised during the operation to generate revised functional predictive maps and revised actuator control. In some examples, the actuator control is provided based on functional predictive control zone maps which are also revised during the operation at the worksite. In some examples, the revisions (e.g., adjustments, calibrations, etc.) are tied to regions or zones of the worksite rather than to the whole worksite or some non-georeferenced condition. For example, the adjustments are applied to one or more areas of a worksite to which an adjustment is determined to be relevant (e.g., such as by satisfying one or more conditions which may result in application of an adjustment to one or more locations while not applying the adjustment to one or more other locations), as opposed to applying a change in a blanket way to every location in a non-selective way.

In some examples described herein, the models determine and apply those adjustments to selective portions or zones of the worksite based on a set of a priori data, which, in some instances, is multivariate in nature. For example, adjustments may, without limitation, be tied to defined portions of the worksite based on site-specific factors such as topography, soil type, crop variety, soil moisture, as well as various other factors, alone or in combination. Consequently, the adjustments are applied to the portions of the field in which the site-specific factors satisfy one or more criteria and not to other portions of the field where those site-specific factors do not satisfy the one or more criteria. Thus, in some examples described herein, the model generates a revised functional predictive map for at least the current location or zone, the unworked part of the worksite, or the whole worksite.

As an example, in which the adjustment is applied only to certain areas of the field, consider the following. The system may determine that a detected in-situ characteristic value varies from a predictive value of the characteristic such as by a threshold amount. This deviation may only be detected in areas of the field where the elevation of the worksite is above a certain level. Thus, the revision to the predictive value is only applied to other areas of the worksite having elevation above the certain level. In this simpler example, the predictive characteristic value and elevation at the point the deviation occurred and the detected characteristic value and elevation at the point the deviation crossed the threshold are used to generate a linear equation. The linear equation is used to adjust the predictive characteristic value in areas of the worksite not yet operated at during the current operation (e.g., unsprayed areas during the current spraying operation) in the functional predictive map as a function of elevation and the predicted characteristic value. This results in a revised functional predictive map in which some values are adjusted while others remain unchanged based on selected criteria, e.g., elevation as well as threshold deviation. The revised functional map is then used to generate a revised functional control zone map for controlling the machine.

As an example, without limitation, consider an instance of the paradigm described herein which is parameterized as follows.

One or more maps of the field are obtained, such as one or more of a topographic map, a soil type map, a soil moisture map, an optical characteristic map, a tiling map, an irrigation map, a prior operation characteristic map, and another type of map.

In-situ sensors generate sensor data indicative of in-situ characteristic values, such as in-situ soil moisture values.

A predictive model generator generates one or more predictive models based on the one or more obtained maps and the in-situ sensor data, such as a predictive soil moisture model

A predictive map generator generates one or more functional predictive maps based on a model generated by the predictive model generator and the one or more obtained maps. For example, the predictive map generator may generate a functional predictive soil moisture map that maps predictive soil moisture values to one or more locations on the worksite based on a predictive soil moisture model and the one or more obtained maps.

Control zones, which include machine settings values, can be incorporated into the functional predictive soil moisture map to generate a functional predictive soil moisture control zone map.

As the mobile machine continues to operate at the worksite, additional in-situ sensor data is collected. A learning trigger criteria can be detected, such as threshold amount of additional in-situ sensor data being collected, a magnitude of change in a relationship (e.g., the in-situ characteristic values varies to a certain [e.g., threshold] degree from a predictive value of the characteristic), and operator or user makes edits to the predictive map(s) or to a control algorithm, or both, a certain (e.g., threshold) amount of time elapses, as well as various other learning trigger criteria. The predictive model is then revised based on the additional in-situ sensor data and the values from the obtained maps. The functional predictive map or the functional predictive control zone map, or both, are then revised based on the revised model and the values in the obtained maps.

As another example, without limitation, consider an instance of the paradigm described herein which is parameterized as follows.

One or more maps of the field are obtained, such as one or more of a soil moisture map, a predictive soil moisture map (e.g., functional predictive soil moisture map or another type of predictive soil moisture map), and another type of map.

In-situ sensors generate sensor data indicative of in-situ characteristic values, such as in-situ height characteristic values (e.g., boom height values or machine height values, or both).

A predictive model generator generates one or more predictive models based on the one or more obtained maps and the in-situ sensor data, such as a predictive height characteristic model, for instance a predictive boom height model or a predictive machine height model, or both.

A predictive map generator generates one or more functional predictive maps based on a model generated by the predictive model generator and the one or more obtained maps. For example, the predictive map generator may generate a functional predictive height characteristic map that maps predictive height characteristic values to one or more locations on the worksite based on a predictive height characteristic model and the one or more obtained maps. For example, the predictive map generator may generate, as a functional predictive height characteristic map, a functional predictive boom height map that maps predictive boom height values to one or more locations on the worksite based on a predictive boom height model and the one or more obtained maps. In another example, the predictive map generate may generate, as a functional predictive height characteristic map, a functional predictive machine height map that maps predictive machine height values to one or more locations on the worksite based on a predictive machine height model and the one or more obtained maps.

Control zones, which include machine settings values, can be incorporated into the functional predictive height characteristic map to generate a functional predictive height characteristic control zone map. For example, control zones can be incorporated into the functional predictive boom height map to generate a functional predictive boom height control zone map. In another example, control zones can be incorporated into the functional predictive machine height map to generate a functional predictive machine height control zone map.

As the mobile machine continues to operate at the worksite, additional in-situ sensor data is collected. A learning trigger criteria can be detected, such as threshold amount of additional in-situ sensor data being collected, a magnitude of change in a relationship (e.g., the in-situ characteristic values varies to a certain [e.g., threshold] degree from a predictive value of the characteristic), and operator or user makes edits to the predictive map(s) or to a control algorithm, or both, a certain (e.g., threshold) amount of time elapses, as well as various other learning trigger criteria. One or more predictive models are then revised based on the additional in-situ sensor data and the values from the obtained maps. The functional predictive map(s) or the functional predictive control zone map(s), or both, are then revised based on the revised model(s) and the values in the obtained maps.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores may be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, components, logic and interactions. It will be appreciated that any or all of such systems, components, logic and interactions may be implemented by hardware items, such as processors, memory, or other processing components, some of which are described below, that perform the functions associated with those systems, components, or logic, or interactions. In addition, any or all of the systems, components, logic and interactions may be implemented by software that is loaded into a memory and is subsequently executed by a processor or server or other computing component, as described below. Any or all of the systems, components, logic and interactions may also be implemented by different combinations of hardware, software, firmware, etc., some examples of which are described below. These are some examples of different structures that may be used to implement any or all of the systems, components, logic and interactions described above. Other structures may be used as well.

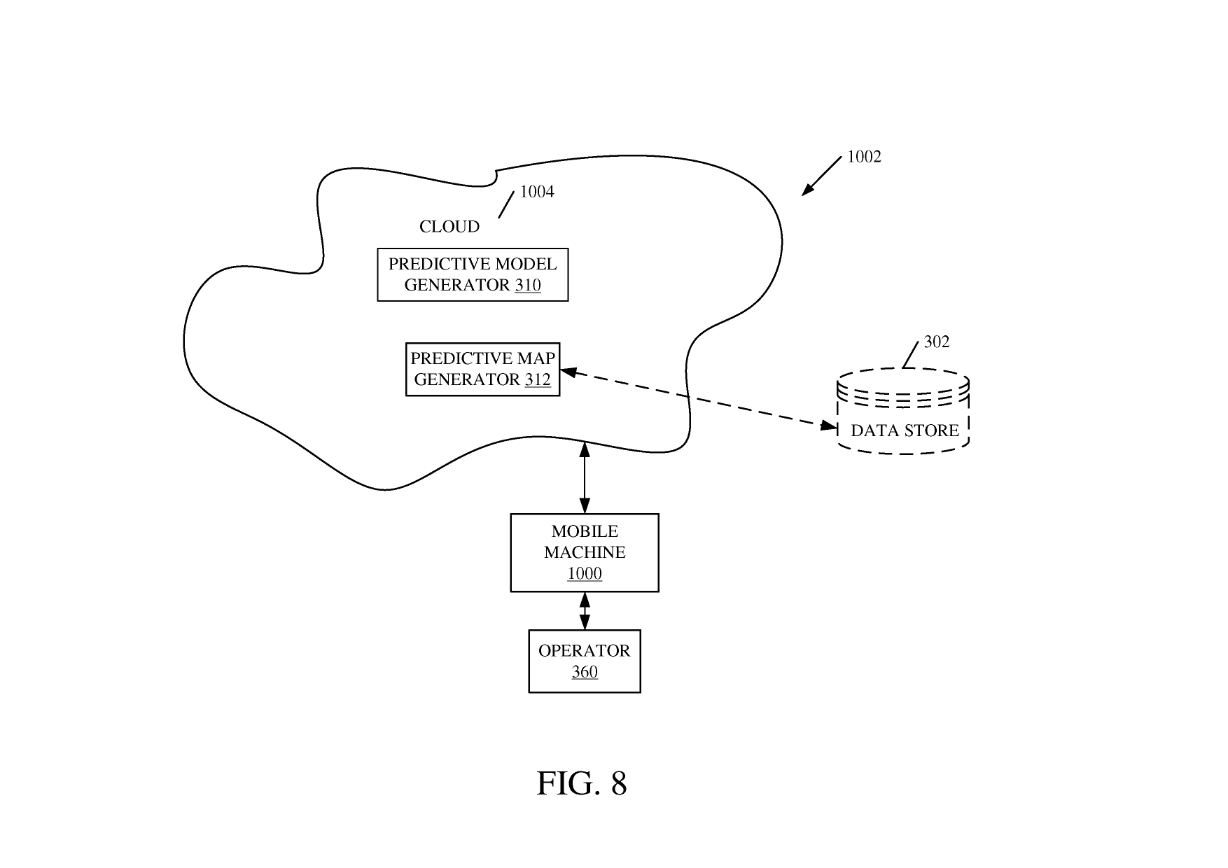

FIG. 8 is a block diagram of mobile machine 1000, which may be similar to mobile machine 100 shown in FIG. 3. The mobile machine 100 communicates with elements in a remote server architecture 1002. In some examples, remote server architecture 1002 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in FIG. 3 as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 8, some items are similar to those shown in FIG. 3 and those items are similarly numbered. FIG. 8 specifically shows that predictive model generator 310 or predictive map generator 312, or both, may be located at a server location 1004 that is remote from the mobile machine 1000. Therefore, in the example shown in FIG. 8, mobile machine 1000 accesses systems through remote server location 1004. In other examples, various other items may also be located at server location 1004, such as data store 302, map selector 309, predictive model 311, functional predictive maps 263 (including predictive maps 264 and predictive control zone maps 265), control zone generator 313, control system 314, and processing system 338.

FIG. 8 also depicts another example of a remote server architecture. FIG. 8 shows that some elements of FIG. 8 may be disposed at a remote server location 1004 while others may be located elsewhere. By way of example, data store 302 may be disposed at a location separate from location 1004 and accessed via the remote server at location 1004. Regardless of where the elements are located, the elements can be accessed directly by mobile machine 1000 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users, or systems. For instance, physical carriers may be used instead of, or in addition to, electromagnetic wave carriers. In some examples, where wireless telecommunication service coverage is poor or nonexistent, another machine, such as a fuel truck or other mobile machine or vehicle, may have an automated, semi-automated or manual information collection system. As the mobile machine 1000 comes close to the machine containing the information collection system, such as a fuel truck prior to fueling, the information collection system collects the information from the mobile machine 1000 using any type of ad-hoc wireless connection. The collected information may then be forwarded to another network when the machine containing the received information reaches a location where wireless telecommunication service coverage or other wireless coverage– is available. For instance, a fuel truck may enter an area having wireless communication coverage when traveling to a location to fuel other machines or when at a main fuel storage location. All of these architectures are contemplated herein. Further, the information may be stored on the mobile machine 1000 until the mobile machine 1000 enters an area having wireless communication coverage. The mobile machine 1000, itself, may send the information to another network.

It will also be noted that the elements of FIG. 3, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1002 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

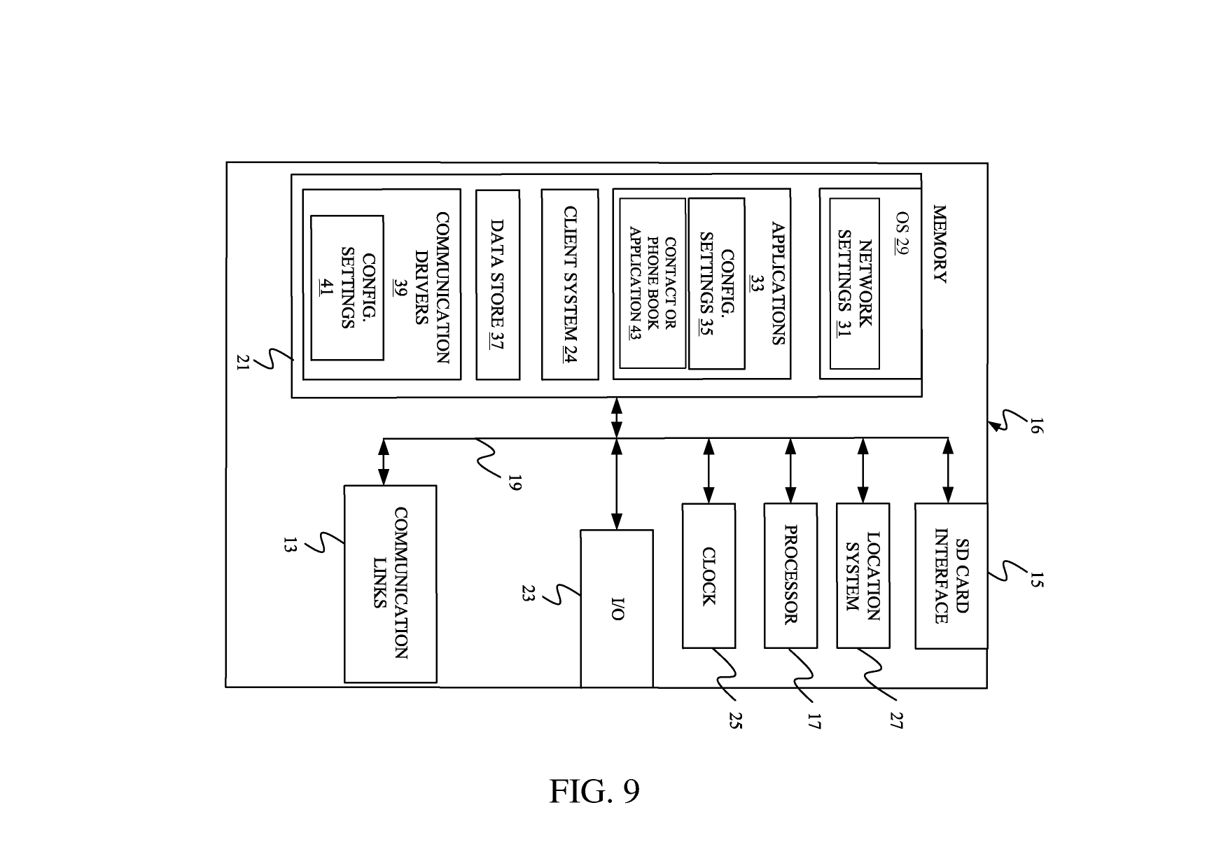

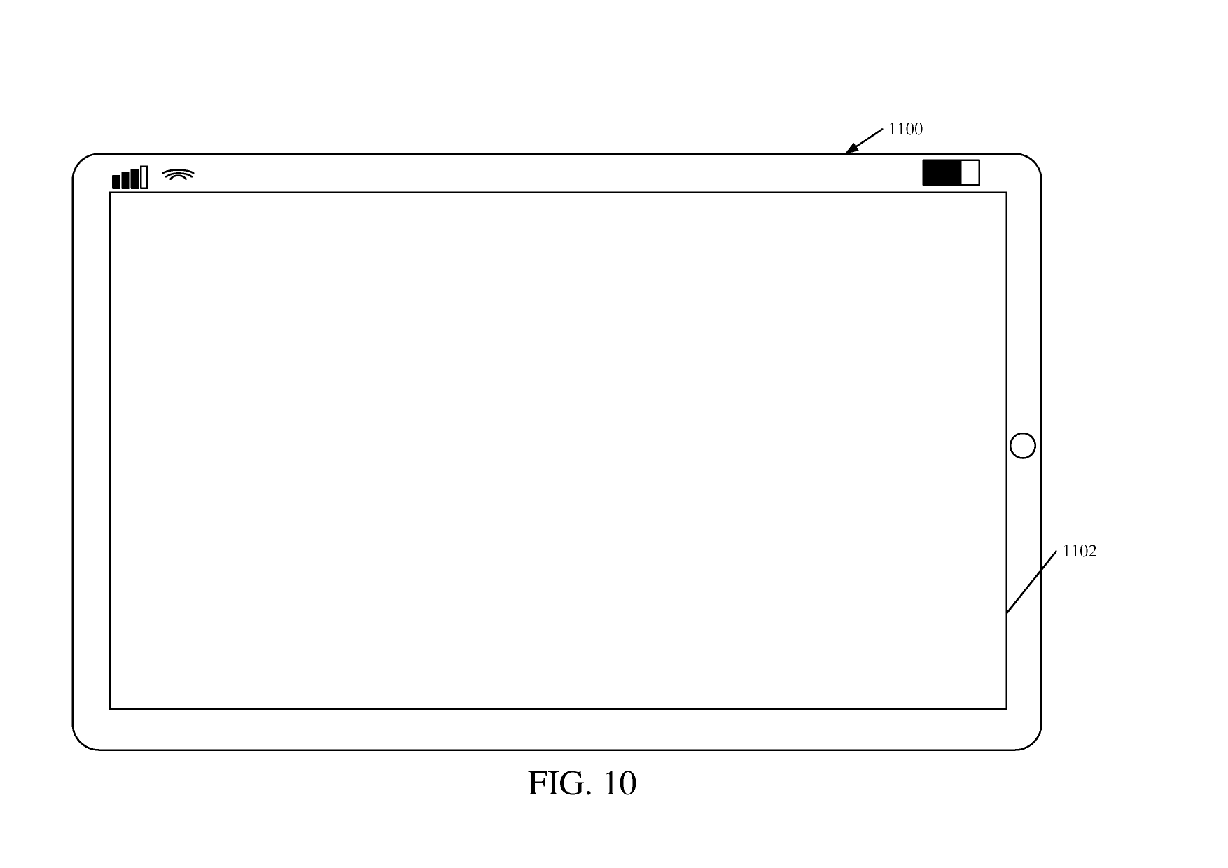

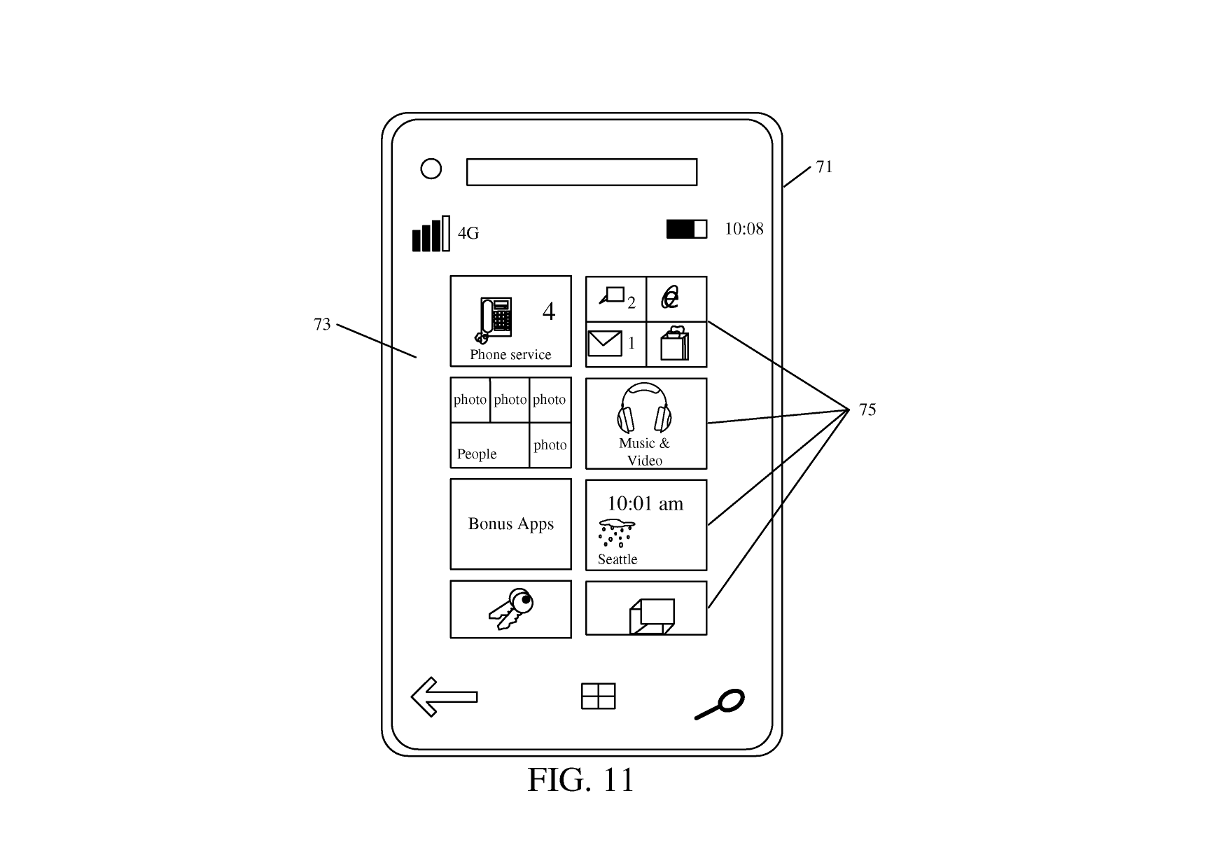

FIG. 9 is a simplified block diagram of one illustrative example of a handheld or mobile computing device that can be used as a user’s or client’s handheld device 16, in which the present system (or parts of it) can be deployed. For instance, a mobile device can be deployed in the operator compartment of mobile machine 100 for use in generating, processing, or displaying the maps discussed above. FIGS. 10-11 are examples of handheld or mobile devices.

FIG. 9 provides a general block diagram of the components of a client device 16 that can run some components shown in FIG. 3, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 may also include computer storage media (described below). Memory 21 stores computer readable instructions that, when executed by processor 17, cause the processor to perform computer-implemented steps or functions according to the instructions. Processor 17 may be activated by other components to facilitate their functionality as well.

FIG. 10 shows one example in which device 16 is a tablet computer 1100. In FIG. 10, computer 1100 is shown with user interface display screen 1102. Screen 1102 can be a touch screen or a pen-enabled interface that receives inputs from a pen or stylus. Tablet computer 1100 may also use an on-screen virtual keyboard. Of course, computer 1100 might also be attached to a keyboard or other user input device through a suitable attachment mechanism, such as a wireless link or USB port, for instance. Computer 1100 may also illustratively receive voice inputs as well.

FIG. 11 is similar to FIG. 10 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

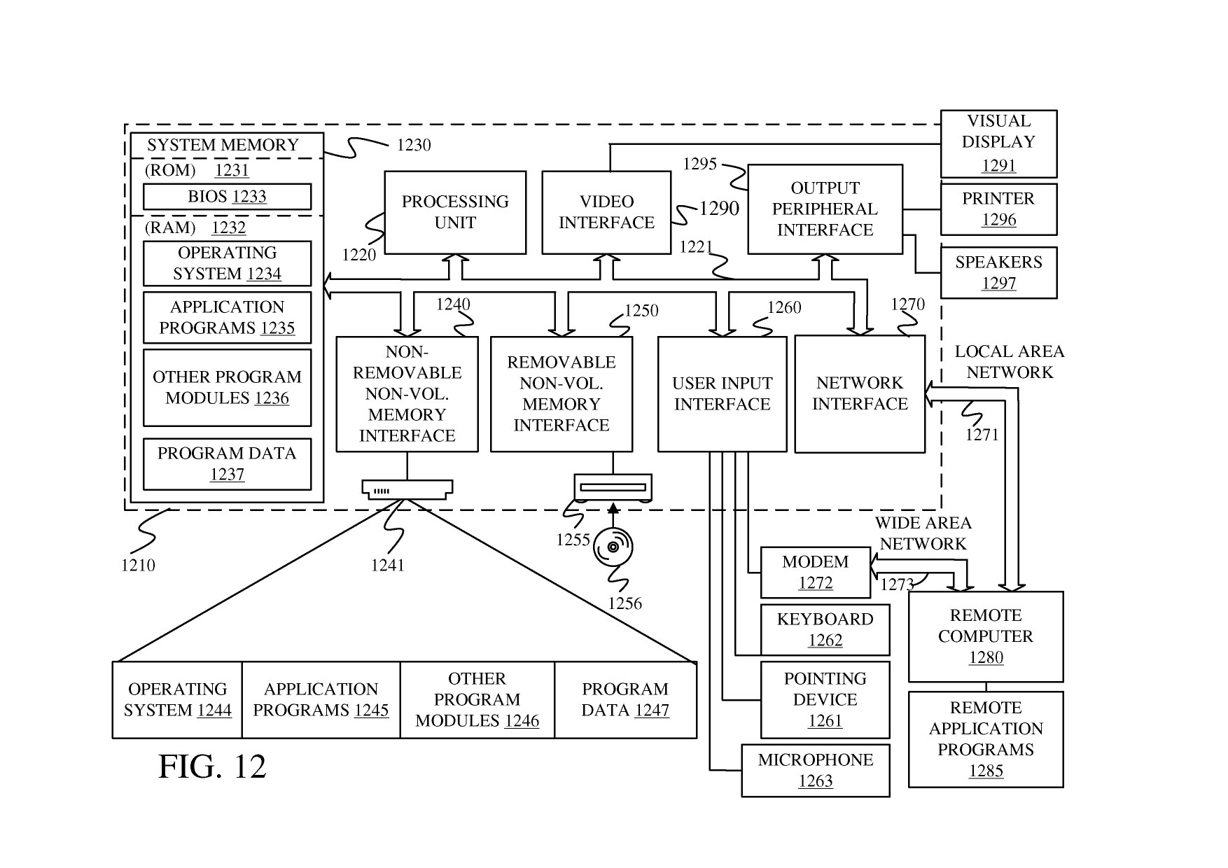

FIG. 12 is one example of a computing environment in which elements of FIG. 3 can be deployed. With reference to FIG. 12, an example system for implementing some embodiments includes a computing device in the form of a computer 1210 programmed to operate as discussed above. Components of computer 1210 may include, but are not limited to, a processing unit 1220 (which can comprise processors or servers from previous FIGS.), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to FIG. 3 can be deployed in corresponding portions of FIG. 12.

Computer 1210 typically includes a variety of computer readable media. Computer readable media may be any available media that can be accessed by computer 1210 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable volatile/nonvolatile computer storage media. By way of example only, FIG. 12 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite dish, scanner, or the like. These and other input devices are often connected to the processing unit 1220 through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections (such as a controller area network – CAN, local area network – LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 12 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for generating functional predictive maps and controlling a machine based on functional predictive maps have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for generating functional predictive maps and controlling a machine based on functional predictive maps. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”

The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for generating functional predictive maps and controlling a machine based on functional predictive maps, have been disclosed. Although the systems and methods for generating functional predictive maps and controlling a machine based on functional predictive maps have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

What is claimed is:

1. An agricultural spraying system comprising:
a communication system configured to receive an information map that includes values of a characteristic corresponding to different geographic locations in a worksite;
an in-situ soil moisture sensor configured to detect a value of soil moisture corresponding to a geographic location in the worksite;
a predictive model generator configured to generate a predictive model indicative of a relationship between values of the characteristic and values of soil moisture based on a value of the characteristic in the information map at the geographic location and the value of soil moisture detected by the in-situ soil moisture sensor corresponding to the geographic location;
a predictive map generator configured to generate a functional predictive map of the worksite that maps predictive values of soil moisture to the different geographic locations in the worksite, based on the values of the characteristic in the information map and based on the predictive model; and
a control system configured to control a mobile agricultural sprayer based on the functional predictive map.

2. The agricultural spraying system of claim 1, wherein the information map comprises one of:
a topographic map that maps, as the values of the characteristic, topographic characteristic values to the different geographic locations in the worksite;
a soil type map that maps, as the values of the characteristic, soil type values to the different geographic locations in the worksite;
a soil moisture map that maps, as the values of the characteristic, soil moisture values to the different geographic locations in the worksite;
an optical characteristic map that maps, as the values of the characteristic, optical characteristic values to the different geographic locations in the worksite;
a tiling map that maps, as the values of the characteristic, tiling characteristic values to the different geographic locations in the worksite;
an irrigation map that maps, as the values of the characteristic, irrigation characteristic values to the different geographic locations in the worksite; or
a prior operation characteristic map that maps, as the values of the characteristic, prior operation characteristic values to the different geographic locations in the worksite.

3. The agricultural spraying system of claim 1, and further comprising:
an in-situ boom height sensor configured to detect a value of boom height corresponding to a geographic location in the worksite.

4. The agricultural spraying system of claim 3, wherein the predictive model generator is further configured to generate a predictive boom height model indicative of a relationship between predictive values of soil moisture and values of boom height based on a predictive value of soil moisture in the functional predictive map at the geographic location to which the value of boom height detected by the in-situ boom height sensor corresponds and the value of boom height detected by the in-situ boom height sensor corresponding to the geographic location.

5. The agricultural spraying system of claim 4, wherein the predictive map generator is further configured to generate a functional predictive boom height map of the worksite that maps predictive values of boom height to the different geographic locations in the worksite, based on the predictive values of soil moisture in the functional predictive map and based on the predictive boom height model.

6. The agricultural spraying system of claim 1, and further comprising:
an in-situ machine height sensor configured to detect a value of machine height corresponding to a geographic location in the worksite.

7. The agricultural spraying system of claim 6, wherein the predictive model generator is further configured to generate a predictive machine height model indicative of a relationship between predictive values of soil moisture and values of machine height based on a predictive value of soil moisture in the functional predictive map at the geographic location to which the value of machine height detected by the in-situ boom height sensor corresponds and the value of machine height detected by the in-situ machine height sensor corresponding to the geographic location.

8. The agricultural spraying system of claim 7, wherein the predictive map generator is further configured to generate a functional predictive machine height map of the worksite that maps predictive values of machine height to the different geographic locations in the worksite, based on the predictive values of soil moisture in the functional predictive map and based on the predictive machine height model.

9. The agricultural spraying system of claim 1, wherein the control system comprises one or more of:
a path planning controller configured to control a steering subsystem of a mobile agricultural sprayer based on the functional predictive map;
a machine height controller configured to control a machine height subsystem of the mobile agricultural sprayer based on the functional predictive map;
a boom height controller configured to control a boom height subsystem of the mobile agricultural sprayer based on the functional predictive map;
a tire pressure controller configured to control a tire pressure subsystem of the mobile agricultural sprayer based on the functional predictive map; and
an interface controller configured to control an interface mechanism based on the functional predictive map.

10. A computer implemented method of generating a functional predictive map comprising:
receiving an information map that maps values of a characteristic to different geographic locations in a worksite;
detecting, with an in-situ sensor, a value of soil moisture corresponding to a geographic location at the worksite while a mobile agricultural sprayer is operating at the worksite;
generating a predictive model indicative of a relationship between values of the characteristic and values of soil moisture based on the value of soil moisture detected by the in-situ sensor corresponding to the geographic location and the value of the characteristic in the information map at the geographic location;
controlling a predictive map generator to generate the functional predictive map of the worksite that maps predictive values of soil moisture to the different geographic locations in the worksite based on the values of the characteristic in the information map and the predictive model.

11. The computer implemented method of claim 10, and further comprising:
detecting, with an in-situ boom height sensor, a value of boom height corresponding to a geographic location at the worksite while the mobile agricultural sprayer is operating at the worksite;
generating a predictive boom height model indicative of a relationship between predictive values of soil moisture and values of boom height based on the value of boom height detected by the in-situ boom height sensor corresponding to the geographic location and the predictive value of soil moisture in the functional predictive map at the geographic location to which the value of boom height detected by the in-situ boom height sensor corresponds; and
controlling the predictive map generator to generate a functional predictive boom height map of the worksite that maps predictive values of boom height to the different geographic locations in the worksite based on the predictive values of soil moisture in the functional predictive map and the predictive boom height model.

12. The computer implemented method of claim 10, and further comprising:
detecting, with an in-situ machine height sensor, a value of machine height corresponding to a geographic location at the worksite while the mobile agricultural sprayer is operating at the worksite;
generating a predictive machine height model indicative of a relationship between predictive values of soil moisture and values of machine height based on the value of machine height detected by the in-situ machine height sensor corresponding to the geographic location and the predictive value of soil moisture in the functional predictive map at the geographic location to which the value of machine height detected by the in-situ machine height sensor corresponds; and
controlling the predictive map generator to generate a functional predictive machine height map of the worksite that maps predictive values of machine height to the different geographic locations in the worksite based on the predictive values of soil moisture in the functional predictive map and the predictive machine height model.

13. The computer implemented method of claim 10, and further comprising:
controlling a controllable subsystem of the mobile agricultural sprayer based on the functional predictive map.

14. The computer implemented method of claim 13, wherein controlling the controllable subsystem of the mobile agricultural sprayer based on the functional predictive map comprises one or more of:
controlling a tire pressure subsystem to adjust a pressure of a tire of the mobile agricultural sprayer based on the functional predictive map;
controlling a boom height subsystem to actuate a boom height actuator of the mobile agricultural sprayer based on the functional predictive map;
controlling a machine height subsystem to actuate a machine height actuator of the mobile agricultural sprayer based on the functional predictive map;
controlling a steering subsystem to adjust a heading of the mobile agricultural sprayer based on the functional predictive map; and
controlling an interface mechanism to provide an indication based on the functional predictive map.

15. An agricultural spraying system comprising:
a communication system configured to receive an information map that includes values of a characteristic corresponding to different geographic locations in a worksite;
an in-situ height characteristic sensor configured to detect a value of a height characteristic corresponding to a geographic location in the worksite;
a predictive model generator configured to generate a predictive model indicative of a relationship between values of the characteristic and values of the height characteristic based on a value of the characteristic in the information map at the geographic location and the value of the height characteristic detected by the in-situ height characteristic sensor corresponding to the geographic location;
a predictive map generator configured to generate a functional predictive map of the worksite that maps predictive values of the height characteristic to the different geographic locations in the worksite, based on the values of the characteristic in the information map and based on the predictive model; and
a control system configured to control a mobile agricultural sprayer based on the functional predictive map.

16. The agricultural spraying system of claim 15, wherein the in-situ height characteristic sensor comprises:
an in-situ boom height sensor configured to detect, as the value of the height characteristic, a value of boom height corresponding to the geographic location in the worksite.

17. The agricultural spraying system of claim 15, wherein the in-situ height characteristic sensor comprises:
an in-situ machine height sensor configured to detect, as the value of the height characteristic, a value of machine height corresponding to the geographic location in the worksite.

18. The agricultural spraying system of claim 15, wherein the information map comprises one of:
a soil moisture map that maps, as the values of the characteristic, soil moisture values to the different geographic locations in the worksite; or
a predictive soil moisture map that maps, as the values of the characteristic, predictive soil moisture values to the different geographic locations in the worksite.

19. The agricultural spraying system of claim 15, and further comprising:
an in-situ soil moisture sensor configured to detect a value of soil moisture corresponding to a geographic location in the worksite,
wherein the communication system is further configured to receive an additional information map that includes values of an additional characteristic corresponding to the different geographic locations in the worksite,
wherein the predictive model generator is further configured to generate a predictive soil moisture model indicative of a relationship between values of the additional characteristic and values of soil moisture based on a value of the additional characteristic in the additional information map at the geographic location to which the value of soil moisture detected by the in-situ soil moisture sensor corresponds and the value of soil moisture detected by the in-situ soil moisture sensor corresponding to the geographic location,
wherein the predictive map generator is further configured to generate a functional predictive soil moisture map of the worksite that maps predictive values of soil moisture to the different geographic locations in the worksite, based on the values of the additional characteristic in the additional information map and based on the predictive soil moisture model, and
wherein the information map comprises the functional predictive soil moisture map that maps, as the values of the characteristic, predictive values of soil moisture to the different geographic locations in the worksite, and wherein the predictive model generator is configured to generate as the predictive model, a predictive height characteristic model indicative of a relationship between predictive value of soil moisture and values of machine height based on the value of machine height detected by the in-situ height characteristic sensor corresponding to the geographic location and the predictive value of soil moisture, in the functional predictive soil moisture map, at the geographic location, the predictive height characteristic model being configured to receive a predictive value of soil moisture as a model input and generate a value of the height characteristic as a model output based on the relationship.

20. The agricultural spraying system of claim 15, wherein the control system comprises one or more of:
a path planning controller configured to control a steering subsystem of a mobile agricultural sprayer based on the functional predictive map;
a machine height controller configured to control a machine height subsystem of the mobile agricultural sprayer based on the functional predictive map;
a boom height controller configured to control a boom height subsystem of the mobile agricultural sprayer based on the functional predictive map;
a tire pressure controller configured to control a tire pressure subsystem of the mobile agricultural sprayer based on the functional predictive map; and
an interface controller configured to control an interface mechanism based on the functional predictive map.
